(19) United States
(12) Patent Application Publication
(10) Pub. No.: US 2004/0252867 A1
(43) Pub. Date: Dec. 16, 2004

(54) Biometric sensor

(76) Inventors: Je-Hsiung Lan, Irvine, CA (US); John Van Zandt, Mission Viejo, CA (US)

Correspondence Address: STRADLING YOCCA CARLSON & RAUTH, IP Department, 660 Newport Center, Suite 1600, P.O. Box 7680, Newport Beach, CA, 92660-6441, US

(21) Appl. No.: 10/079,960

(22) Filed: Feb. 19, 2002

Related U.S. Application Data
(63) Continuation-in-part of application No. 09/477,943, filed on Jan. 5, 2000.

(51) Int. Cl. G06K 9/00

(52) U.S. Cl. 382/124

(57) ABSTRACT

A system and methods for sensing and imaging a fingerprint surface using an optical sensing device. The fingerprint system utilizes an optical detector to capture light selectively reflected by the relief features of the fingerprint surface. A number of different methods for lighting and positioning the sensor are described to desirably enhance the contrast and clarity of the rendered image and to improve accuracy in discriminating between fingerprints. A color filter system is also described that is integrated into fingerprint sensor and improves the quality of the resultant fingerprint image.

This application is a continuation-in-part of U.S. patent application No. 09/477,943 entitled “Planar Optical Image Sensor and System for Generating an Electronic Image of a Relief Object for Fingerprint Reading” filed on Jan. 5, 2000.

### BACKGROUND OF THE INVENTION

1. Field of the Invention

The invention relates to an biometric sensor system. More particularly, the invention relates to an optical sensor system and method for detecting and rendering a relief object such as a fingerprint.

2. Description of the Related Art

Fingerprint sensors, which provide fingerprint imaging and recognition capabilities, have found increasing utility in a variety of applications, including building access security systems, computer access security systems, and other personal identity verification systems. Fingerprint sensors in these applications are typically employed to verify that a person attempting to gain access to a protected system is in fact an authorized user of that system. This process is referred to as authentication. Fingerprints are statistically unique to each individual and difficult to replicate. Fingerprints are further advantageous as authentication means as they cannot be misplaced or forgotten as is the case with tokens, such as pass keys or cards, or passwords and combinations.

The accuracy and resolution of the electronic image developed by a fingerprint sensor is important to the dependability of the sensor system. Fingerprint discrimination relies on indexing distinguishing features in the ridge and valley patterns of the fingerprint and comparing them to known patterns. Inadequate resolution or imaging errors can result in inaccuracies in the authentication process. In particular, authorized users should be granted access without rejection or extended delay. A denial of access to an authorized user is referred to as a false rejection. The fingerprint sensor system should also not grant access to other than authorized users. Doing so is referred to as a false acception.

Certain types of optical fingerprint sensors take advantage of the phenomenon of total internal reflection due to the differing indices of refraction of air and tissue. When a fingertip is placed onto a substrate, the protruding ridges of the fingerprint are in contact with the substrate while the valleys between the ridges form air-filled regions. By illuminating the finger and placing photodetectors within the substrate, which has an index of refraction close to that of the finger, light is able to pass between the finger and the substrate through the ridges, but is reflected from the air-filled valleys. In this way, the ridges can be optically distinguished from the valleys to form an electronic image of the fingerprint pattern.

An important factor in determining the quality of a fingerprint image resolved by an optical fingerprint sensor is the amount of, and the angle at which, light illuminates the ridges and valleys of the finger. Ambient light entering the fingerprint sensor while the sensor is attempting to resolve the fingerprint image may be of such a nature as to reduce the contrast of the ridges and valleys of the fingerprint image and degrade the image quality. This problem is particularly troublesome in that the reduced image quality may further result in reduced accuracy in discriminating between fingerprints. Ambient light entering the fingerprint sensor may also degrade the performance of the fingerprint sensor system as a result of undesirable reflection and refraction within the sensor which degrades the quality of the rendered fingerprint surface.

The use of a light-blocking enclosure or shield to reduce the influence of ambient light in the detection of the fingerprint has been proposed to address the aforementioned resolution problem. However, the use of a shield is often impractical as it necessitates the formation of a relatively bulky structure around the fingerprint sensor region. Additionally, in some applications the fingerprint sensor may be positioned in such a way as to make it difficult or impossible to create an enclosure which reduces or eliminates the ambient light effects. For example, if the fingerprint sensor is integrated into a touchscreen, monitor, or other display apparatus, the use of a light blocking enclosure may not be possible as it would block or impede a user's ability to view the portion of the display apparatus covered by the enclosure.

Another problem arises when providing illumination for detection of the fingerprint and, in particular, results from the placement of the light source used to illuminate the ridges and valleys of the fingertip. In some situations, conventional backlighting of the fingerprint sensor may not be the most efficient method by which the fingerprint can be illuminated. This problem may be exacerbated by the structure of the fingerprint sensor or accompanying electronics which occlude light from the back surface of the device. In this circumstance, backlighting cannot be readily used to illuminate the surface of the finger.

However, fingerprint detection systems that use photo-detection as a method for identifying the fingerprint typically do require some source of lighting which illuminates the underside of the fingerprint surface. A problem encountered when illuminating the fingerprint surface is ensuring that the entire region of the fingerprint is uniformly illuminated. Non-uniform illumination leads to reduced fingerprint resolution and reduced accuracy in distinguishing between similar fingerprint patterns.

Another problem related to the requisite need for illumination of conventional photodetector fingerprint systems relates to the source of light used to illuminate the fingerprint surface. In some applications, the use of an externally positioned or integrated light source is impractical, as it would interfere with the operation of the device. Furthermore, the spectral characteristics of the light produced by certain light sources may be unsuitable for illumination of the fingerprint surface and may result in decreased contrast and resolution of the rendered fingerprint image.

Additionally, there are applications where a fingerprint sensor is desired to be integrated into another electronic device which cannot be illuminated in a practical manner using conventional methods. For example, if the surfaces of the fingerprint sensor are necessarily formed from an opaque material, externally generated light-dependent fingerprint detection is precluded due to the inability to transmit and reflect light through the surfaces of the fingerprint detector.

Conventional fingerprint sensors for electronic devices, such as personal computers, laptop computers, or workstations, typically operate as stand-alone or externally connected devices. These fingerprint sensors are commonly connected to the electronic device through an expansion port or peripheral port such as a serial port, a parallel port, a USB port, a PC card slot, a PCMCIA expansion port or the like. However, the number of peripheral connection ports that are available for other externally connected peripheral devices is limited. As a consequence, it may be necessary to continually exchange port connections for multiple peripheral devices, including the fingerprint sensor, and may prevent the user from enjoying the convenience of having multiple devices simultaneously connected at one time.

In addition, stand-alone fingerprint sensors can be cumbersome in that they require a portion of the workspace near the host device to be dedicated to their presence and may require a cord or connector to extend between the fingerprint sensor and the host electronic device. This can result in an increase in the amount of “clutter” or workspace disorganization near the electronic device, whereby the creation of an undesirable or unmanageable workspace environment may manifest where a space saving situation is of greater importance.

Another problem may arise when the fingerprint sensor is used in conjunction with portable devices, such as notebook computers, handheld personal digital assistant (PDA) devices, and memory storage devices. These host devices may not have the necessary expansion ports available to connect an externally connected fingerprint sensor, and, furthermore, if such a sensor can be connected, then its use undesirably adds additional weight and bulk to the computing device.

### SUMMARY OF THE INVENTION

In one aspect, the invention comprises a fingerprint sensor wherein a finger placed on the sensor is illuminated by both a light source and by ambient light, the fingerprint sensor having a color filter that filters out a portion of the ambient light, the fingerprint sensor comprising: a contact surface which receives a fingertip of a user; at least one light source which generates at least green light that is reflected by the fingertip; a color filter which is substantially transparent to the green light and substantially opaque to a portion of ambient light that is substantially transmitted through the fingertip; and a plurality of optical detectors disposed from the contact surface with at least a portion of the color filter disposed between the optical detectors and the contact surface, the optical detectors positioned to receive the green light reflected by the fingertip, the optical detectors generating electrical signals in response to the received light, thereby providing an electronic representation of a fingerprint corresponding to the fingertip.

In another aspect, the invention comprises a fingerprint sensor comprising: at least one light source which generates light that is reflected by a fingertip; a color filter which is substantially transparent to green light and substantially opaque to non-green light; and at least one optical detector disposed from the fingertip with at least a portion of the color filter disposed between the optical detector and the fingertip, the optical detector positioned to receive the green light reflected by the fingertip.

In yet another aspect, the invention comprises a fingerprint sensor comprising: a contact surface which receives a fingertip of a user, the fingertip comprising a pattern of ridges and valleys, the contact surface in contact with the ridges of the fingertip; at least one light source which generates light that is reflected from the contact surface; a color filter which is substantially transparent to green light and substantially opaque to non-green light; and at least one optical detector disposed from the contact surface with at least a portion of the color filter disposed between the optical detector and the contact surface, the optical detector positioned to receive the green light reflected from the contact surface.

In still yet another aspect, the invention comprises a fingerprint sensor comprising: a substrate which is substantially transparent to green light; at least one light source coupled to the substrate, the light source generating light that propagates through the substrate and is reflected by a fingertip; a color filter which is substantially transparent to green light and substantially opaque to non-green light; and at least one optical detector disposed from the fingertip with at least a portion of the color filter disposed between the optical detector and the fingertip, the optical detector positioned to receive the green light reflected by the fingertip.

In a further aspect, the invention comprises a fingerprint sensor comprising: at least one light source which generates light that is reflected by a fingertip; a color filter which is substantially transparent to green light and substantially opaque to non-green light; and an optical detector layer disposed from the fingertip with at least a portion of the color filter disposed between the optical detector layer and the fingertip, the optical detector layer positioned to receive the green light reflected by the fingertip.

In a still further aspect, the invention comprises a fingerprint sensor comprising: at least one light source which generates light that is reflected by a fingertip; a color filter which is substantially transparent to non-red light and substantially opaque to red light; and at least one optical detector disposed from the fingertip with at least a portion of the color filter disposed between the optical detector and the fingertip, the optical detector positioned to receive the non-red light reflected by the fingertip.

In an additional aspect, the invention comprises a fingerprint sensor comprising: a contact surface which receives a fingertip of a user, the fingertip comprising a pattern of ridges and valleys, the contact surface in contact with the ridges of the fingertip; at least one light source which generates light that is reflected from the contact surface; a color filter which is substantially transparent to non-red light and substantially opaque to red light; and at least one optical detector disposed from the contact surface with at least a portion of the color filter disposed between the optical detector and the contact surface, the optical detector positioned to receive the non-red light reflected from the contact surface.

In yet an additional aspect, the invention comprises a fingerprint sensor comprising: a substrate which is substantially transparent to non-red light; at least one light source coupled to the substrate, the light source generating light that propagates through the substrate and is reflected by a fingertip; a color filter which is substantially transparent to non-red light and substantially opaque to red light; and at least one optical detector disposed from the fingertip with at least a portion of the color filter disposed between the optical detector and the fingertip, the optical detector positioned to receive the non-red light reflected by the fingertip.

In another aspect the invention comprises a fingerprint sensor comprising: at least one light source which generates light that is reflected by a fingertip; a color filter which is substantially transparent to non-red light and substantially opaque to red light; and an optical detector layer disposed from the fingertip with at least a portion of the color filter disposed between the optical detector layer and the fingertip, the optical detector layer positioned to receive the non-red light reflected by the fingertip.

In yet another aspect, the invention comprises a fingerprint sensor comprising: at least one light source which generates light that is reflected by a fingertip; a color filter which is substantially opaque to a portion of ambient light that passes through the fingertip; and at least one optical detector disposed from the fingertip with at least a portion of the color filter disposed between the optical detector and the fingertip, the optical detector positioned to receive a portion of the light that reflects from the fingertip and passes through the color filter.

In a further aspect, the invention comprises a fingerprint sensor comprising: a contact surface which receives a fingertip of a user, the fingertip comprising a pattern of ridges and valleys, the contact surface in contact with the ridges of the fingertip; at least one light source which generates light that is reflected from the contact surface; a color filter which is substantially opaque to a portion of ambient light that passes through the fingertip; and at least one optical detector disposed from the contact surface with at least a portion of the color filter disposed between the optical detector and the contact surface, the optical detector positioned to receive a portion of the light that reflects from the contact surface and passes through the color filter.

In a still further aspect, the invention comprises a fingerprint sensor comprising: at least one light source coupled to a substrate, the light source generating light that propagates through the substrate and is reflected by a fingertip, the substrate being substantially transparent to the light generated by the light source; a color filter which is substantially opaque to a portion of ambient light that passes through the fingertip; and at least one optical detector disposed from the fingertip with at least a portion of the color filter disposed between the optical detector and the fingertip, the optical detector positioned to receive a portion of the light that reflects from the fingertip.

In an additional aspect, the invention comprises a fingerprint sensor comprising: at least one light source which generates light that is reflected by a fingertip; a color filter which is substantially opaque to a portion of ambient light that passes through the fingertip; and an optical detector layer disposed from the fingertip with at least a portion of the color filter disposed between the optical detector layer and the fingertip, the optical detector layer positioned to receive a portion of the light that reflects from the fingertip.

In still yet another aspect, the invention comprises a fingerprint sensor comprising: at least one light source which generates light that is reflected by a fingertip; and at least one optical detector disposed from the fingertip, the optical detector positioned to receive the light generated by the light source and reflected by the fingertip, the optical detector comprising a color filter which is substantially transparent to the light that is generated by the light source and reflected by the fingertip and substantially opaque to a portion of ambient light substantially transmitted through the fingertip, whereby the optical detector is substantially responsive to the light that is generated by the light source and reflected by the fingertip and is not substantially responsive to the portion of ambient light substantially transmitted through the fingertip.

In a further aspect, the invention comprises a fingerprint sensor comprising: at least one light source which generates light that is reflected by a fingertip; and a plurality of optical detectors disposed from the fingertip, the optical detectors positioned to receive the light generated by the light source and reflected by the fingertip, the optical detectors each comprising: a switching diode; a photodiode comprising a photoactive p-layer, an intrinsic layer, and an n-layer; and a color filter layer covering the photoactive p-layer, the color filter layer substantially transparent to the light generated by the light source and reflected by the fingertip and substantially opaque to a portion of ambient light substantially transmitted through the fingertip, whereby the optical detectors are substantially responsive to light that is generated by the light source and not substantially responsive to the portion of ambient light substantially transmitted through the fingertip.

In a still further aspect, the invention comprises a fingerprint sensor wherein a finger placed on the sensor is illuminated by both a light source and by ambient light, the fingerprint sensor having a color filter that filters a portion of the ambient light, the fingerprint sensor comprising: a substrate comprising a first material which is substantially transparent to light with wavelengths within a first range of wavelengths; a contact surface which receives a fingertip of a user; a color filter layer comprising a second material which is substantially transparent to light with wavelengths within the first range of wavelengths and substantially opaque to a portion of ambient light with wavelengths within a second range of wavelengths, the portion of ambient light propagating through the fingertip; at least one light source coupled to the substrate, the light source generating light with at least one wavelength within the first range of wavelengths, the light propagating through the substrate to the fingertip; and a plurality of optical detectors disposed from the contact surface with at least a portion of the second material disposed between the optical detectors and the contact surface, the optical detectors positioned to receive light generated by the light source and reflected by the fingertip, the optical detectors generating electrical signals in response to the received light, thereby providing an electronic representation of a fingerprint corresponding to the fingertip.

In another aspect, the invention comprises a method of sensing a fingerprint comprising a pattern of ridges and valleys of a fingertip of a user, the method comprising: receiving the fingertip on a fingerprint sensor; receiving a first light substantially transmitted through the fingertip to a contact surface, whereby the first light is generated by ambient light sources; generating a second light and substantially transmitting the second light to the fingertip from the contact surface; reflecting a portion of the second light from the fingertip; filtering the first light substantially transmitted through the contact surface from the second light reflected from the fingertip; and detecting the second light reflected from the fingertip, thereby imaging the fingerprint of the fingertip.

In yet another aspect, the invention comprises a fingerprint sensor comprising: at least one light source which generates green light that is reflected by a fingertip; a color filter which is substantially transparent to the green light generated by the light source and reflected by the fingertip, and which is substantially opaque to non-green light; and at least one optical detector disposed from the fingertip with at least a portion of the color filter disposed between the optical detector and the fingertip, the optical detector positioned to receive the green light generated by the light source and reflected by the fingertip.

In an additional aspect, the invention comprises a fingerprint sensor comprising: at least one light source comprising a green light-emitting diode which generates green light that is reflected by a fingertip; a color filter which is substantially transparent to the green light generated by the green light-emitting diode and reflected by the fingertip, and which is substantially opaque to non-green light; and at least one optical detector comprising an active matrix sensor array disposed from the fingertip with at least a portion of the color filter disposed between the active matrix sensor array and the fingertip, the active matrix sensor array positioned to receive the green light generated by the green light-emitting diode and reflected by the fingertip.

In yet an additional aspect, the invention comprises a fingerprint sensor comprising: at least one light source comprising a microlens array and a green light-emitting diode which generates green light that is reflected by a fingertip; a color filter which is substantially transparent to the green light generated by the light source and reflected by the fingertip, and which is substantially opaque to non-green light; and at least one optical detector disposed from the fingertip with at least a portion of the color filter disposed between the optical detector and the fingertip, the optical detector positioned to receive the green light generated by the light source and reflected by the fingertip.

In a further aspect the invention comprises a fingerprint sensor comprising: at least one light source comprising a microlens array and a green light-emitting diode which generates green light that is reflected by a fingertip; a color filter which is substantially transparent to the green light generated by the light source and reflected by the fingertip, and which is substantially opaque to non-green light; and at least one optical detector comprising an active matrix sensor array disposed from the fingertip with at least a portion of the color filter disposed between the active matrix sensor array and the fingertip, the active matrix sensor array positioned to receive the green light generated by the green light-emitting diode and reflected by the fingertip.

In a still further aspect, the invention comprises a fingerprint sensor comprising: at least one light source which generates non-red light that is reflected by a fingertip; a color filter which is substantially transparent to the non-red light generated by the light source and reflected by the fingertip, and which is substantially opaque to red light; and at least one optical detector disposed from the fingertip with at least a portion of the color filter disposed between the optical detector and the fingertip, the optical detector positioned to receive the non-red light generated by the light source and reflected by the fingertip.

In another aspect, the invention comprises a fingerprint sensor comprising: at least one light source which generates light that is reflected by a fingertip, the light having a wavelength which is not substantially transmitted through the fingertip; a color filter which is substantially opaque to a portion of ambient light that passes through the fingertip, and which is substantially transparent to the light generated by the light source and reflected by the fingertip; and at least one optical detector disposed from the fingertip with at least a portion of the color filter disposed between the optical detector and the fingertip, the optical detector positioned to receive the light generated by the light source and reflected by the fingertip.

### BRIEF DESCRIPTION OF THE DRAWINGS

These and other aspects, advantages, and novel features of the invention will become apparent upon reading the following detailed description and upon reference to the accompanying drawings. In the drawings, same elements have the same reference numerals in which:

FIG. 1 shows an overview of an optical image sensor system;

FIG. 2 shows an embodiment of an optical module;

FIG. 3A shows a side view of a first embodiment of an optical module;

FIG. 3B shows a side view of a second embodiment of an optical module;

FIG. 4 shows a side view of a third embodiment of an optical module;

FIG. 5 shows upper layers of an optical module with a fingertip placed on a top surface;

FIG. 6 shows a section of the upper layers shown in FIG. 5 with a ridge of a fingertip covering a photosensitive pixel;

FIG. 7 shows a section of the upper layers shown in FIG. 5 with a valley of a fingertip located above a photosensitive pixel;

FIG. 8 shows a schematic circuit diagram of a matrix of photosensitive pixels comprising diodes;

FIGS. 8A and 8B show timing diagrams of address and detector voltages;

FIG. 9 shows a schematic circuit diagram of a matrix of photosensitive pixels comprising transistors;

FIGS. 10A-10D show timing diagrams illustrating operation of the circuit shown in FIG. 9;

FIG. 11 shows an embodiment of fingerprint sensing system;

FIG. 12 shows a flow chart of a read-out procedure;

FIG. 13 shows a block diagram of a driver module;

FIG. 14 shows an embodiment of an optical module having photodetectors and light sources located within one layer;

FIG. 15 shows a first embodiment of a photodetector of a pixel;

FIG. 15A shows a second embodiment of a photodetector of a pixel;

FIG. 16 shows an exemplary topography of a pixel layout;

FIG. 17 shows an embodiment of an optical module that comprises an optical lens;

FIG. 17A shows an embodiment of a light source of a pixel;

FIG. 18 shows a first embodiment of a light source;

FIG. 19 shows a second embodiment of a light source;

FIG. 20 shows an embodiment of an optical module that comprises a reflector and an optical lens;

FIG. 21 shows a further embodiment of an optical module;

FIG. 22 shows an embodiment of an optical module that comprises a fiber optic bundle;

FIG. 23 illustrates a fingerprint sensor in accordance with one aspect of the present invention;

FIG. 24 is a perspective view of a fingerprint sensor showing the contact surface on which a finger is placed;

FIG. 25 illustrates an exemplary transmittance spectrum for color-filters in red, green, and blue;

FIG. 26 illustrates an exemplary emission spectrum for a sensor backlight panel;

FIG. 27 is a perspective view of an optical detector comprising an optical array of pixels;

FIG. 28 illustrates a cross-sectional view of an optical sensor in accordance with one aspect of the present invention;

FIG. 29 illustrates an exemplary optical responsivity of an amorphous-silicon p-i-n photodiode;

FIG. 30 is a flowchart detailing a method for sensing a fingerprint;

FIG. 31A-C illustrate additional embodiments of the fingerprint sensor;

FIG. 32A-C illustrate additional embodiments of the fingerprint sensor;

FIG. 33A-B illustrate a fingerprint sensor attached to a printed circuit board;

FIG. 34A-B illustrate the illumination of a fingerprint surface using exemplary modes of lighting;

FIG. 35 illustrates an exemplary sensor that uses selective reflection to render the fingerprint surface;

FIG. 36A-C illustrate a side injected lighting apparatus for the fingerprint sensor;

FIG. 37A-B illustrate a bottom injected lighting apparatus for the fingerprint sensor;

FIG. 38A-C illustrate a tactile fingerprint sensor in accordance with one aspect of the present invention;

FIG. 39 illustrates another tactile fingerprint sensor in accordance with one aspect of the present invention;

FIG. 40A-B illustrate a fingerprint sensor used in conjunction with a multifunction OLED screen;

FIG. 41 illustrates another embodiment of fingerprint sensor 930 integrated into the multifunction OLED screen;

FIG. 42A-B illustrate an OLED fingerprint sensor with an integrated color filter;

FIG. 43A-B illustrate fingerprint sensor with an OLED backlight;

FIG. 44A-B illustrate an exemplary application of the fingerprint sensor integrated into an identification card;

FIG. 45 illustrates a laptop-computing device with integrated fingerprint sensor;

FIG. 46 illustrates a Personal Digital Assistant (PDA) device with integrated fingerprint sensor;

FIG. 47 illustrates a passive matrix liquid crystal display with integrated fingerprint sensor;

FIG. 48 illustrates an active matrix liquid crystal display device with integrated fingerprint sensor;

FIG. 49 is a cross-sectional representation of a liquid crystal display apparatus with integrated fingerprint sensor;

FIG. 50 is a flow chart showing the operation of one embodiment of the present invention;

FIG. 51 is a block diagram illustrating one embodiment of a fingerprint sensor;

FIG. 52 is a top view of a fingerprint sensor with an optically transparent protective layer for shunting ESD;

FIG. 53 is a top view of a finger print sensor with an optically transparent protective layer with secondary conductive metal foil for shunting ESD;

FIG. 54A illustrates a sample fingerprint image sensed by a sensor without an optically transparent conductive layer;

FIG. 54B illustrates a sample fingerprint image sensed by a fingerprint sensor with an optically transparent conductive protective layer;

FIG. 55 is a circuit diagram of one embodiment of a live finger detection system;

FIG. 56 is a circuit diagram of another embodiment of a live finger detection system;

FIG. 57 is a top view of one embodiment of a finger contact;

FIG. 58A is a side section view of another embodiment of a finger contact;

FIG. 58B is a side section view of the finger contact of FIG. 57;

FIG. 59 is a flow chart showing the operation of one embodiment of the present invention.

### DETAILED DESCRIPTION OF THE PREFERRED EMBODIMENT

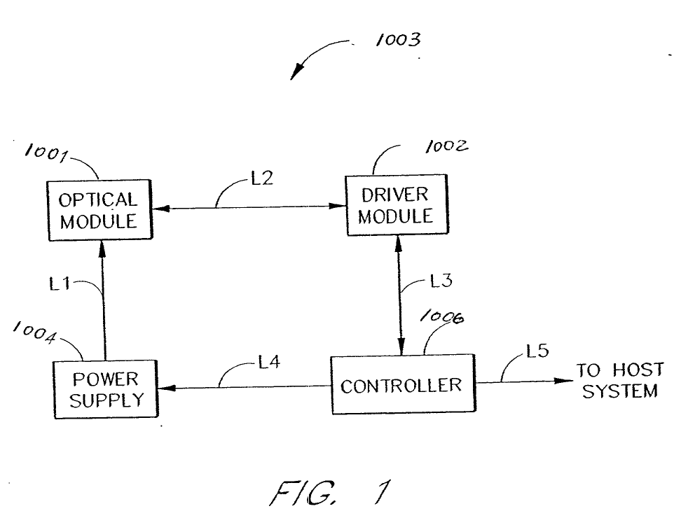

FIG. 1 shows an exemplary embodiment of an optical image sensor system 1003. The optical image sensor system 1003 generates an electronic signal in response to an object that is placed on an optical module 1001. The electronic signal may indicate the presence of the object or correspond to an electronic representation of a surface of the object. In one embodiment, the object is a pencil-like pointer used, for example, to select an icon on a touch pad or “write” on the touch pad. In another embodiment, the object is a relief object such as a tip of a person's finger. As is well known, a human fingertip has a surface that forms a unique pattern of ridges and valleys. The structure of the fingertip, or a print caused when the fingertip is placed on a surface is often referred to as a “fingerprint.” Hereinafter, this term is generally used to refer to the print caused by the fingertip.

Embodiments of the invention are described with reference, but not limited, to a fingertip as the object placed upon the optical module 1001. In response to the presence of the fingerprint, the optical module 1001 generates in one embodiment the electronic representation (“electronic image” or “digital image”) of the fingerprint. The fingerprint resulting from the sensing of the physical fingerprint of the user is referred to as the “sensed” fingerprint to distinguish it from a “stored” fingerprint of an authorized user. As described below in greater detail, if the sensed fingerprint matches the stored fingerprint, the present user is identified as the authorized user.

The illustrated optical image sensor system 1003 further includes a power supply 4, a driver module 1002 and a controller 1006. A connection L1 connects the power supply 1004 to the optical module 1001, and a connection L2 connects the driver module 1002 to the optical module 1001. The controller 1006 is connected to the driver module 1002 and the power supply 1004 through connections L3, L4, respectively. A connection L5 connects the controller 1006, for example, to a processor unit of a host system (not shown).

The host system may be a personal computer (PC), a laptop computer, a cellular phone, a security system, or other equipment installed, for example, in an access-restricted location where high-level security is needed. The host system processes the sensed fingerprint of the present user and matches it with the stored fingerprint of the authorized user. The host system allows full operation of the host system itself, or access to the restricted areas only if the electronic representation of the sensed fingerprint matches the stored fingerprint of the authorized user.

In one embodiment, the optical image sensor system 1003 is an external apparatus that is connectable to a computer (e.g., a desktop computer or a laptop). The computer includes a software program that operates the computer and the optical image sensor system 1003 and performs a matching procedure. In other embodiments, the optical image sensor system 1003 may be implemented, for example, within a computer or a cellular phone. In these embodiments, the optical module 1001 is located so that a user may place a finger on an exposed surface of the optical module 1001. For instance, the optical module may be integrated into a keyboard of a computer or next to the keypad of a cellular phone. Remaining components of the optical image sensor system 1003 are then located within the computer or the cellular phone.

In alternative embodiments the optical image sensor system 1003 may be implemented as a portable, autonomous identification and/or authentication apparatus that includes the components and software to perform the matching procedure and to output the result of the matching procedure. For example, the optical image sensor system 1003 may be implemented within a smart or chip card, or a communications module designed in accordance with a specification defined by the Personal Computer Memory Card International Association (PCMCIA). The communications module is, thus, often referred to as a PCMCIA card.

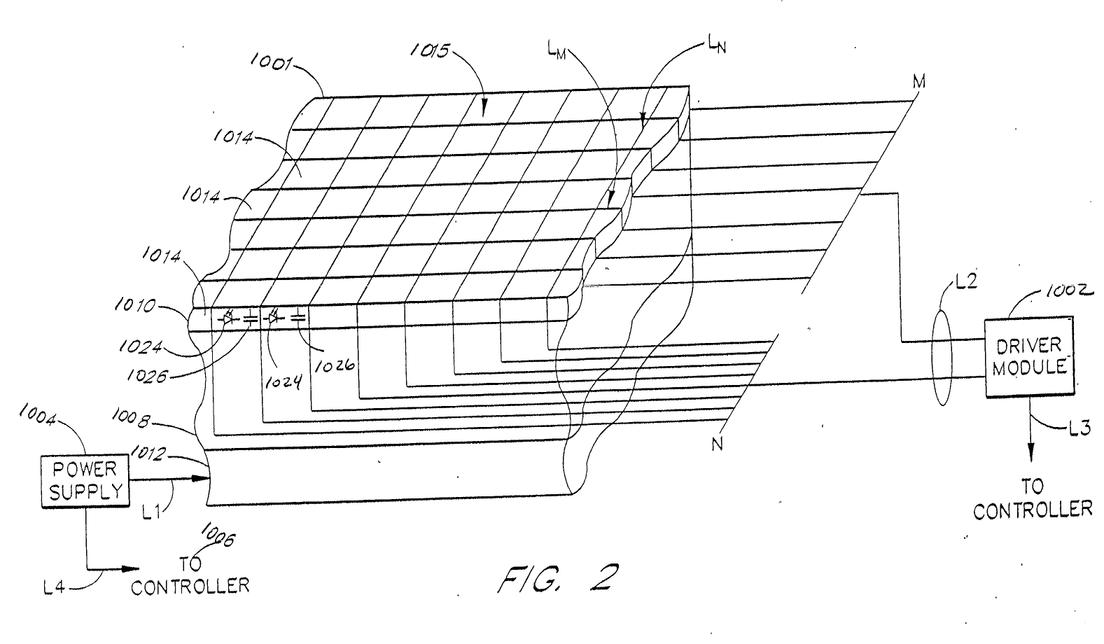

Focusing on an exemplary embodiment of the optical module 1, FIG. 2 shows a perspective view of the optical module 1001 to illustrate a general structure of the optical module 1001. In one embodiment, the optical module 1001 includes multiple layers and has a flat, generally rectangular shape with a planar top surface 1015. The optical module 1001 may have a thickness of about 1-2 mm, a length of about 3 cm, and a width of about 2 cm. The top surface 1015 forms an exposed contact area onto which the user places a finger. The contact area is, for example, about 6 cm². In other embodiments, the top surface 1015 may have a circular-, oval-, square-like, or any other shape of sufficient size to contact a sufficiently large part of the finger.

FIG. 2, as well as the other figures, illustrates the optical module 1001 so that the top surface 1015 and the contact area are horizontal. Terms, such as “top,” “bottom,” “above,” “below,” “underneath,” or the like, to describe the orientation of an element or a layer of the optical module 1001 are, thus, used with reference to the horizontal orientation of the optical module 1001. Those skilled in the art will appreciate that the optical module 1001 may have another orientation and that the terms then apply correspondingly.

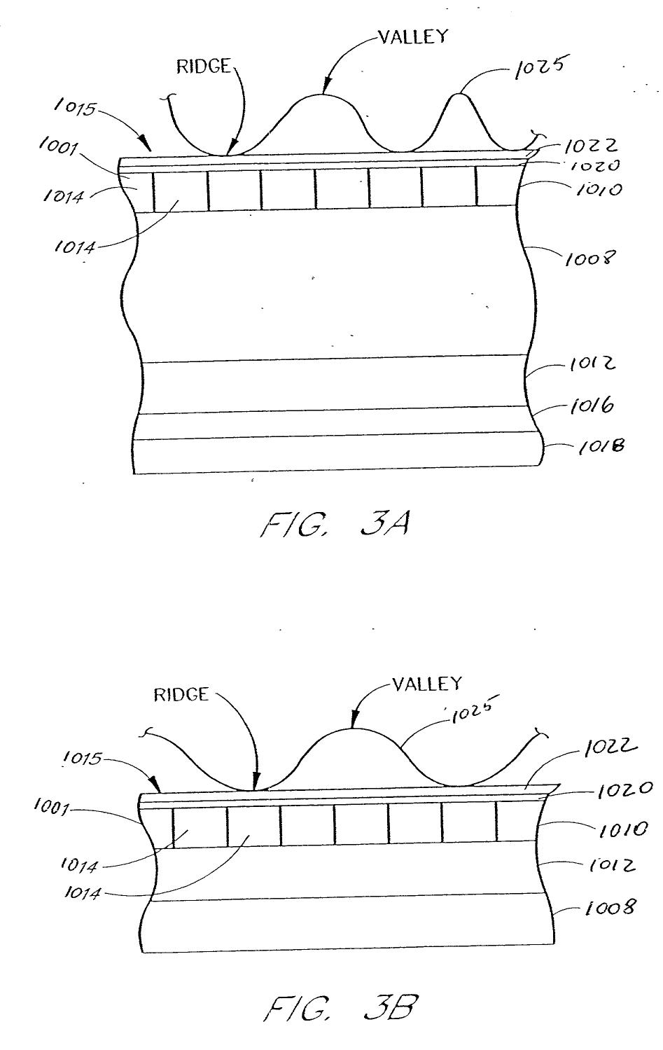

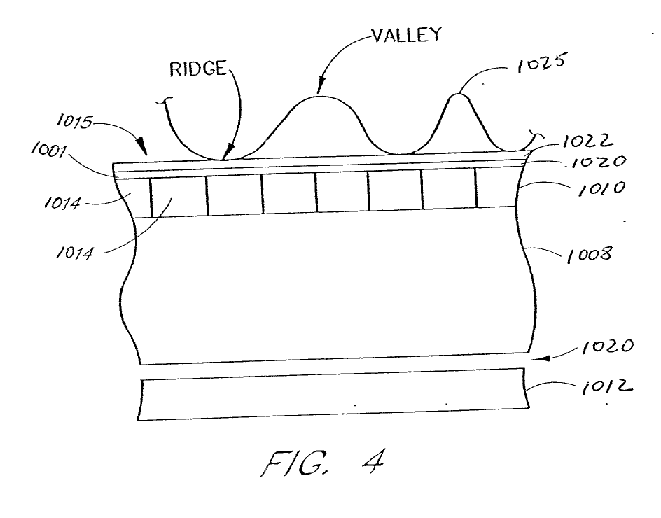

From top to bottom, the optical module 1001 has a detector layer 1010, a substrate layer 1008, and a light source layer 1012. It is contemplated that, in another embodiment, the optical module 1001 may include additional layers (e.g., a surface coating) as shown in FIG. 3. The detector layer 1010 includes a plurality of individual, spaced-apart photosensitive areas. Each photosensitive area is a pixel 1014 of an optical array with the pixels 1014 being arranged in M rows and N columns. In one embodiment, the pixel 1014 has M=315 rows and N=240 columns. As described below with reference to FIG. 5, each pixel 1014 includes in one embodiment a photodetector 1024 and a charge-storing mechanism, for example, an inherent (parasitic) capacitance or a capacitor 1026 electrically coupled to the photodetector 1024. Each pixel 1014, hence, each photodetector 1024, can be selected through an address line L_{M} (row) and a data line L_{N} (column). To illustrate the array structure of the detector layer 1010, the address lines L_{M} and the data lines L_{N} are indicated in the detector layer 1010, but it is contemplated that these lines are for illustrative purposes only and typically not visible. The address lines L_{M} and the data lines L_{N} are connected to the connection L2 that connects the optical module 1001 to the driver module 2.

The photosensitive areas are implemented on top of the substrate layer 1008 which is transparent for light emitted by the light source layer 1012. For instance, the photosensitive areas may be deposited directly on the substrate layer 1008. In one embodiment, a rigid substrate such as glass forms the substrate layer 1008. The glass substrate may have a thickness of about 1.1 mm. Other suitable, transparent materials include plastic-like materials.

In the illustrated embodiment, the light source layer 1012 is in direct contact with the substrate layer 8, and connected to the power supply 1004 which provides electrical power for the light source layer 1012. The light source layer 1012 includes a single light source that extends across the glass substrate and illuminates the glass substrate evenly. In other embodiments, the light source layer 1012 may include multiple individual light sources located to evenly over and illuminate the glass substrate, an array emitter including pixelized light sources, or a light source panel such as an electroluminescent panel. The term “light source” is therefore intended to encompass single or multiple light sources or light source panels which may have a variety of configurations. When the light source is activated, light propagates in upward direction through the transparent substrate layer 1008 and the detector layer 1010 to illuminate the top surface 1015. The light source, therefore, functions as a backlight for the top surface 1015 of the optical module 1001.

The light source layer 1012, and thus the light source, may therefore be implemented in a variety of different ways. The light source may be an electroluminescent device, one or more light emitting diodes (LED's), an electroluminescent device, a backlight device, for example, as used for a liquid crystal displays (LCD), or any other light source suitable to illuminate the substrate layer 1008 of the optical module 1001. Generally, the light source is selected to emit light that passes with minimal attenuation through the substrate layer 1008 and the detector layer 1010 to illuminate the top surface 1015 and the fingertip placed onto the top surface 1015 as explained below. In one embodiment, the light is visible and, for example, emitted by an electroluminescent light source.

The electroluminescent light source may be based on inorganic or organic materials. An organic electroluminescent material includes, for example, thin sublimed molecular films such as tris(8-quinolinolato) aluminum (III) commonly known as Alq or light emitting polymers having specialized structures which provide positive and negative charge carriers having high mobilities. The light-emitting polymers include polyphenylene vinylene (PPV), soluble polythiophene derivatives, and polyanilene which may be applied by known coating techniques such as spin or doctor-blade coating. Further details about organic electroluminescent materials are described in J. C. Sturm et al., “INTEGRATED ORGANIC LIGHT EMITTING DIODE STRUCTURES USING DOPED POLYMERS,” Proceedings of SID, 1997, pages F-11-F18.

An inorganic electroluminescent material includes a phosphor material in combination with materials such as zinc sulfide:manganese (ZnS:Mn), zinc silicate (Zn₂SiO₄) or zinc gallate (ZnGaO₄). In one embodiment, the phosphor, ZnS:Mn material may be dispersed in an insulating dielectric material such as barium titanate (BaTiO₃). Other dielectric materials include yttrium oxide, silicon nitride, and silicon oxy-nitride.

In another embodiment, the light source layer 1012 includes an electroluminescent (EL) panel. Such an EL panel is, for example, manufactured by Durel Corporation of Chandler, Ariz., and designated as part number DB5-615B.

Depending on what kind of light source the light source layer 1012 includes, the power supply 1004 provides either a predetermined voltage or a predetermined current to the light source. For instance, EL panels are voltage-controlled devices. A typical operating voltage for an EL panel ranges approximately between 100 volts and 300 volts. Organic LED's, however, are current-controlled devices. A typical operating current density for an organic LED is in the order of milliamperes per cm₂. Further, the kind of light source determines if the power supply 1004 provides an alternating current (AC) or a direct current (DC), or an AC voltage or a DC voltage.

The light source layer 1012 includes electrodes that are connected to the power supply 1004. In one embodiment, the light source layer 1012 has a transparent electrode that faces the substrate layer 1008, and a bottom electrode. The transparent electrode is, for example, a transparent polymeric material coated with a transparent electrode composition such as indium tin oxide (ITO) or aluminum doped zinc oxide (ZnO:Al). In another embodiment, the transparent electrode composition may include transparent aluminum doped zinc oxide (AZO).

FIG. 3A shows an embodiment of the optical module 1001 in greater detail. In addition, FIG. 3A shows a portion of a fingertip 1025 placed on top of the surface 1015 and having ridges and valleys. The ridges are separated by the valleys and touch the surface 1015. The illustrated embodiment of the optical module 1001 has the same general structure as the embodiment shown in FIG. 2 but shows additional layers. Same elements (layers) have, thus, same reference numerals.

Referring to layers between the top surface 1015 and the detector layer 10, a planarization layer 1020 covers the detector layer 1010 and provides for a planar surface. A planar surface reduces the possibility that undesired residuals remain on the surface of the optical module 1001 and allows easy cleaning of the surface. The planarization layer 1020 is a transparent dielectric insulator and has a thickness of about 1-2 μm. In one embodiment, the dielectric insulator is a non-conducting, transparent polymer such as benzocyclobutene (BCB). Other materials for the planarization layer 1020 (dielectric insulator) include acrylic, epoxy, or polyimide.

Following the planarization layer 1020, a top layer 1022 covers the planarization layer 1020. The top layer 1022 is an electrically conducting material and is in one embodiment connected to ground. As the fingertip 1025 is illuminated from within the optical module 1001, the top layer 1022 is also transparent. In one embodiment, the top layer 1022 includes as transparent and conducting material ITO. The top layer 1022 has a thickness of about 1000 Å. Although the top layer 1022 completely covers the planarization layer 1020 in one embodiment, it is contemplated that the top layer 1022 may be implemented as a plurality of parallel ITO stripes or as a grid of ITO stripes. An advantage of the conducting top layer 1022 is that any static charge the fingertip 1025 may carry is discharged from the top surface 1015 to ground thereby avoiding electrostatic discharge (ESD) problems.

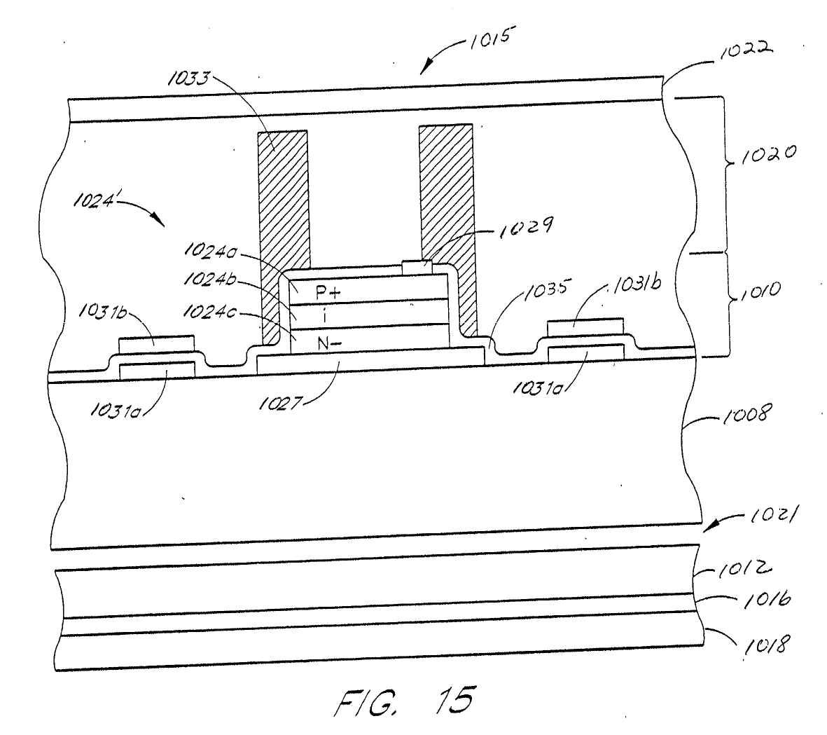

In another embodiment, the transparent and conducting stripes may be implemented so that a finger detection circuit may be fabricated on top of the planarization layer 1020. For example, the finger detection circuit may comprise two ITO electrodes spaced apart from each other. When a fingertip is placed over the these ITO electrodes, a current flows between the ITO electrodes via the fingertip. Further details of detecting the finger are described below with reference to FIG. 11.

Referring to layers underneath the light source layer 1012, a reflector layer 1016 covers a bottom surface of the light source layer 1012. In one embodiment, the reflector layer 1016 is a thin layer of aluminum which reflects light from the light source layer 1012 back into the light source layer 1012. Because the reflector layer 1016 reflects light back into the light source layer 1012, the efficiency of the light source layer 1012 is improved and a higher light intensity reaches the top layer 1015 and the fingertip 1025. The layer of aluminum is conductive and, hence, may serve as an electrode for the light source layer 1012. Those skilled in the art will appreciate that other materials that have conductive and reflective properties may be used to form the reflector layer 1016. These materials, include metals such chromium (Cr), molybdenum (Mo), gold (Au), silver (Ag) and copper (Cu) or alloys including these and other metals.

An insulation layer 1018 covers the reflector layer 1016 and forms in the illustrated embodiment a bottom surface of the optical module 1001. The insulation layer 1018 covers the exposed surface of the reflector layer 1016 and enhances the mirror effect of the reflector layer 1016. In one embodiment, the insulation layer 1018 includes a polymer such as polyester. It is contemplated that other insulating materials such as polyethylene may be used.

FIG. 3B shows a further embodiment of an optical module 1001 which comprises layers and elements already introduced in FIG. 3A, same layers and elements have, thus, the same reference numerals. Compared to the embodiment of FIG. 3A, the order of the detector layer 1010, the light source layer 1012, and the substrate layer 1008 is changed. That is, in FIG. 3B, the light source layer 1012 is positioned between the detector layer 1010 and the substrate layer 1008, whereas in FIG. 3A the substrate layer 1008 is between the detector layer 1010 and the light source layer 1012. On top of the detector layer 1010, the planarization layer 1020 and the top layer 1022 are implemented which perform the same functions as described above.

In one embodiment, the light source layer 1012 includes a thin-film EL panel and the substrate layer 1008 is a glass substrate. Alternatively, the substrate layer 1008 may be formed by a layer of plastic-like material. With the substrate layer 1008 positioned underneath the light source layer 1012, the substrate layer 1008 may be transparent or opaque. In addition, the material for the substrate layer 1008 may be a rigid or a flexible material.

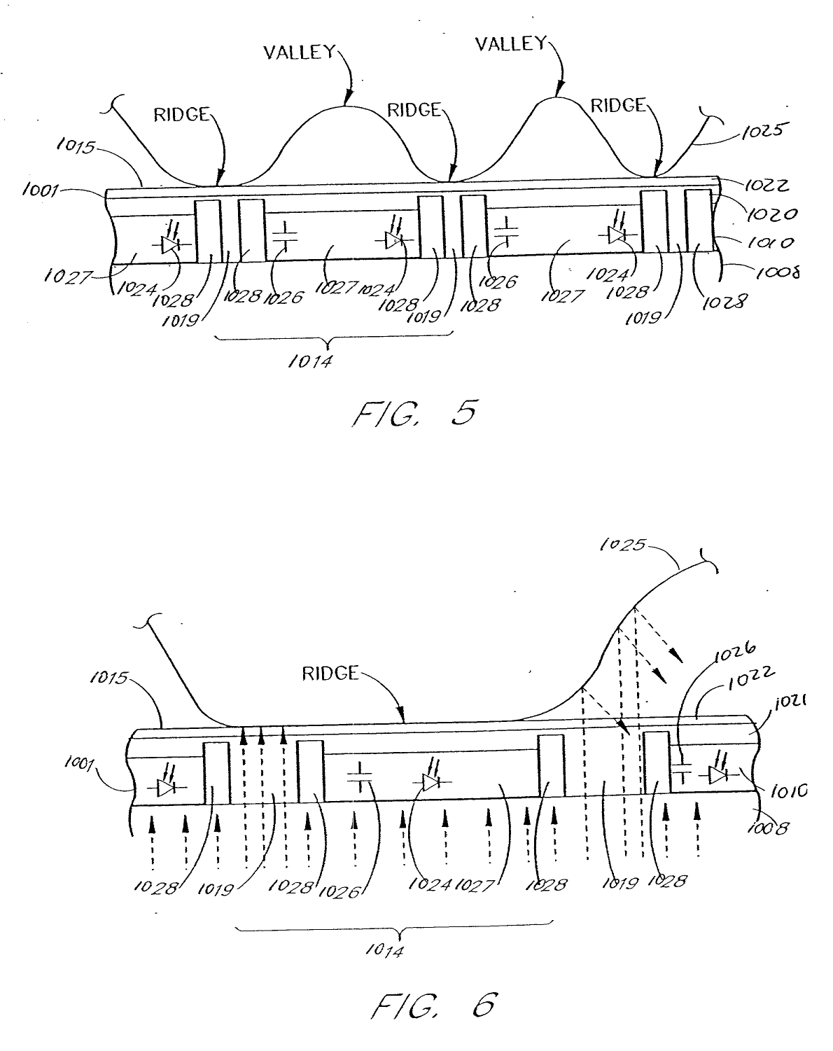

FIG. 4 shows another embodiment of an optical module 1001. From the substrate layer 1008 upward, the structure of the optical module 1001 is as shown in FIG. 3A and same elements have the same reference numerals. The illustrated embodiment differs from the embodiment shown in FIG. 3A in that a gap 1021 exists between the substrate layer 1008 and the light source layer 1012. The gap 1021 may have a width within a wide range, for example, a few microns or several centimeters. In one embodiment, the gap 1021 includes a transparent medium (e.g., air, plastic).

The light source layer 1012 may be permanently connected to the substrate layer 1008 during manufacturing and is an integral part of the optical module 1001. In another embodiment, however, the light source layer 1012 may be an element separate and independent from the substrate layer 1008 and the remaining layers. As a separate element, the user has an additional degree of freedom and may select a particular kind of light source and position it underneath the substrate layer 1008. Criteria for selecting the light source include, to name a few, size, thickness, light intensity, power consumption and wavelength spectrum of the emitted light. For instance, if the optical module is implemented within a portable, battery-operated device, the optical module 1001 must be as small (thin) as possible and consume as little power as possible. In the same application, however, the light intensity should be as high as possible to sufficiently illuminate the fingertip 1025.

The term “optical module 1001” as used in this specification is intended to encompass the various embodiments described herein, for example, the embodiments shown in FIGS. 3A, 3B and the embodiment shown in FIG. 4 in which the light source layer 1012 may be a separate element. It is contemplated that the optical module 1001 may include only the substrate layer 1008 and the upper layers 1010, 1020, 1022, without a light source.

FIG. 5 illustrates one embodiment of the detector layer 1010. The detector layer 1010 is implemented on the surface of the substrate layer 1008 and covered by the planarization layer 1020 and the top layer 1022. For illustrative purposes, the fingertip 1025 is placed on the surface 1015 and two ridges and two valleys are shown. It is contemplated that the FIG. 5 is a magnified illustration of the upper layers 1010, 1020, 1022 of the optical module 1001 and that the size of the fingertip 1025 and the thicknesses of the layers 1010, 1020, 1022 are not to scale.

The detector layer 1010 includes spaced-apart photosensitive areas 1027 which are distributed over the contact area of the optical module 1001. Each photosensitive area 1027 is part of a pixel 1014 and includes a photodetector 1024. The bottom portion (or electrode) of the photosensitive areas 1027 are opaque for light originating from the substrate layer 1008. In the illustrated embodiment, a single pixel 1014 includes the photodetector 1024 and a mechanism that stores electrical charge. The pixels 1014 are separated by light barriers 1028 that extend essentially perpendicular with respect to the substrate layer 1008. Between adjacent light barriers 1028 a transparent area 1019 exists A light barrier 1028 may be formed by a non-conducting opaque material such as a black-matrix material used in liquid-crystal displays (LCDs). In one embodiment, the charge-storing mechanism may be an inherent (parasitic) capacitance of the photodetector 1024. In another embodiment, the charge-storing mechanism may be a capacitor 1026. For illustrative purposes, the charge-storing mechanism is hereinafter indicated through a conventional symbol for a capacitor (1026) and the photodetector 1024 is indicated through a conventional symbol for a photodiode. To indicate that the photodetectors 1024 and the charge-storing mechanisms 1026 function in principle as individual elements, the photodetectors 1024 and the charge-storing mechanisms 1026 are illustrated as neighboring elements. It is contemplated that each photodetector 1024 is electrically associated with one charge-storing mechanism 1026.

The photodetectors 1024 are in one embodiment pin photodiodes. In another embodiment, the photodetectors 1024 are thin film transistors (TFT) each having terminals referred to as gate, drain and source, wherein the gates are photosensitive areas. The pin photodiodes and the TFT photodetectors, respectively, are manufactured through conventional process technologies typically used to manufacture such photosensitive elements. In case the charge-storing mechanism 1026 includes a capacitor, the capacitors (1026) are often manufactured during essentially the same manufacturing process as the photodetectors 1024. As known in the art, photodetectors are sensitive to incident light. When the intensity of the incident light changes, an internally generated current changes. The current that flows when no light is incident is commonly referred to as a “darkcurrent” and the current that flows when light is incident is referred to as a “photocurrent.”

FIG. 6 illustrates a magnified section of the detector layer 1010 shown in FIG. 5. To illustrate the operation of the optical module 1001, the detector layer 1010 includes photodiodes or phototransistors as photodetectors 1024 and capacitors as charge-storing mechanisms 1026. A ridge of the fingertip 1025 is shown covering one pixel 1014. It is contemplated that a ridge of a typical finger may cover about five pixels. Light originating from the light source layer 1012 is indicated through dashed lines. Referring to the covered pixel 1014, the photodetector 1024 and the light barrier 1028 are opaque for the light used and light does not pass through the photodetector 1024 and the light barrier 1028. Light originating from the light source layer 1012 passes through the transparent areas 1019 between the light barriers 1028 and illuminates the fingertip 1025. As illustrated, the light illuminates the ridge which is located immediately above the area 1019. However, as the ridge covers the photodetector 1024 and the area 1019 most of the photons are blocked by the ridge and do not reach the photodetector 1024. Consequently, only a very small or no photocurrent is generated and the area above the photodetector 1024 is represented as a dark pixel. If a digital signal processing is used, the states “no photocurrent” and “dark pixel” may be represented through a logic state “LOW.”

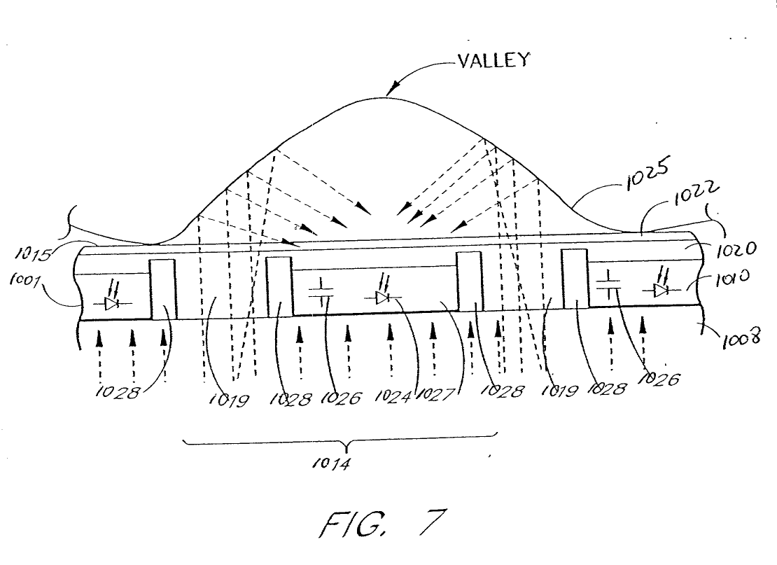

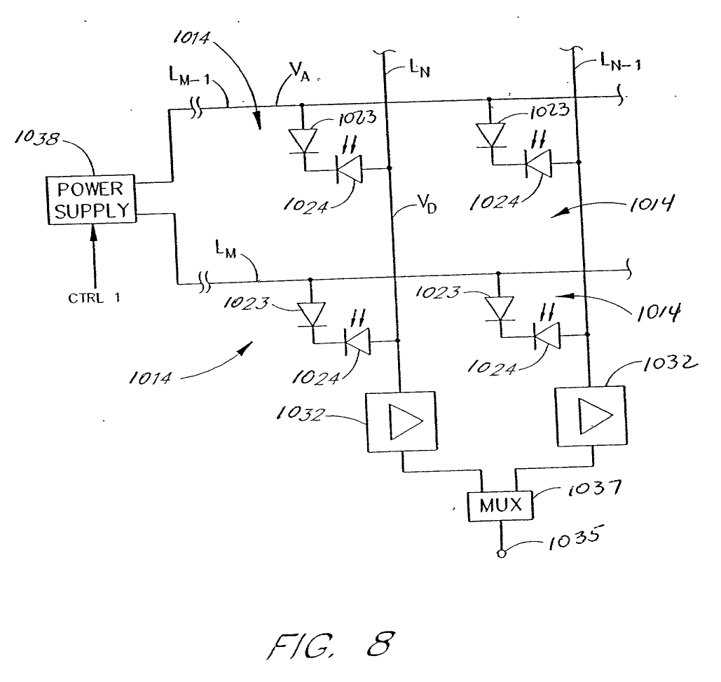

FIG. 7 illustrates a magnified section of the detector layer 1010 with a valley located above the pixel 1014. The detector layer 1010 includes also photodiodes or phototransistors as photodetectors 1024 and capacitors as charge-storing mechanisms 1026. As illustrated, light does not pass through the capacitor 1026 and the photodetector 1024, but passes through the transparent areas 1019 and enters into a cavity formed between the valley and the top surface 1015. Light that enters the cavity is randomly reflected at the surface of the cavity. Some of the reflected light is incident upon the photodetector 1024 and generates a photocurrent. In this case, the area above the photodetector 1024 is represented as a bright pixel. The states “photocurrent” and “bright pixel” may be represented through a logic state “HIGH.”

The light source layer 1012 functions as a backlight that illuminates the fingertip 1025 from within the optical module 1001. The backlight illumination allows that the optical module 1001 and, hence, the optical sensor system 1003 reliably generate a digital image of the fingerprint regardless if the user has a wet, oily or dirty finger. These surface characteristics of the user's finger are usually transparent for the used light and do not influence the path of the light. Light, therefore, enters the cavity and is reflected from the valleys back into the optical module 1001.

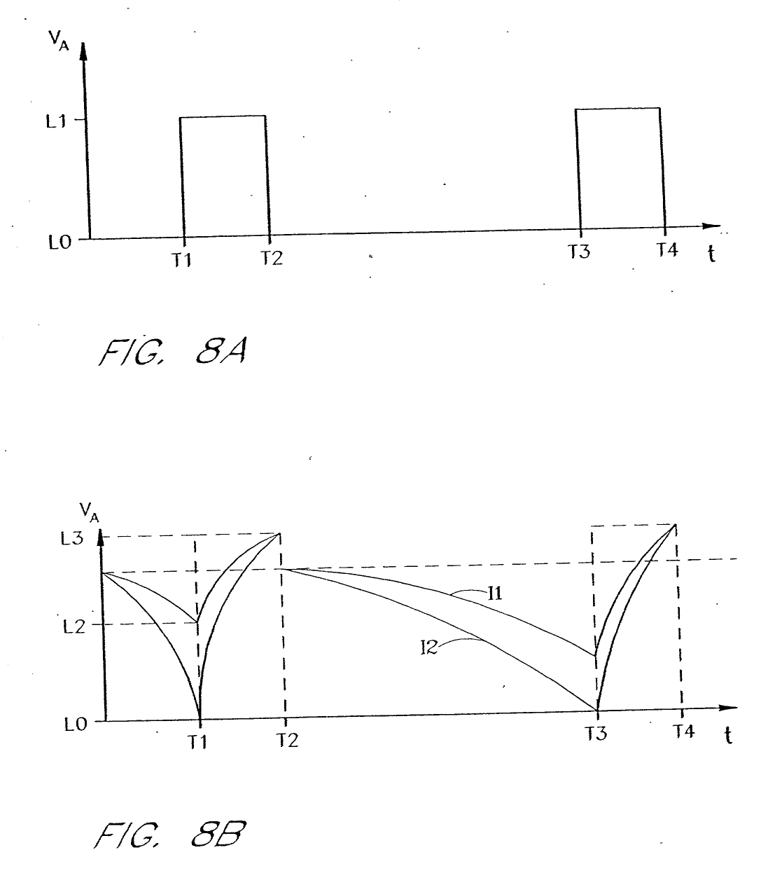

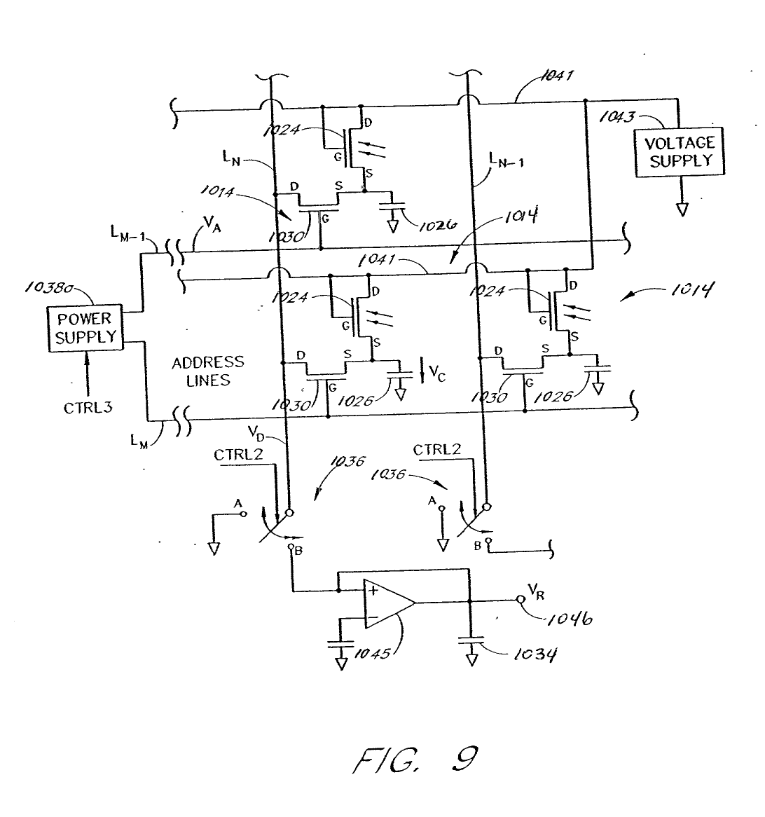

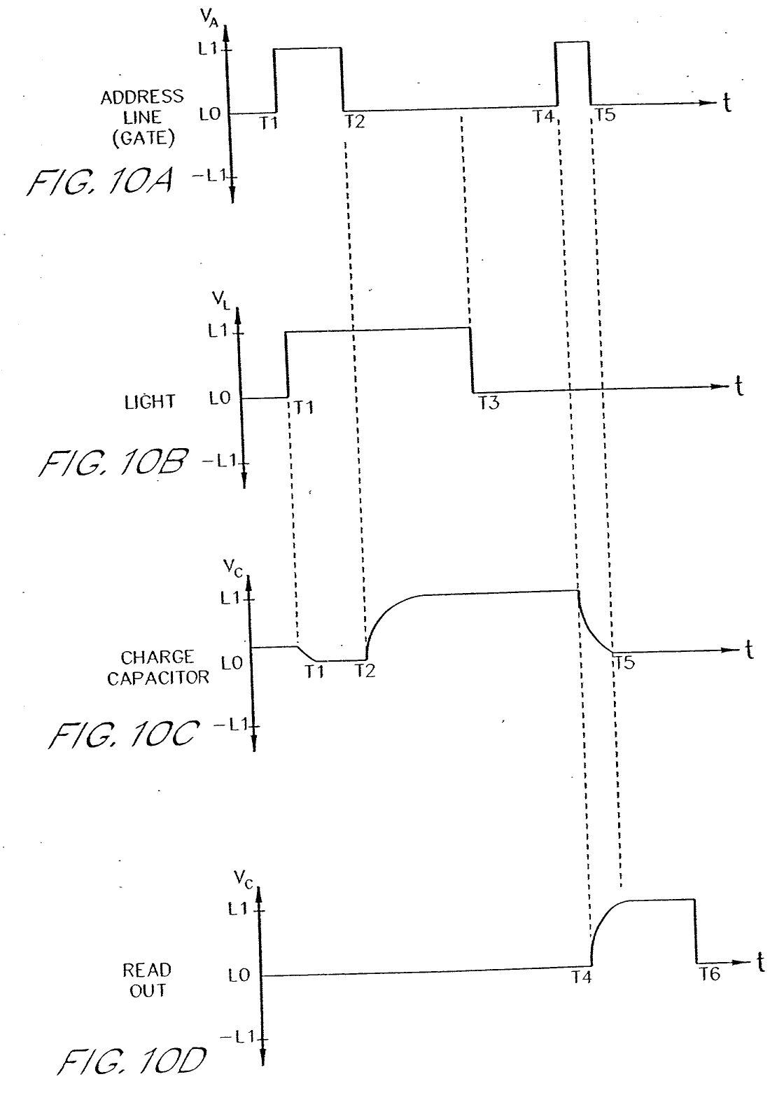

FIG. 8 shows a schematic circuit diagram of a matrix of the photosensitive pixels 1014. For ease of illustration, only circuit diagrams of four pixels 1014 are shown in greater detail. Each pixel 1014 includes one photodetector 1024 and one switching element 1023 and is connected to a data line L_{N}, L_{N-1} and an address line L_{M}, L_{M-1}. It is contemplated that N and M are positive integers. In the illustrated embodiment, the photodetector 1024 is a photodiode, for example, a pin photodiode, and the switching element 1023 is a switching diode, each having an anode and a cathode. The photodetector 1024 is hereinafter referred to as the photodiode 1024.

As each pixel 1014 has the same structure, one embodiment of the pixel array is described hereinafter with reference to the pixel 1014 that is connected to the address line L_{M} and the data line L_{N}. The photodiode 1024 and the switching diode 1023 are connected in series with the cathode of the switching diode 1023 connected to the address line L_{M} and the cathode of the photodiode 1024 connected to the data line L_{N}. The anodes of the diodes 1023 1024 are thus connected.

The address lines L_{M}, L_{M-1}, are connected to a power supply 1038. The power supply 1038 receives a control signal CTRL1 from a central processor (not shown) which controls the operation of the power supply 1038. As a function of the control signal CTRL1, the power supply 1038 selectively provides an address voltage V_{A} having predetermined voltage levels of predetermined durations to the address lines L_{M}, L_{M-1} and, thus, to the cathodes of the individual switching diodes 1023.

The data lines L_{N}, L_{N-1} are connected to amplifiers 1032 and convey in operation data voltages V_{D} to the amplifiers 1032. The amplifiers 1032 are in one embodiment charge-sensitive amplifiers. Outputs of the amplifiers 1032 are connected to a multiplexer 1037 having an output 1035. The output 1035 is connected to a signal processing unit, for example, an analog-to-digital (A/D) converter if the subsequent signal processing is in digital form. The central processor may control the one or more multiplexers.

FIGS. 8A and 8B show timing diagrams, i.e., DC voltages as a function of the time t, illustrating the operation of the circuit shown in FIG. 8. In operation, as shown in FIG. 8A, the power supply 1038 addresses the address lines L_{M} periodically with an address voltage V_{A}. At t=T1, the address voltage V_{A} changes from a low-voltage level L0, for example, about 0 volts, to a higher-voltage level L1, for example, about 4-5 volts, and returns to the level L0 at t=T2. The period between t=T1 and t=T2 is referred to as “pulse duration.” At t=T3, the address voltage V_{A} changes again from the low-voltage level L0 to the higher-voltage level L1, and returns to the low-voltage level L0 at t=T4.

During the pulse duration, the switching diode 1023 is forward biased and a forward-bias current flows through the switching diode 1023. The forward-bias current charges an inherent (parasitic) capacitance of the photodiode 1024. Following t=T2, i.e., following the falling edge of the address voltage V_{A} the switching diode 1023 and the photodiode 1024 are reverse biased.

Between two consecutive pulses, i.e., between t=T2 and t=T3, when the pixel 1014 is illuminated, the capacitance of the photodiode 1024 is discharged by the photocurrent generated in the photodiode 1024. This amount of charge is detected during the following pulse when the photodiode 1024 is charged back to its original value, as explained with reference to FIG. 8B.

FIG. 8B shows the data voltage V_{D} between t=T1 and t=T4 for two different illuminations I1, I2, with I1<I2. The higher illumination I2 generates a higher photocurrent than the lower illumination I1. A high photocurrent discharges the capacitance of the photodiode 1024 faster than a relative low photocurrent. Hence, at the illumination I2, the data voltage V_{D} is lower at t=T1 and t=T3 than at the illumination I1. As illustrated, at these instances t=T1 and t=T3 the data voltage V_{D} is at a level L0, e.g., zero volt, at the illumination I2, and at a level L2, e.g., about 1 volt, at the illumination I1. The amplifiers 1032 detect the amount of charge that is necessary to re-charge the capacitance of the photodiode 1024.

As the data voltage V_{D} for the illumination I2 is lower than the data voltage V_{D} for the illumination I1 at the beginning of the rising edge of the address voltage V_{A}, a higher amount of charge is necessary to re-charge the capacitance of the photodiode 1024 at the illumination I2. The amount necessary for the re-charging is, thus, an indication if a pixel 1014 was exposed to light reflected from the valley of the finger 1009. As illustrated, the voltage V_{D} increases within the pulse duration from the level L0 or the level L2, respectively, to a level L3. The level L3 may be at a voltage of about 5 volts.

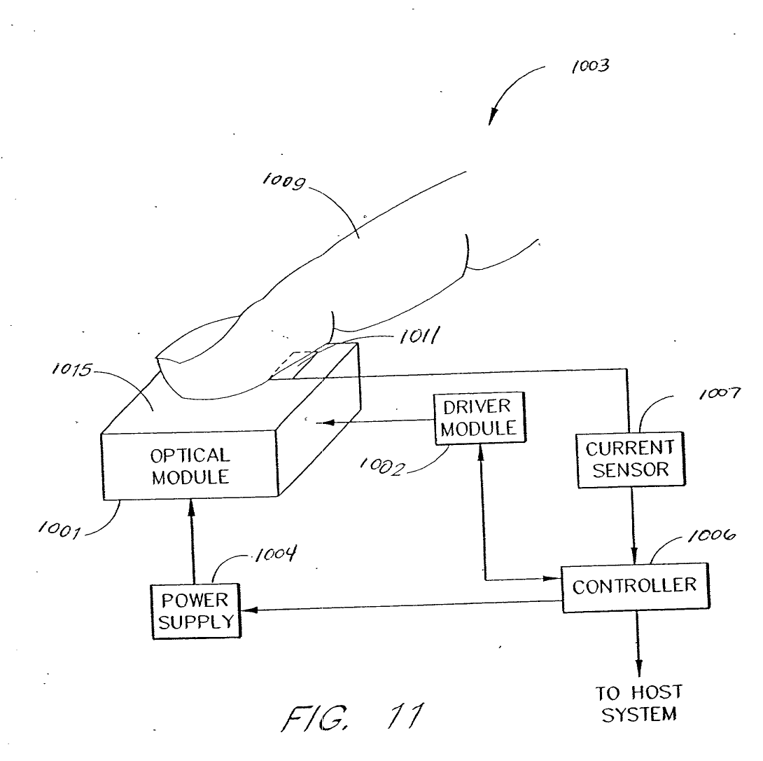

FIG. 9 shows a schematic circuit diagram of a further embodiment of a matrix of the photosensitive pixels 1014. For ease of illustration, only circuit diagrams of three pixels 1014 are shown in greater detail. Each pixel 1014 includes one photodetector 1024, a switching transistor 1030, and one capacitor 1026. As in FIG. 8, each pixel 1014 is connected to a data line L_{N}, L_{N-1} and an address line L_{M}, L_{M-1}. It is contemplated that N and M are positive integers. In the illustrated embodiment, the photodetector 1024 and the switching transistor 1030 are thin film field effect transistors having terminals referred to as drain D, gate G and source S. The photodetector 1024 (hereinafter referred to as the phototransistor 1024) has a photosensitive area that generally exists in an area defined by the gate G.

As each pixel 1014 has the same structure, one embodiment of the pixel array is described hereinafter with reference to the pixel 1014 that is connected to the address line L_{M} and the data line L_{N}. Referring to the phototransistor 1024, the drain D and the gate G are both connected to a power line 1041 which connects the phototransistor 1024 to a voltage supply 1043. The source S of the phototransistor 1024 is connected to the source S of the switching transistor 1030 and a terminal of the capacitor 1026 which has a further terminal that is grounded. The drain D of the switching transistor 1030 is connected to the data line L_{N} and the gate G of the switching transistor 1030 is connected to the address line L_{M}.

In use, the voltage supply 1043 provides a voltage of about −5 volts to the phototransistor 1024. In one embodiment, the voltage supply 1043 provides the voltage only during the period the light source 1012 is active. In another embodiment, the voltage supply 1043 provides the voltage continuously. When the pixel 1014 is exposed to light, the (powered) phototransistor 1024 generates a photocurrent that charges the capacitor 1026 as a function of time and light incident on the phototransistor 1024 causes a voltage V_{c} across the capacitor 1026. While the phototransistor 1024 is exposed to light, the switching transistor 1030 is not conducting and the photocurrent charges the capacitor 1026.

The address lines L_{M}, L_{M-1} l are connected to a power supply 1038a. The power supply 1038a receives a control signal CTRL3 from a central processor (not shown) which controls the operation of the power supply 1038a. As a function of the control signal CTRL3, the power supply 1038a selectively provides predetermined voltage levels of a predetermined duration to the address lines L_{M}, L_{M-1}, and, thus, to the gates G of the individual switching transistors 1030.

The data lines L_{N}, L_{N-1} are connected to switches 1036. In the illustrated embodiment, each switch 1036 has two positions A, B, and receives a control signal CTRL2 that sets the switch 1036 to one of the positions A, B. In position A the data line L_{N} is connected to ground, and in position B the data line L_{N} is connected to an electrical circuit including an amplifier 1145 and a grounded capacitor 1034. The circuit has an output 1146 for a voltage V_{R}. It is contemplated that the switch 1036 assigned to the data line L_{N-1} has also two positions A, B and is likewise connected to an electrical circuit and ground.

It is contemplated that instead of having one electrical circuit for each data line L_{N}, L_{N-1}, a multiplexer may be interposed to reduce the number of amplifier circuits. For instance, a multiplexer may be assigned to several data lines L_{N}, L_{N-1} with an output of the multiplexer connected to the electrical circuit. The central processor may control the one or more multiplexers.

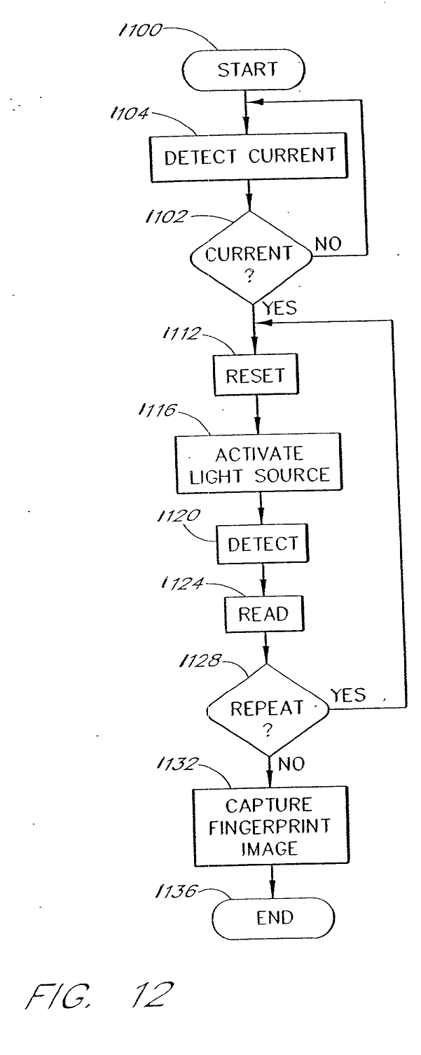

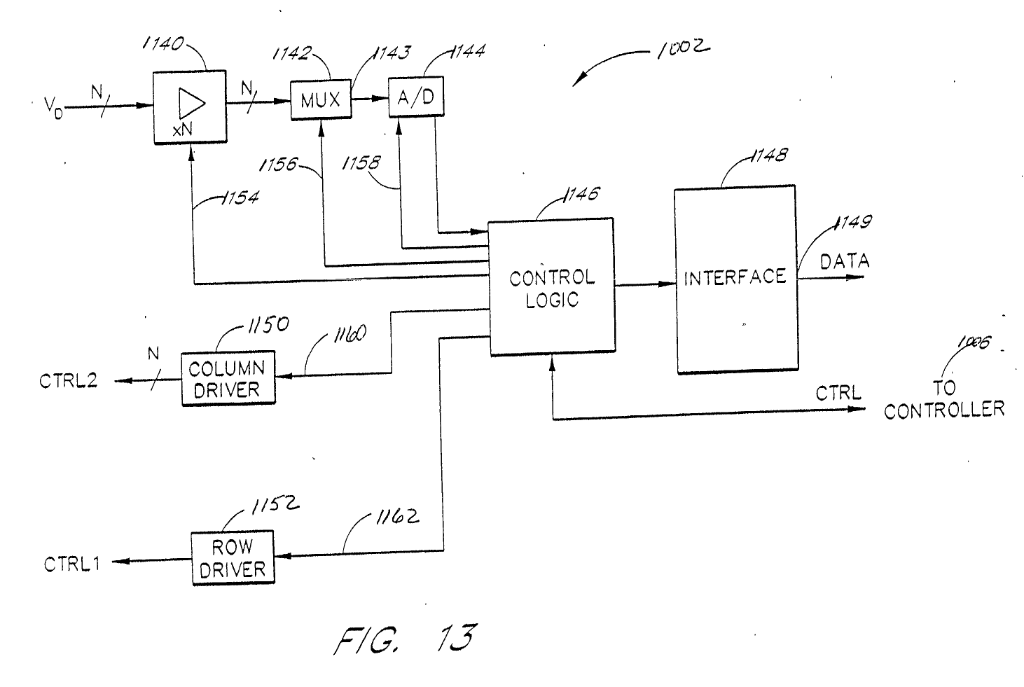

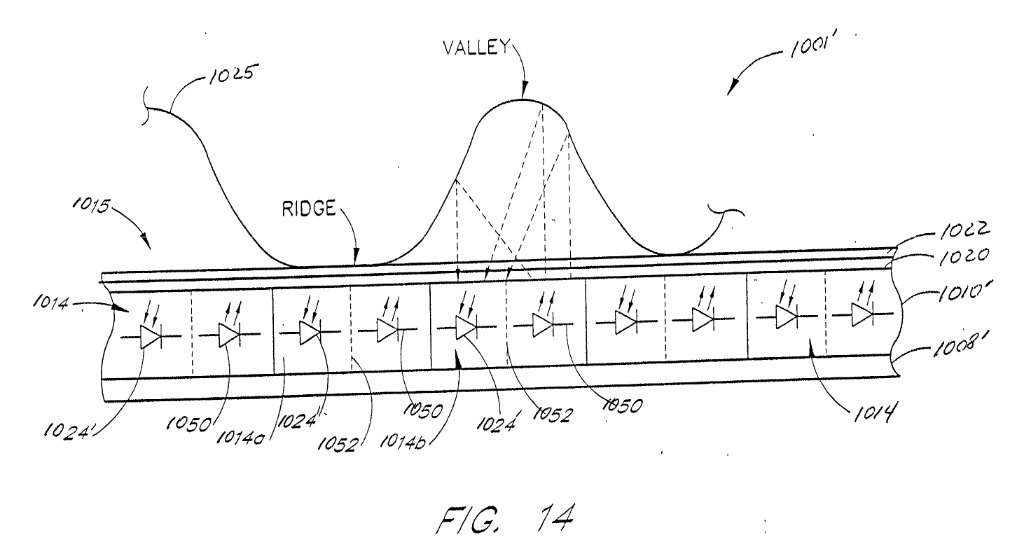

The operation of the circuit is explained with reference to the timing diagrams shown in FIGS. 10A-10D. FIG. 10A shows the address voltage V_{A} output by the power supply 1038a and applied to the address line L_{M} and the gate G of the switching transistor 1030. FIG. 10B shows a voltage V_{L} operating the light source layer 1012 of the optical module 1. The voltage V_{L} indicates periods during which the light source layer 1012 emits light and during which the light source layer 1012 is dark. FIG. 10C shows the voltage V_{C} across the capacitor 1026, and FIG. 10D shows the voltage V_{R} across the capacitor 1034.

Referring to FIG. 10A, at t=T1, the address voltage V_{A} changes from a level L0 to a level L1 and returns to the level L0 at t=T2. The period between t=T1 and t=T2 is referred to as “reset cycle.” At t=T1, the switch 1036 is in the position A connecting the data line L_{N} to ground. In one embodiment, the address voltage V_{A} is approximately between 10 volts and 15 volts. The address voltage V_{A} which is applied to the gate G turns the switching transistor 1030 on and any charge stored on the capacitor 1026 flows from the capacitor 1026 through the switching transistor 1030 (drain-source path), the data line L_{N} and the switch 1036 (position A) to ground. During the reset cycle, the capacitor 1034 is also connected so that any charge is discharged to ground.

As shown in FIG. 10B, the voltage V_{L} changes from the level L0 to the level L1 at t=T1 and activates the light source layer 12. At t=T3 (with T3>T2), the voltage V_{L} returns to the level L0 deactivating the light source layer 12. Hence, in one embodiment, the light source layer 1012 emits light during the reset cycle.

Referring to FIGS. 10A and 10B, with the electrical circuit and the pixel 1014 being reset, the pixel 1014 is enabled to detect light. The period between T2 and T3 is referred to as a “detect cycle” and a corresponding operational state of the optical module 1001 is referred to as “detect mode.” During the detect cycle, the light source layer 1012 is active and the switching transistor 1030 is turned off. The phototransistor 1024 is reverse biased and sensitive to incident light. If no light is incident, the conductivity of a channel existing between the drain D and source S is low and the channel conducts only a minimum current which is commonly referred to as the “dark current.”

Assuming light is incident to the gate area of the phototransistor 1024, for example, because a valley of the fingerprint is above the pixel 1014 (see FIG. 7), charge carriers are generated and the conductivity of the channel increases. The generated charge carriers superimpose with the dark current forming a current commonly known as a the “photo current.” If a ridge of the fingerprint covers the gate area of the transistor 1024, no light is incident and only the dark current flows.

If light is incident, the photocurrent charges the capacitor 1026 during the detect cycle and the voltage V_{C} across the capacitor 1026 changes as a function of time as shown in FIG. 10C. As the capacitor 1026 has been discharged during the reset cycle, the voltage V_{C} is approximately zero before the charging of the capacitor 1026 begins at t=T2. The voltage V_{C} increases in accordance with a conventional charge function of a capacitor until the light source layer 1012 is turned off at t=T3. The capacitor 1026 stores the charge and the voltage V_{C} remains essentially unchanged after the light source layer 1012 has been turned off.

After the detect cycle, the pixel 1014 stores information which indicates if a ridge or a valley is present above the pixel 1014. It is contemplated that every pixel 1014 of the optical module 1001 stores information after a detect cycle and the information together represent the relief structure of the fingerprint. In order to make the information available for a subsequent electronic processing, the information needs to be read during a “read cycle” and a corresponding operational state of the optical module 1001 is referred to as “read mode.”

The read cycle is initiated through applying a positive pulse to the gate G of the switching transistor 1030. As shown in FIG. 10A, the address voltage V_{A} changes from level L0 to level L1 at t=T4 and returns to level L0 at t=T5. During the read cycle the switch 1036 is in position B connecting the data line L_{N} to the amplifier 1045. Further, the light source layer 1012 is deactivated (V_{L}=0 in FIG. 10B) during the read cycle.

The positive address voltage V_{A} activates the switching transistor 1024 as during the reset cycle described above. The activated switching transistor 1024 closes a path from the capacitor 1026 to the amplifier 1045 and a read-out current flows discharging the capacitor 1026. The amplifier 1045 and the capacitor 1034 are connected to form an integrator. The read-out current charges the capacitor 1034 causing the voltage V_{R}. FIG. 10D illustrates the voltage V_{R} as a function of time. The voltage V_{R} increases during the read cycle, i.e., between t=T4 and t=T5, up to the level L1 and remains essentially constant at this level L1 thereafter. In the illustrated embodiment, the capacitor 1034 is discharged at t=T6 and the voltage V_{R} drops to the level L0.

In one embodiment, the amplifier 1045 and the capacitor 1034 are part of the driver module 1002 (FIG. 1). The amplifier 1045 and the capacitor 1034 are controllable by the controller 1006. At the end of the read cycle, the controller 1006 “polls” the capacitor 1034 at regular polling instances to determine the voltage V_{R} at these polling instances. If the voltage V_{R} has the level L1, the controller 1006 interprets this as “valley above pixel 1014.” If the voltage V_{R} has the level L0 at a polling instance, the controller 1006 interprets this as “ridge above pixel 1014.” By polling all pixels 1014 of the optical module 1001 in the same manner, the controller 1006 creates the electronic representation of the fingerprint.

FIG. 11 shows a further embodiment of an optical image sensor system 1003′. The system 1003′ generally corresponds to the system 1003 shown in FIG. 1. Same components have therefore the same reference numerals. The optical module 1001 is illustrated in a perspective view with a finger 1009 placed on the surface 1015 of the optical module 1001. The optical module 1001 includes a contact pad 1011 at the surface 1015, and a sensor module 1007 is connected to the contact pad 1011. Like the driver module 1002 and the power supply 1004, the sensor module 1007 is connected to the controller 1006.

The sensor module 1007 and the contact pad 1011 are configured to detect if the finger 1009 is placed on the optical module 1001. When placed on the optical module 1, the finger 1009 closes an electrical loop and a current flows across the finger surface. In one embodiment, the sensor module 1007 is a current sensor that detects if the finger 1009 is present. In other embodiments, the sensor module 1007 may be a voltage sensor that determines a voltage across a resistor, or a sensor that determines the conductivity of the loop.

The contact pad 1011 may be implemented in various ways. For instance, the contact pad 1011 may be a circular contact element (contact ring) that surrounds the area where the finger 1009 is placed, or the contact pad 1011 may include several independent pads located in the plane of the surface 1015. When the finger 1009 is placed, a current flows, for example, between the contact ring, the finger surface, and the grounded surface of the optical module 1001. In another embodiment, the contact pad 1011 may have several first electrodes and several second electrodes connected to the sensor module 1007, wherein the first and second electrodes are interdigited. The finger 1009 connects the first and second electrodes and, hence, closes the loop.

FIG. 12 is a flow chart illustrating a procedure of operating the optical module 1001 of the optical image sensor system 1003′ shown in FIG. 11. The procedure is described with reference to the detector array that includes the switching transistors 1030 and the phototransistors 1024. It is contemplated that a similar procedure is executed when the detector array includes the switching diodes 1023 and the photodiodes 1024. The procedure is initialized in step 1100 in which the controller 1006 may conduct a self-test to determine, among others, if the driver module 1002, the power supply 1004 and the optical module 1001 are properly connected and operable.

Proceeding to steps 1104 and 108, the controller 1006 determines if the sensor module 1007 detects a current that flows between the contact pad 1011 and the surface 1015 of the optical module 1001. In step 1108, if the sensor module 1007 does not detect a current, the procedure returns along the NO branch to step 1104. As long as the sensor module 1007 does not detect a current, the controller 1006 disables a further execution of the procedure because the finger 1009 is not present. However, if the sensor module 1007 detects a current, the controller 1006 determines that the finger 1009 is present and the procedure proceeds along the YES branch to step 1112. It is contemplated that the steps 1104 and 1108 are optional and are omitted in systems, like the optical image sensor system 1003 shown in FIG. 1, that do not include a sensor module 1007.

Proceeding to step 1112, the controller 1006 resets the optical module 1001 to prepare capturing of the fingerprint caused by the finger 1009. For instance, the controller 1006 applies the positive voltage V_{A} to the gates G of the switching transistors 1030 to reset the capacitors 1026 during the reset cycle. It is contemplated that in step 1112 and the following steps, the controller 1006 operates the switches 1036 as described with reference to FIGS. 10A-10D and no specific reference to the positions A, B of the switches 1036 is made hereinafter.

Proceeding to step 1116, the controller 1006 controls the power supply 1004 to activate the light source layer 1012. The activated light source layer 1012 illuminates the surface 1015 of the optical module 1001. As shown in FIGS. 10A, 10B, the light source layer 1012 is activated at the beginning of the reset cycle (t=T1).

Proceeding to step 1120, the controller 1006 operates the driver module 1002 to apply a positive voltage V_{D} (level L1) to the data lines L_{N}, L_{N-1} and thus to the drains D of the switching transistors 1030. During this detect cycle, the phototransistors 1024 which are covered by ridges do not generate photocurrents and the capacitors 1026 are not charged. However, those phototransistors 1024, which are not covered by ridges, generate photocurrents that charge the capacitors 1026. FIG. 10D illustrates the charging of the capacitors 1026 as a function of time.

Proceeding to step 1124, the controller 1006 operates the driver module 1002 to read the information stored on the capacitors 1026. With the voltages V_{A} and V_{L} and switches 1036 properly set, conductive paths exist between the capacitors 1026 and the amplifiers 1032 and the capacitors 1034. Those capacitors 1026, which have been charged by the photocurrents, are sources for discharge currents that the amplifiers 1032 and the capacitors 1034 integrate. If the voltage V_{R} of a capacitor 1034 is at the level L1, a valley was placed over the pixel 1014 and, correspondingly, if the voltage V_{R} is at the level L0, a ridge covered the pixel 1014.

During the read cycle, the controller 1006 determines the values of the voltages V_{R} of the capacitors 1034. In their entirety, these values represent a digital representation of the fingerprint. The controller 1006 can evaluate the representation and determine the quality of the representation, for example, if the fingerprint image is too bright or too dark, or if the exposure time needs to be increased or decreased. In any case, the controller 1006 may adjust the intensity of the light emitted by the light source layer 1012 by controlling the voltage and/or the duration of the voltage supplied to the light source layer 1012.

Because of this adjustment process, the steps 1112-1124 may be repeated as indicated in step 1128. In one embodiment, the procedure returns along the YES branch to step 1112 three times in order to generate four representations of the fingerprint images. For instance, the representations are generated at a rate of four representations per second. When the fourth representation is generated the procedure proceeds along the NO branch to step 1132.

In step 1132, the final representation of the fingerprint image is captured and stored in a storage device. The storage device may be accessed by a matching unit, which compares the captured representation of the present fingerprint with a stored fingerprint of the owner. The matching unit may be located within the controller 1006 or within the host system. The procedure ends at step 1136.

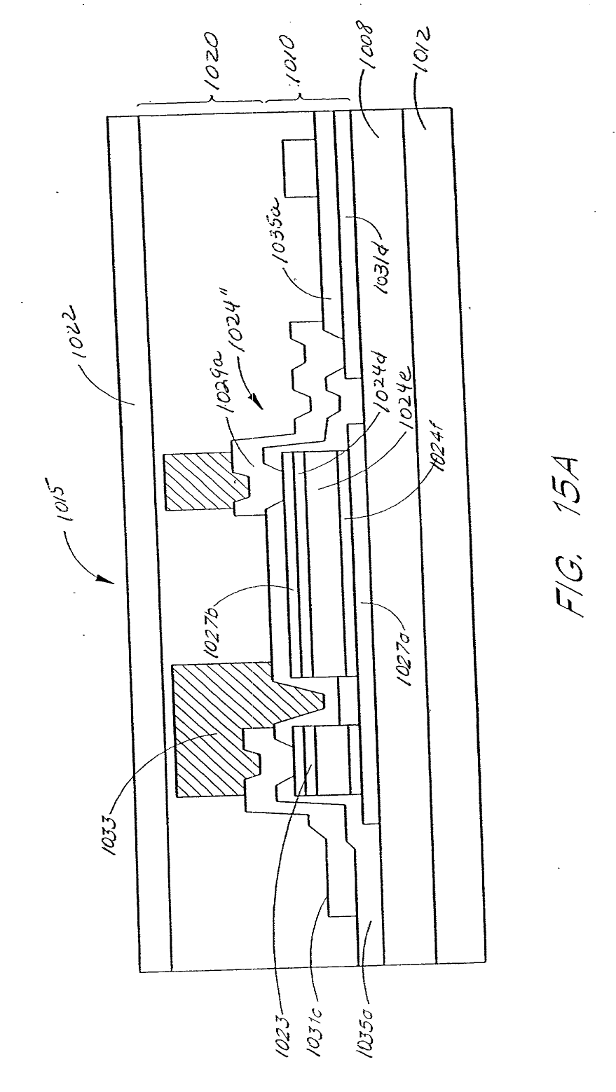

FIG. 13 shows a block diagram of a driver module 1002 which may be configured for use with the electrical circuits shown in FIG. 8 and FIG. 9. The driver module 1002 is associated with the N address lines L_{N}, L_{N-1} (rows) and M data lines L_{M}, L_{M-1}, (columns) of the `optical module 1. In the illustrated embodiment, the driver module 1002 includes components which are already shown in FIG. 8 and FIG. 9. That is, for example, a multiplexer 1008 corresponds to the multiplexer 1037 of FIG. 8, and an input amplifier module 1140 includes the amplifiers 1032 shown in FIG. 8.

The input amplifier module 1140 has N inputs and N amplifiers to connect to the data lines L_{N}, L_{N-1}. The N amplifiers of the input amplifier module 1140 operate as charge sense amplifiers to determine the charge necessary to re-charge the capacitance of the photodiode 1024 (FIG. 8B). The input amplifier module 1140 has N outputs which are connected to inputs of the multiplexer 1142. The multiplexer 1142 has an output 1143 which is connected to an input of an analog-to-digital (A/D) converter 1144. An output of the A/D converter 1144 is connected to a control logic 1146.

The control logic 1146 is connected to an interface 1148 which has an output 1149 for a signal DATA and which is connected to the controller 1006. The control logic 1146 is further directly connected to the controller 1006 to receive a control signal CTRL that the control logic 1146 uses to generate individual control signals. Control lines 1154, 1156, 1158 connect the control logic 1146 to the input amplifier module 1140, the multiplexer 1142, and the A/D converter 1144, respectively. For instance, the individual control signals include a control signal to set an amplification factor of the input amplifier module 1140, and timing control signals to clock the multiplexer 1142 and the A/D converter 1144.

The driver module 1002 further includes a column driver 1150 and a row driver 1152. The column driver 1150 may be disabled when used in combination with the circuit of FIG. 8. A control line 1160 connects the column driver 1150 and the control logic 1146, and a control line 1162 connects the row driver 1152 and the control logic 1146. In one embodiment, the column driver 1150 has N outputs connected to the switches 1036, and generates N control signals CTRL2, one for each switch 1036, to operate the switches 1036 between the positions A, B.

In the illustrated embodiment, the row driver 1152 has an output which is connected to the power supply 1038, 1038a. The output provides the control signal CTRL1, CTRL2 which controls the power supply 1038, 1038a to drive the address lines L_{M} with the voltage V_{A}. It is contemplated that in another embodiment the row driver 1152 may have M outputs to directly drive each address line L_{M}. In this case, the row driver 1152 includes a power supply corresponding to the power supply 1038, 1038a.

The driver module 1002 is in one embodiment implemented as an application specific integrated circuit (ASIC), for example, in CMOS technology. Those skilled in the art will appreciate that the driver module 1002 may also be implemented, for example, in hybrid technology using discrete components. Further, those skilled in the art will appreciate that in other embodiments the structure of the illustrated driver module 1002 may be modified although the general function of the driver module 1002 is maintained.

FIG. 14 shows another embodiment of an optical module 1001′. The fingertip 1025 is placed on the surface 1015, wherein a ridge covers a pixel 1014a and a valley is located above a neighboring pixel 1014b. The pixels 1014a, 1014b are representatives of the pixels 1014 of the optical module 1001′, which have the same structure as the pixels 1014a, 1014b. The general structure of the pixels 1014 is described with reference to the pixel 1014a.

The optical module 1001′ has a multiple layer structure. In the illustrated embodiment, four layers 1008′, 1010′, 1020, 1022 are shown, wherein the layers 1020, 1022 are the planarization layer 1020 and top layer 1022, respectively, described with reference to FIG. 3. The planarization layer 1020 covers an active layer 1010′, which is implemented on a substrate layer 1008′. Within the active layer 1010′, the pixels 1014, 1014a, 1014b are implemented. The active layer 1010′ also includes conductor lines (not shown) to electrically connect the pixels 1014, 1014a, 14b, for example, to the driver module 1002.

The pixel 14a includes a light source 1050 and a photodetector 1024′ which are both implemented in the active layer 1010′. The photodetector 1024′ is in one embodiment a pin photodiode, and the light source 1050 is a light emitting diode (LED). The photodetector 1024′ and the light source 1050 are indicated through conventional symbols, respectively. In another embodiment, the photodetector 1024 is a photodiode or a phototransistor (e.g., a TFT). A light barrier 1052 separates the photodetector 1024′ and the light source 1050 to avoid that light is directly incident on the photodetector 1024′. The light barrier 1052 is indicated through a dashed line between the symbols for the photodetector 1024′ and the light source 1050. Those skilled in the art will appreciate that each pixel 1014 is optically isolated from neighboring pixels 1014 to avoid that light from the light source 1050 is directly incident on the photodetector 1024′ of a neighboring pixel 1014.

It is contemplated that the light barrier 1052 may be implemented in various ways. For instance, in one embodiment, the light barrier 1052 may be an opaque, wall-like barrier that may extend in vertical direction beyond the planes of the photodetector 1024′ and the light source 1050. In another embodiment, the light source 1050 or the photodetector 1024′ may be positioned within cavities that have openings facing the planarization layer 1020. In yet another embodiment, both the photodetector 1024′ and the light source 1050 may be positioned within cavities.

The substrate layer 1008′ includes a material selected to allow the implementation of the active layer 1010′ through conventional high temperature, chemical deposition processes, and may be a transparent or opaque material. In one embodiment, the substrate layer 1008′ is a glass substrate onto which the active layer 1010′ is grown. In other embodiments, the substrate layer 1008′ may be a semiconductor substrate such as a silicon or gallium arsenide substrate, or a temperature resistant polymer material.

In FIG. 14, the valley of the fingertip 1025 is above the pixel 1014b and the ridge covers the pixel 1014a. In operation, the light source 1050 of the pixel 1014b emits light that passes through the layers 1020, 1022 and is reflected on the inclined surfaces of the valley. The reflected light is incident on the photodetector 1024′ which generates a photocurrent, as described above. The photocurrent indicates that a valley was located above the pixel 1014b. The light source 1050 of the pixel 1014a also emits light that passes through the layers 1020, 1022, but substantially no light is incident on the photodetector 1024′ because the pixel 1014a is covered by the ridge. As a consequence, the photodetector 1024′ does not generate a photocurrent. The substantially unchanged dark current indicates that a ridge covered the pixel 1014a.

Focusing on a particular embodiment of the detector layer 1010, FIG. 15 shows an enlarged view of a section of the pixel 1014. As in the previous embodiments, the pixel 1014 includes, from top to bottom, the top layer 1022, the planarization layer 1020, the detector layer 1010, the substrate layer 1008, the light source layer 1012, the reflector layer 1016, and the insulation layer 1018. As in FIG. 4, the gap 1021 separates the light source layer 1012 and the substrate layer 1008. In another embodiment, the light source layer 1012 and the substrate layer 1008 are in direct contact, for example, as shown in FIG. 3.

The detector layer 1010 includes a photodetector 1024′ which is in the illustrated embodiment a photodiode. It is contemplated that the pixel 1014 further includes the switching diode 1023 which is not shown in the illustrated section of the pixel 1014. The photodiode 1024′ is a pin photodiode which comprises a photoactive p-layer 1024 a, an intrinsic (i)-layer 1024b and an n-layer 1024c. The photodiode 1024′ is implemented above an electrode 1027 through a conventional process for pin photodiodes. The n-layer 1024c is formed by a layer of amorphous silicon (a-Si:H) doped to be of n-type silicon, and the p-layer 1024 a is formed by a layer of amorphous silicon doped to be of p-type silicon. Between the p- and n-layers 1024a, 1024c, a layer of undoped amorphous silicon forms the i-layer 1024b. The p-layer 1024a can be covered by a layer of transparent and conducting ITO (not shown) which is in contact with an electrode 1029 indicated on top of the p-layer 1024a.

The electrodes 1027, 1029 and bus lines 1031a, 1031b are, for example, thin layers of chromium. It is contemplated that other conducting materials, such as molybdenum (Mo) or tungsten (W), may be used to form the electrodes 1027, 1029 and the bus lines 1031 a, 1031b. In one embodiment, the bus lines 1031 a are part of the lines L_{N}, L_{N-1} and the bus lines 1031b are part of the lines L_{M}, L_{M-1}. The bus lines 1031b are implemented on top of the bus lines 1031 a and separated through a passivation layer 1035. The passivation layer 1035, thus, covers the bus lines 1031 a and the pin diode 1024′.

The p-layer 1024a faces the top surface 1015 through which light re-enters the optical module 1001 when the walls of a valley reflect the light. The photodiode 1024′ ideally does not receive light reflected from a ridge located above the pixel 1014. The pixel 1014 includes a light barrier 1033 that surrounds the photodiode 1024′ avoiding that extraneous light is incident onto the photodiode 1024′ covered by the area of the ridge. Without the light barrier 1033, sidewalls of the photodiode 1024′ would be exposed to backlight illumination. Therefore, photocurrent would be generated by absorbing light incident via the sidewall. The increase in the photocurrent would increase the noise level and hence reduce the contrast ratio of the fingerprint image. In one embodiment, the light barrier 1033 has a hollow, elongate body of an opaque material. The opaque material may be an organic resin or any nonconducting material.

The light barrier 1033 is formed through a multiple-step process. When the photodiode 1024′ has been implemented, in a first step, the opaque material is applied through, for example, spin coating so that the opaque material covers the photodiode 1024′, the bus lines 1031, and the remaining areas of the pixel 1014. In a second step, a mask is applied and the shape and location of the light barrier 1033 is defined by means of a photo-lithography process. A third step is a dry-etching process which removes undesired opaque material thereby forming the light barrier 1033. The third step may be simplified without using a dry-etching process if a photo-definable opaque material is used.

After the photodiode 1024′ and the light barrier 1033 are implemented, the transparent planarization layer 1020 is applied. The planarization layer 1020 may completely cover a top surface of the light barrier 1033 as illustrated. In another embodiment, however, the top surface of the light barrier 1033 may be in the same plane as the top surface of the planarization layer 1020 and covered by the top layer 1022.

The light barrier 1033 prohibits that scattered light is incident on the photodiode 1024′ and, thus, allows only reflected light to enter the photodiode 1024′. The pixel 1014 provides for an improved contrast because the difference in intensities between “dark” and “bright” is greater. “Dark” refers to a situation in which the pixel 1014 is covered by a ridge, and “bright” refers to a situation in which a valley is located above the pixel and the walls of the valley reflect light.

Those skilled in the art will appreciate that in another embodiment the light barrier 1033 and a TFT transistor may be combined. As in the above example, the light barrier 1033 protects the TFT transistor from scattered or lateral incident light. Further, those skilled in the art will appreciate that the light barrier 1033 may also be combined with the embodiment shown in FIG. 14 in which the photodetector 1024′ and the light source 1050 of a pixel 1014 lay in the same plane.

FIG. 15A shows a further enlarged view of a section of the pixel 1014. As in the previous embodiments, the pixel 1014 includes, from top to bottom, the top layer 1022, the planarization layer 1020, the detector layer 1010, the substrate layer 1008, and the light source layer 1012. In another embodiment, the light source layer 1012 and the substrate layer 1008 may be separated through a gap, for example, as shown in FIG. 4.

The detector layer 1010 includes a photodetector 1024 ″ which is a pin photodiode which comprises a photoactive p-layer 1024d, an intrinsic (i)-layer 1024e and an n-layer 1024f. The photodiode 1024″ is implemented above a chromium (Cr) electrode 1027 a through a conventional process for pin photodiodes. The n-layer 1024f is formed by a layer of amorphous silicon (a-Si:H) doped to be of n-type silicon, and the p-layer 1024d is formed by a layer of amorphous silicon doped to be of p-type silicon. Between the p- and n-layers 1024a, 1024c, a layer of undoped amorphous silicon forms the i-layer 1024e. The p-layer 1024d is covered by a layer 1027b of transparent conducting ITO which is in contact with an electrode 1029a indicated on top of the p-layer 1024d.

The electrodes 1027a, 1029a and bus lines 1031c, 1031d are, for example, thin layers of chromium or a combination of chromium and aluminum. It is contemplated that other conducting materials, such as Mo or W, may be used to form the electrodes 1027a, 1029a and the bus lines 1031c, 1031d. In one embodiment, the bus lines 1031c are part of the data lines L_{N}, L_{N-1} and the bus lines 1031d are part of the address lines L_{M}, L_{M-1}. The bus lines 1031d and the bus lines 1031c are separated through a passivation layer 1035a.

In the illustrated embodiment, the switching diode 1023 is also a pin photodetector and has generally the same structure as the pin photodiode 102′ of FIG. 15. The light barrier 1033 is implemented as described above. In addition, the light barrier 1033 covers the switching diode 1023.

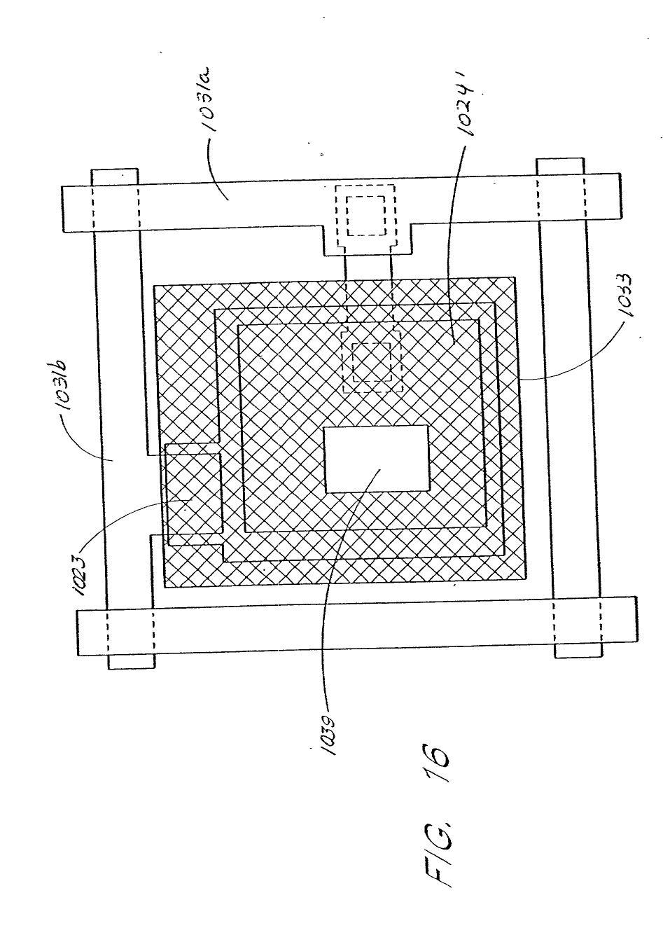

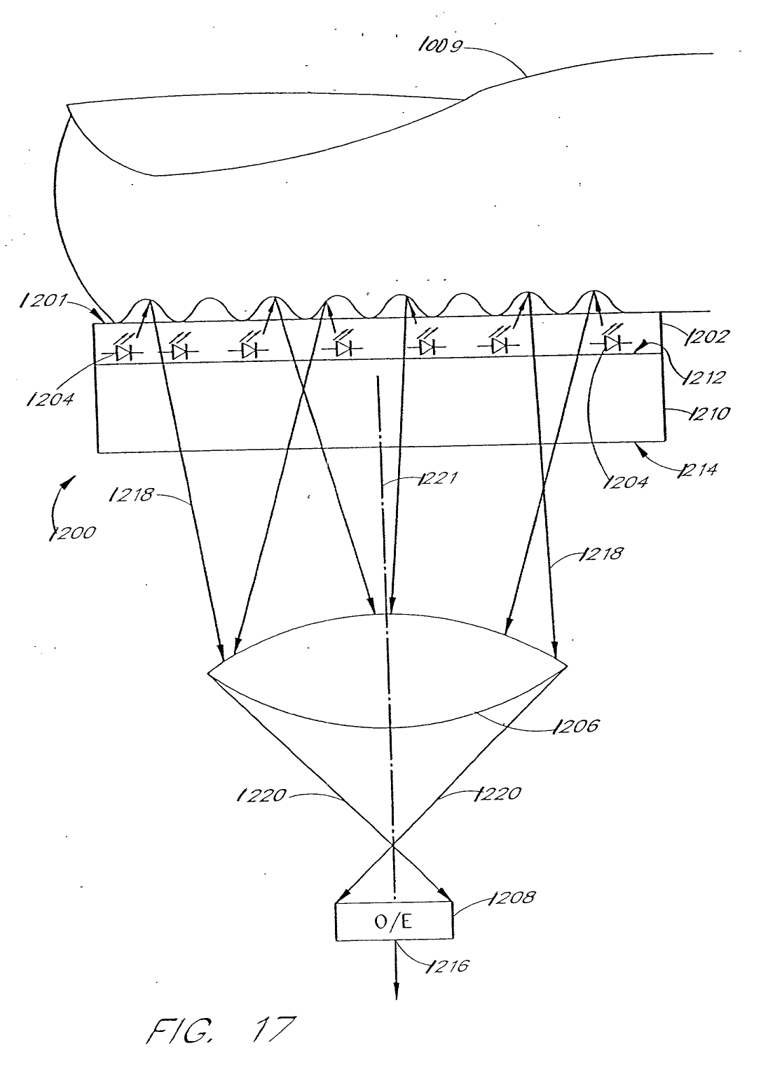

FIG. 16 shows a top view of the section of the pixel 1014 shown in FIG. 15A, including the switching diode 1023, to illustrate a layout of the pixel 1014. As illustrated, the photodetector 1024′ has a rectangular shape and is connected to the bus lines 1031 a (columns/data) and the bus lines 1031b (rows/address). The elongate light barrier 1033 has a rectangular cross-section and covers the switching diode 1023 and a part of the photodetector 1024′. The light barrier 1033 has a quadratic area 1039 which does not cover the photodetector 1024′ and, thus, allows light to be incident on the photodetector 1024′.

In the illustrated embodiment, the cross-section of the area 1039 corresponds to the cross-section of the light barrier 1033. However, in other embodiment, the cross-section of the area 1039 may be different from the cross-section of the light barrier 1033, for example, circular.

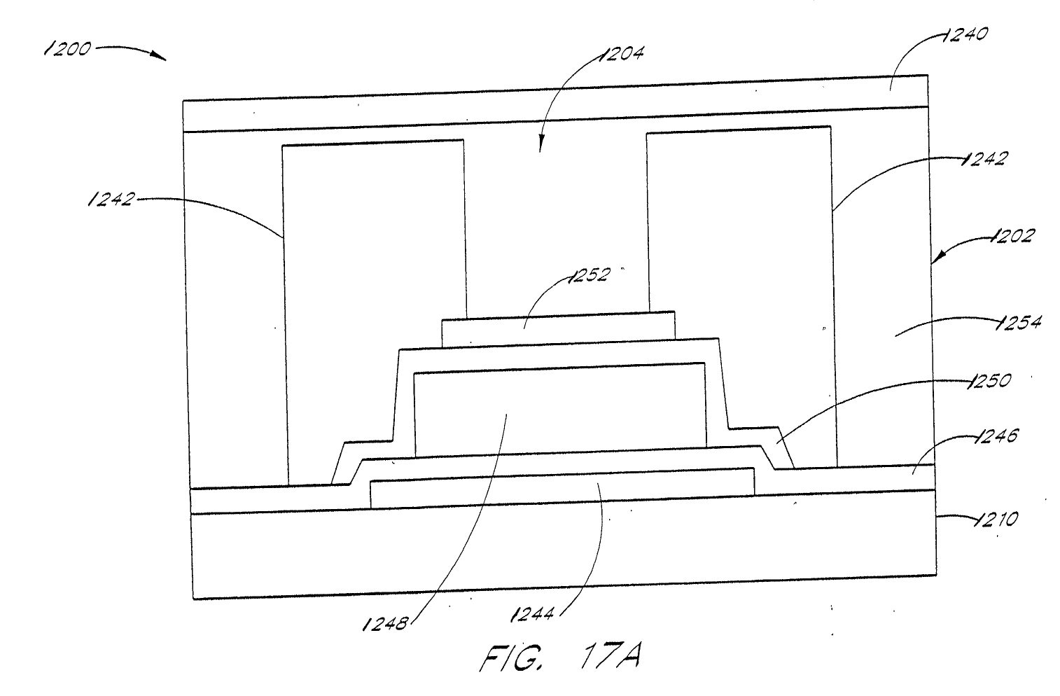

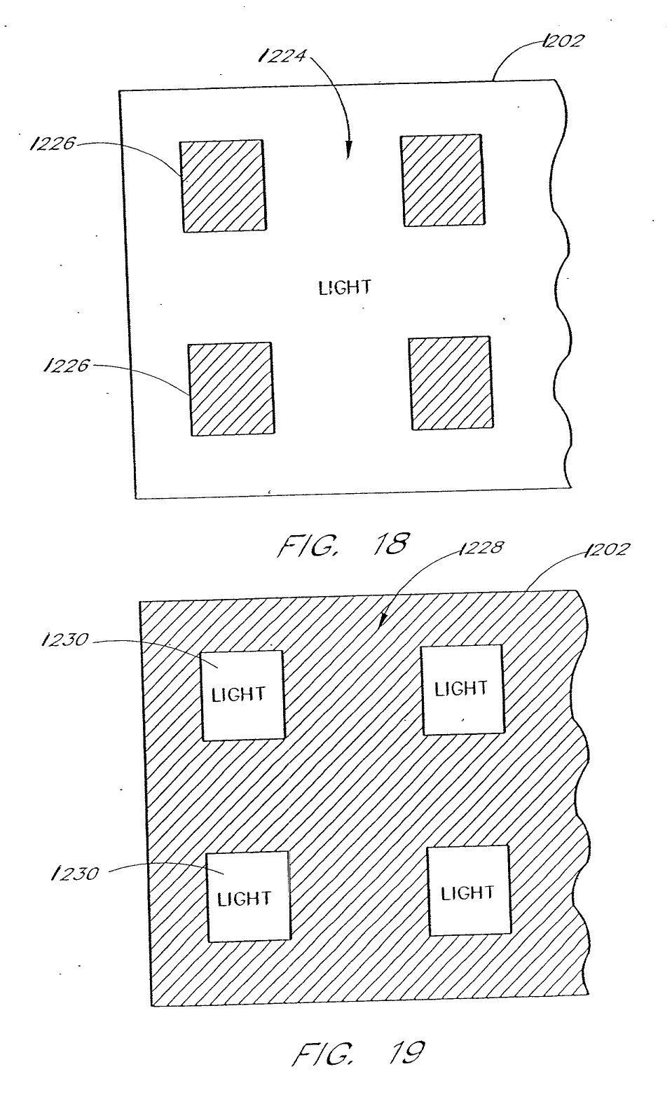

FIG. 17 shows an embodiment of an optical module 1200 with the finger 1009 placed onto a contact surface 1201. As in the previous embodiments, the optical module 1200 is configured so that the valleys of the finger 1009 reflect light, which originates from within the optical module 1200, back into the optical module 1200.

The optical module 1200 comprises a substrate 1210 and a light emitting layer 1202. In the illustrated embodiment, the light emitting layer 1202 includes a plurality of discrete light sources 1204. The substrate 1210 is transparent for light emitted by the light sources 1204. A surface 1212 of the substrate 1210 faces the finger 1009 and receives the light sources 1204. The layer 1202 covers the light sources 1204 as a protective coating and provides that the contact surface 1201 is planar. In one embodiment, the substrate 1210 has a thickness of about 0.5-1.5 mm, and the layer 1202 has a thickness of about 1 μm.

The optical module 1200 comprises further an optical lens 1206 and an opto-electronic (O/E) converter 1208. The optical lens 1206 is located between the substrate 1210 and the O/E converter 1208 along an axis 1221 that is perpendicular to a surface 1214 that faces the optical lens 1206. In FIG. 17, rays 1218 illustrate light which is reflected by the valleys and incident on the optical lens 1206, rays 1220 illustrate light which is passed through the lens 1206 and incident on the O/E converter 1208.

In one embodiment, the light sources 1204 are arranged in spread relationships as a pixelized array of individual light emitting diodes (LED). Each LED is connected to a power supply via a pair of electrodes. In operation, each LED emits a cone-shaped beam of light having a predetermined aperture. The cone-shaped beam of light illuminates an area of the finger 1009. The area directly underneath the LED, or the substrate of the LED itself, is opaque so that no light is emitted directly into the substrate 1210. The electrodes of the LED's are transparent for light emitted by the LED's. In one embodiment, the electrodes are formed by ITO. FIG. 17A shows an embodiment of a light source 1204 for a pixel for the optical module 1200.

In another embodiment, the light emitting layer 1202 includes a single sheet of thin film electroluminescent (EL) material that forms a patterned EL light source. FIGS. 18 and 19 show embodiments of EL light sources. The EL light source is connected to a power supply via a first electrode that faces the finger 1009 and a second electrode on top of the substrate 1210. The first electrode is transparent for light emitted by the EL light source to allow undisturbed illumination of the finger 1009. The area between the EL light source and the substrate 1210 has an opaque pattern that prevents light emitted by the EL light source from directly illuminating the lens 1206, while allowing light reflected from the finger 1009 reach the lens 1206. The opaqueness may be achieved by an opaque second electrode or an opaque coating.

In one embodiment, the optical lens 1206 has a distance from the light sources 1204 of about 40 mm, and a distance of about 8 mm from the O/E detector 1208. In operation, the light sources 1204 illuminate the finger 1009. The combination of covered ridges and light reflected by the valleys form an image of the fingerprint. The lens 1206 projects the image onto the O/E detector 1208 which converts the reduced image of the fingerprint into an electronic representation of the fingerprint.

The O/E detector 1208 has an output 1216 for a signal that corresponds to the electronic representation and that is available for a subsequent signal processing. The O/E detector 1208 may be a CMOS imager, an array of photodiodes, a device that includes an array of charge coupled devices (CCD), or any other device that converts the image of the fingerprint into an electronic representation.

FIG. 17A shows an embodiment of a light source 1204 of a pixel of the optical module 1200. The pixel includes, from top to bottom, a top layer 1240, the layer 1202 that includes a planarization layer 1254 and the light source 1204, and the substrate 1210. In the illustrated embodiment, the light source 1204 and the subsequent layers 1254, 1240 are implemented on top of the substrate 1210 which may be a glass substrate.

The light source 1204 includes, from the substrate 1210 upwards, the following layers: an electrode layer 1244 which may include a chromium or aluminum, a semiconductor layer 1246 which may include a-SiNₓO_{y} or a-SiNₓ, a light emitting phosphor layer 1248, a semiconductor layer 1250 which may include a-SiNₓO_{y} or a-SiNₓ, so that the phosphor layer 1248 is embedded between the semiconductor layers 1246 and 1250 within an light emitting area, and on top of the semiconductor layer 1250 an electrode layer 1252 which may include indium tin oxide (ITO).

The pixel includes a light barrier 1242 that surrounds the light source 1204. The light barrier 1242 prohibits that emitted light propagates in horizontal direction. In one embodiment, the light barrier 1242 has a hollow, elongate body of an opaque material. The opaque material may be an organic resin or any nonconducting material. In FIG. 17A, the light barrier 1242 is shown as extending left and right of the light source 1204 between the substrate 1210 and the top layer 1240. The light barrier 1242 is formed through a multiple-step process as described above.

FIG. 18 shows a section of a first embodiment of an EL light source within the layer 1202. The EL light source includes a light emitting area 1224 and isolated areas 1226 which do not emit light. In the illustrated embodiment, the areas 1226 are squares through which the reflected light from the finger can pass through. For instance, neighboring areas 1226 have a distance of about 50 μm, center to center. It is contemplated that in other embodiments, the areas 1226 may have, for example, oval or circular shapes.

FIG. 19 shows a section of a second embodiment of an EL light source 1202′ which forms the layer 1202. The EL light source 1202′ includes isolated light emitting areas 1230 and an area 1228 that does not emit light. In the illustrated embodiment, the light emitting areas 1230 are squares. The EL light source 1202′ may be implemented similar to the EL light source 1202, however, with a complementary structure. That is, the area 1228, which is similarly shaped as the area 1224 in FIG. 18, does not emit light, whereas the area 1224 emits light.

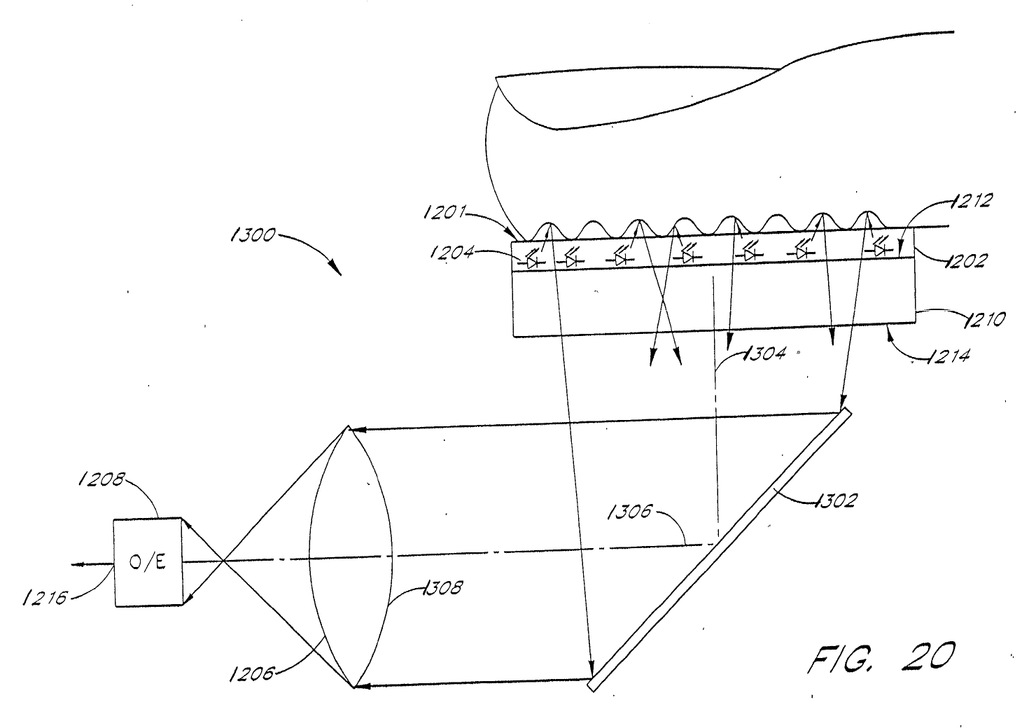

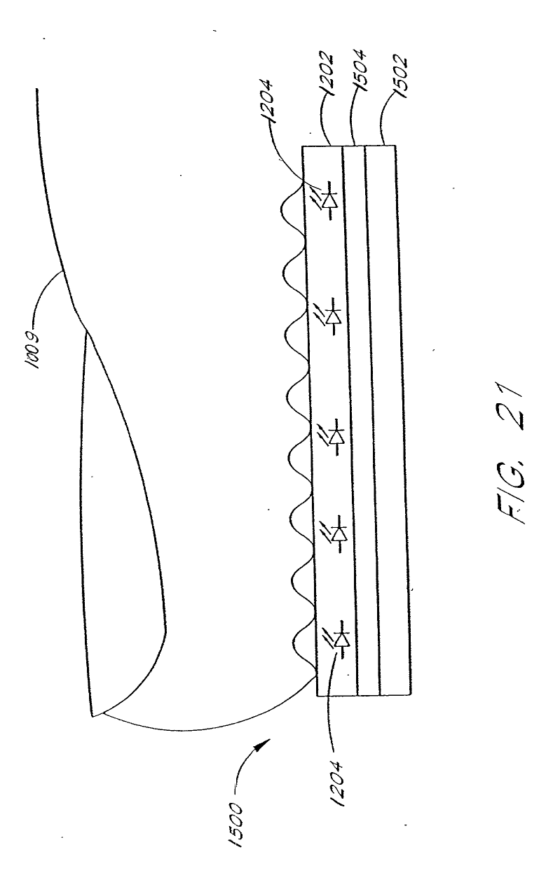

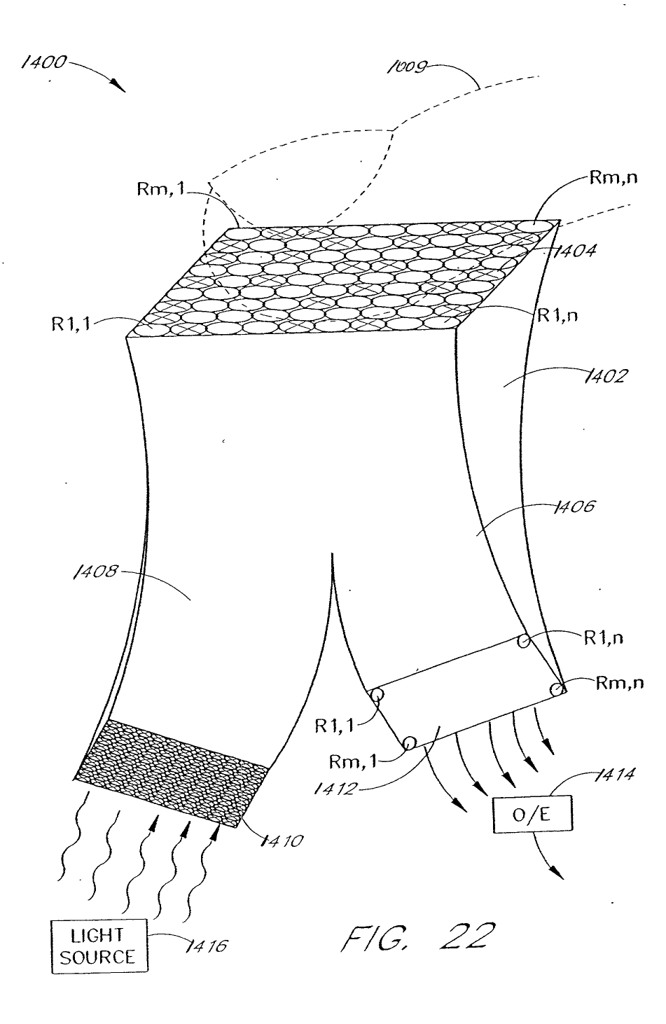

FIG. 20 shows an embodiment of an optical module 1300 which is a modified version of the optical module 1200 shown in FIG. 17. In FIGS. 17 and 20 same elements have, thus, the same reference numerals. An axis 1304 is perpendicular to the surface 1214 and an axis 1306 is perpendicular to a convex surface 1308 of the lens 1206. The axis 1304, 1306 are perpendicular to each other. The optical module 1300 includes a reflector 1302, which is positioned in a plane between the substrate 1210 and the lens 1206 where the axis 1304, 1306 intersect.

The reflector 1302 is in one embodiment a planar mirror that diverts the light reflected by the valleys of the finger 1009 by about 90 degrees so that the light is incident on the lens 1206. The reflector 1302 has a rectangular reflector surface which is sized to project the complete image of the fingerprint onto the lens 1206. In one embodiment, the area of the reflector surface is about half the size of the surface 1214. Because the reflector 1302 diverts the light, the optical module 1300 is thinner than the optical module 1200. In one embodiment, the optical module 1300 is approximately half as thick as the optical module 1200.

FIG. 21 shows a further embodiment of an optical module 1500 onto which the finger 1009 is placed. The optical module 1500 includes a detector layer 1502 and the layer 1202 that includes the light sources 1204 as explained above. Between the layer 1202 and the detector layer 1502, the optical module 1500 includes a planarization/isolation layer 1504 which has a thickness of a few microns, for example, about 4 μm. As in the previous embodiments, the valleys of the finger 1009 reflect light emitted from within the layer 1202 back into the optical module 1500 where the detector layer 1502 receives the reflected light. In one embodiment, the detector layer 1502 is an array of pin photodiodes, for example, as shown in FIG. 9 and explained above.

FIG. 22 shows an embodiment of an optical module 1400 that comprises a fiber optic bundle 1402. The fiber optic bundle 1402 has a surface 1404 onto which the finger 1009 is placed, an input branch 1408 with an input surface 1410, and an output branch 1406 with an output surface 1412. The input surface 1410 receives light which the input branch 1408 guides to the surface 1404 in order to illuminate the finger 1009. As in the previous embodiments, the valleys of the finger 1009 reflect light back into the fiber optic bundle 1402. Within the fiber optic bundle 1402 the output branch 1406 guides the reflected light to the output surface 1412 where the light is incident on a O/E detector 1414 which is connectable to a signal processing device.

The fiber optic bundle 1402 includes a plurality of individual optical fibers. In one embodiment, about half of the optical fibers form the input branch 1408 and the remainder of the optical fibers form the output branch 1406. The optical fibers of the input branch 1408 are referred to as “transmitter fibers” and the optical fibers of the output branch 1406 are referred to as “receiver fibers.” In proximity of the surface 1404, the optical fibers are densely packed and arranged in a rectangular array of pixels having m rows and n columns and forming a planar contact area. In one embodiment, the contact area has a size of about 2.5 cm×2.5 cm (1 inch×1 inch) to receive the finger 1009. A typical outer diameter (without protective plastic coating) of an optical fiber is about 100 μm with a light guiding core of about 10 μm. Furthermore each pixel may occupy an area of approximately 63 square microns.

In one embodiment, each pixel includes an end section of a transmitter fiber and an end section of a receiver fiber. For instance, the optical fibers may be arranged so that in each row and each column the transmitter fibers alternate with the receiver fibers. Further, the arrangement may be that a transmitter fiber directly neighbors only a receiver fiber, but not a transmitter fiber.

FIG. 19 shows four array locations R_{l,l}, R_{l,n}, R_{m,l}, R_{m,n}, each including a receiver fiber. The array locations R_{l,l}, R_{l,n}, R_{m,l}, R_{m,n} are shown at the surface 1404 and at the surface 1412 to indicate that the arrangement of the receiver fibers does not change between the surfaces 1404 and 1412. That is, the receiver fibers that are exposed at the surfaces 1404, 1412 have a fixed, coherent relationship, and thus comprise a coherent fiber bundle. The coherent relationship ensures that light exiting, for example, at the array location R_{l,l} of the output surface 1412 was input at the array location R_{l,l} of the surface 1404.

In operation, a light source 1416 emits light which may be monochromatic or “white” light. The light source 1416, thus, may be selected from a variety of different light sources, for example, halogen lamps, incandescent light bulbs, neon tubes, or even sunlight to name a few. The light illuminates the finger 1009 via the transmitter fibers and, with respect to the finger 1009, every transmitter fiber is a miniature light source (within a pixel) that illuminates a small area of the finger 1009. If a valley is above a miniature light source, the valley reflects light back to the surface 1404 where the reflected light may enter at least one receiving fiber. However, if a ridge covers a pixel, no light is reflected from the transmitter fiber to the receiving fiber and the receiving fiber remains “dark.” As explained above, the entirety of the illuminated and dark receiving fibers forms the image of the fingerprint which is detected by the O/E converter 1414.

The optical image system 1003 shown in FIG. 1 and the various embodiments of the optical module 1001, 1200, 1300, 1400 may be adapted to a variety of applications. For instance, when implemented to function as a touch screen, the optical image system 1003 may detect, which area, i.e., what symbol, the user touched. Further, the optical image system 1003 may trace the movement of the user's finger or pen when the user “writes” onto the surface. During the movement, subsequent pixels 1014 are covered, the finger or pen reflect light, and the pixels 1014 subsequently output photocurrents that allow tracing the movement. In addition, the optical image system 1003 may be configured to determine the shape of an object placed on top of the optical module 1001. A processor may match the determined shape with a number of stored shapes. In another embodiment, the processor may “measure” the area of the object, for example by counting the number of covered pixels 1014 when the area of an individual pixel 1014 is known.

It will be appreciated that one of skill in the art may combine the features of the sensor 1003 with the features of any of the optical modules 1001, 1200, 1300, 1400, or 1500 as herein described without detracting from the spirit of the present invention. It will further be appreciated that the features of the optical modules 1001, 1200, 1300, 1400, or 1500 may be combined by one of skill in the art with the features of other sensors 10, 200, 300, 330, 370, 420, 450, 468, or 500 to be described in greater detail below without detracting from the spirit of the present invention. Additional embodiments of the aforementioned optical image system 1003 will now be discussed. It should be appreciated by those of skill in the art that the features and methods presented herein can be combined and arranged so as to yield many possible combinations of functionalities. It is therefore conceived that the various features of the biometric sensor system can be desirably used to render an electronic fingerprint image in a number of different ways based on the teachings provided herein such that each combination and arrangement corresponds to an additional embodiment of the present invention as will be discussed in greater detail hereinbelow.

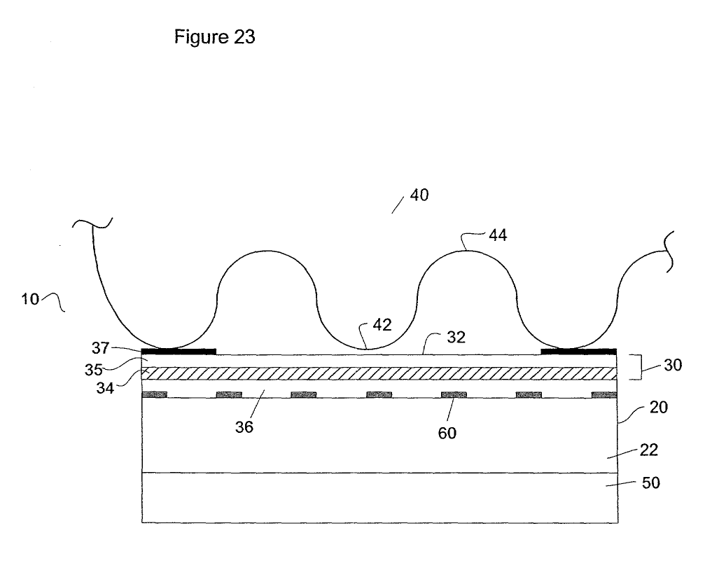

FIG. 23 schematically illustrates one embodiment of a fingerprint sensor 10 compatible with the present invention. The fingerprint sensor 10 comprises a substrate 20 comprising a first material 22 which is substantially transparent to light with wavelengths within a first range of wavelengths. The fingerprint sensor 10 further comprises a color filter layer 30 and a contact surface 32 which receives a fingertip 40 of a user. The color filter layer 30 comprises a second material 34 which is substantially transparent to light with wavelengths within the first range of wavelengths and substantially opaque to a portion of ambient light propagating through the fingertip with wavelengths within a second range of wavelengths. The fingerprint sensor 10 further comprises at least one light source 50 coupled to the substrate 20. The light source 50 generates light with at least one wavelength within the first range of wavelengths, and the light propagates through the substrate 20 to the fingertip 40. A finger placed on the fingerprint sensor is illuminated by both the light source 50 and by ambient light. The fingerprint sensor 10 further comprises a plurality of optical detectors 60 disposed from the contact surface 32 with at least a portion of the second material 34 disposed between the optical detectors 60 and the contact surface 32. The optical detectors 60 are positioned to receive light generated by the light source 50 and reflected by the fingertip 40. The optical detectors 60 generate electrical signals in response to the received light, thereby providing an electronic representation of a fingerprint corresponding to the fingertip 40.

The surface of a person's fingertip 40 has a unique pattern of ridges 42 and valleys 44 which can be used to uniquely identify the person. The structure of the fingertip 40, or a print caused when the fingertip 40 is placed on a surface is often referred to as a “fingerprint.” Hereinafter, this term is generally used to refer to the print caused by the fingertip 40. By placing the surface of a fingertip 40 of a user onto contact surface 32 of the fingerprint sensor 10, the fingerprint sensor 10 in one embodiment generates an electronic representation (“electronic image” or “digital image”) of the fingerprint, which can be used to determine if the present user is an authorized user. The fingerprint resulting from the sensing of the physical fingerprint of the present user is referred to as the “sensed” fingerprint to distinguish it from a “stored” fingerprint of an authorized user. As described in U.S. patent application Ser. No. 09/477,943, entitled “Planar Optical Image Sensor and System for Generating an Electronic Image of a Relief Object for Fingerprint Reading,” filed Jan. 5, 2000, and incorporated by reference herein, if a sensed fingerprint of a present user matches the stored fingerprint of an authorized user, the present user is identified as an authorized user.

The fingerprint sensor 10 is typically connected to a host system, which may be a personal computer (PC), a laptop computer, a cellular phone, a PDA, a security system, or other equipment installed, for example, in an access-restricted location where high-level security is needed. The host system processes the sensed fingerprint of the present user and matches it with the stored fingerprint of the authorized user. The host system allows full operation of the host system itself, or access to the restricted areas only if the electronic representation of the sensed fingerprint matches the stored fingerprint of the authorized user.

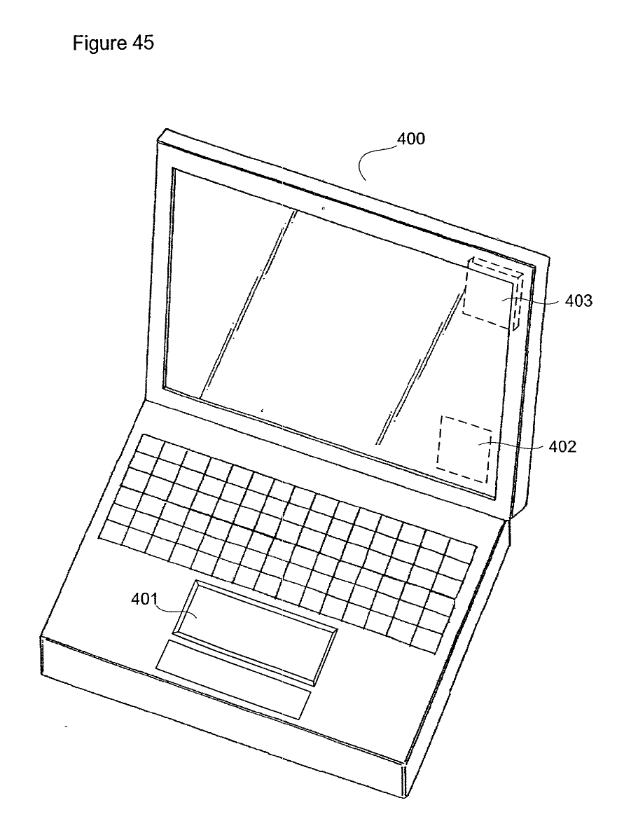

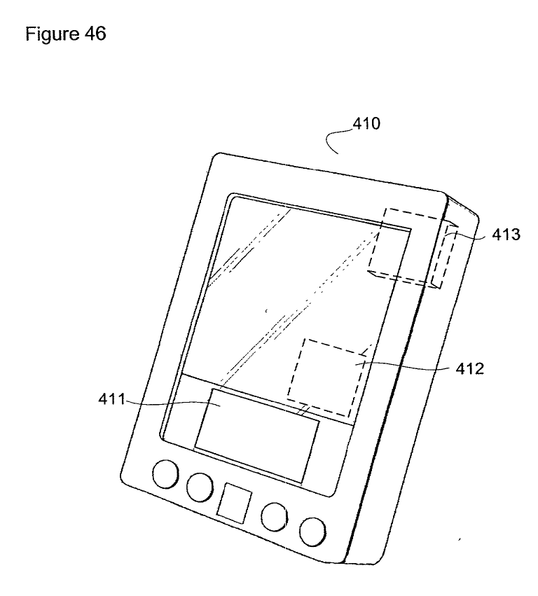

In one embodiment, the fingerprint sensor 10 is an external apparatus that is connectable to a computer (e.g., a desktop computer or a laptop). The computer includes a software program that operates the computer and the fingerprint sensor 10 and performs a matching procedure. In other embodiments, the fingerprint sensor 10 may be implemented, for example, within a computer, a PDA, or a cellular phone. In these embodiments, the fingerprint sensor 10 is located so that a user may place a finger on an exposed surface of the fingerprint sensor 10. For instance, the fingerprint sensor 10 may be integrated into a keyboard of a computer, a PDA, a computer or next to the keypad of a cellular phone, or into a display of a personal electronic device in the manner disclosed in reference to FIGS. 45 and 46 hereinbelow. Remaining components of the fingerprint sensor 10 (such as power supply, driver module, controller, etc.) are then located within the computer or the cellular phone.

In alternative embodiments the fingerprint sensor 10 may be implemented as a portable, autonomous identification and/or authentication apparatus that includes the components and software to perform the matching procedure and to output the result of the matching procedure. For example, the fingerprint sensor 10 may be implemented within a smart or chip card, or a communications module designed in accordance with a specification defined by the Personal Computer Memory Card International Association (PCMCIA). The communications module is, thus, often referred to as a PCMCIA card.

In certain embodiments, the fingerprint sensor 10 has a flat, generally rectangular shape, with a thickness of approximately 1-2 mm, a contact surface 32 which receives the fingertip 40 of the user, and an effective area of approximately 6 cm². In other embodiments, the fingerprint sensor 10 may have a circular-, oval-, square-like-, or any other shape of sufficient size to contact a sufficiently large portion of the fingertip 40 of the user. Persons skilled in the art can select an appropriate configuration and shape for the fingerprint sensor 10 compatible with the present invention.

In the following description and figures, the fingerprint sensor 10 has a generally horizontal orientation. Terms such as “top,” “bottom,” “above,” “below,” “underneath,” or the like, are used with reference to the generally horizontal orientation of the fingerprint sensor 10 to describe the relative orientation of the various components of the fingerprint sensor 10. Persons skilled in the art appreciate that the fingerprint sensor 10 may have other orientations and that the relational terms then apply correspondingly.

The first material 22 of the substrate 20 of the fingerprint sensor 10 is substantially transparent to light with wavelengths within a first range of wavelengths. As used herein, the term “light” corresponds to electromagnetic radiation which may or may not be within the visible spectrum. In addition, as used herein, a material is substantially transparent to light with a given wavelength if the transmittance of the material to the light is greater than or equal to 40%. In certain embodiments, the first range of wavelengths substantially transmitted by the first material 22 preferably range from approximately 400 nm to approximately 600 nm, more preferable from approximately 400 nm to approximately 550 nm, and most preferably from approximately 400 nm to approximately 500 nm. In certain embodiments, the first range of wavelengths corresponds to green light, while in other embodiments the first range corresponds to non-red light. In still other embodiments, the first range of wavelengths corresponds to wavelengths which are not substantially transmitted by the fingertip. The first range of wavelengths includes at least a portion of the emission spectra of the light source 50, described below. In certain embodiments, the first material 22 can also substantially transmit light with wavelengths outside the first range of wavelengths. In addition, the index of refraction of the first material 22 in certain embodiments approximates the index of refraction of the fingertip 40. Examples of first materials 22 compatible with the present invention include, but are not limited to, glass, plastic, or any transparent substrate, such as quartz.

As illustrated in FIG. 23, certain embodiments of the fingerprint sensor 10 comprise a color filter layer 30 comprising a second material 34. In certain embodiments, the color filter layer 30 comprises multiple layers of materials with different optical or mechanical properties. In the embodiment illustrated in FIG. 23, the color filter layer 30 comprises a second material 34 and a hardcoat layer 35 which provides protection to the underlying portions of the color filter layer 30. In this embodiment, the contact surface 32 is the top surface of the hardcoat layer 35. When receiving the fingertip 40 of a user, the contact surface 32 is in contact with the ridges of the fingertip 40. In addition, the index of refraction of the hardcoat layer 35 in certain embodiments approximates the index of refraction of the fingertip 40. An exemplary hardcoat layer 35 comprises a 3 μm-thick film of EXP98024, which is available from Brewer Science, Inc. of Rolla, Mo., and can be applied using standard screen printing processes. Such a hardcoat layer 35 provides resistance to scratching and to chemicals, including various solvents. Persons skilled in the art can select an appropriate material and method of fabrication for the hardcoat layer 35 compatible with the present invention.

In the embodiment schematically illustrated in FIG. 23, the color filter layer 30 overlies a top coat layer 36 which covers the optical detectors 60. This top coat layer 36 provides protection for the optical detectors 60, as well as planarization for subsequent layers. Potential materials for the top coat layer 36 include, but are not limited to, epoxy and acrylic. One exemplary embodiment of the top coat layer 36 comprises a “Philips top-coat” obtainable from Philips Electronics North America, New York, N.Y. and which comprises a 1.5 μm epoxy, followed by a 4 μm acrylic.

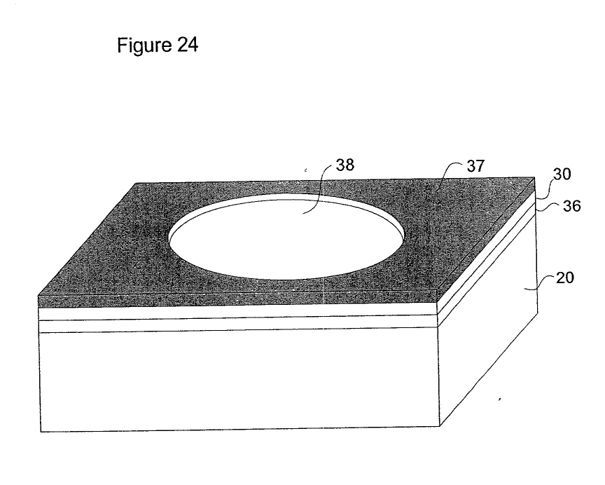

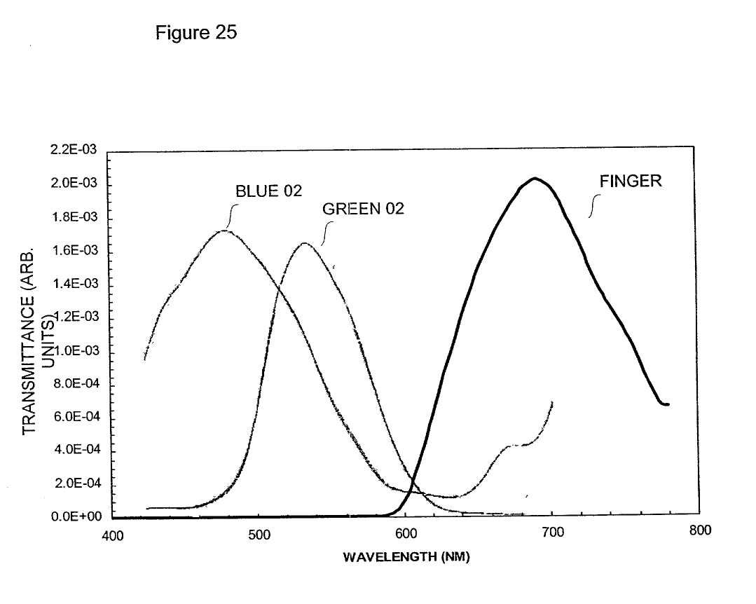

In certain embodiments, the fingerprint sensor 10 also comprises an opaque material 37 which covers a portion of the contact surface 32. The portion of the contact surface 32 not covered by the opaque material thereby defines an active area 38. FIG. 24 schematically illustrates such an embodiment with an opaque material 37 defining an oval-shaped active area 38. During operation of the fingerprint sensor 10, the fingertip 40 is placed onto the active area 38 so that the active area 38 is completely covered by the fingertip 40. As described more fully below, in this way, only a portion of the ambient light is able to propagate to the optical detectors 60 below through the fingertip 40. As seen in FIG. 25, which schematically illustrates the transmittance spectrum of a human finger, the portion of ambient light substantially transmitted through the fingertip 40 has wavelengths larger than approximately 600 nm, with a peak at approximately 700 nm.

In certain embodiments, the second material 34 is substantially transparent to light with a range of wavelengths which approximates the first range of wavelengths substantially transmitted by the first material 22. Alternatively, in other embodiments, the second material 34 is substantially transparent to light with a range of wavelengths which is a subset of the first range of wavelengths. For example, in certain embodiments, the second material 34 is substantially transparent to light within only a subrange of the first range of wavelengths, while in still other embodiments, the second material 34 is substantially transparent to light within a range of wavelengths which only overlaps a portion of the first range of wavelengths. In certain embodiments, the color filter 30 is substantially transparent to green light, while in other embodiments, the color filter 30 is substantially transparent to non-red light. In still other embodiments, the color filter 30 is substantially transparent to light which is not substantially transmitted by the fingertip 40.

The second material 34 is also substantially opaque to light within a second range of wavelengths. As used herein, a material is substantially opaque to light with a given wavelength if the transmittance of the material to the light is less than 20%. In certain embodiments, the second range of wavelengths not substantially transmitted by the second material 34 preferably range from approximately 600 nm to approximately 800 nm, more preferable from approximately 600 nm to approximately 750 nm, and most preferably from approximately 600 nm to approximately 700 nm. In certain embodiments, the second range of wavelengths is characterized as red light, while in other embodiments, the second range of wavelengths is characterized as non-green light. In still other embodiments, the second range of wavelengths is characterized as the portion of ambient light that is substantially transmitted by the fingertip 40. As illustrated in FIG. 25, the portion of ambient light that is substantially transmitted through the fingertip 40 is primarily red light. In certain embodiments, the second material 34 is also substantially opaque to light which is outside both the second range of wavelengths and the first range of wavelengths. In addition, the index of refraction of the second material 34 in certain embodiments approximates the index of refraction of the fingertip 40.

Numerous second materials 34 and techniques for fabricating the color filter layer 30 which are compatible with the present invention are described in “Liquid Crystal Flat Panel Displays,” by William C. O'Mara, pp. 118-126, published by Van Nostrand Reinhold, New York 1993 which is incorporated by reference herein. Examples of second materials 34 include, but are not limited to glass or polyimide with dissolved colorants (e.g., dyes, pigments). In certain embodiments, the color filter comprises an organic material, while in other embodiments, the color filter comprises an inorganic material. One exemplary second material 34 is “Green 02,” which is available from Brewer Science, Inc. of Rolla, Mo., and can be applied using standard screen printing processes. FIG. 25 schematically illustrates a transmittance spectrum for “Green 02,” which is substantially transparent to light with wavelengths between approximately 490 nm and 560 nm, and is substantially opaque to light with wavelengths above approximately 580 nm. In addition, “Green 02” is substantially opaque to light with wavelengths below approximately 480 nm. Similarly, in other embodiments, the second material 34 comprises “Blue 02,” also available from Brewer Science, Inc. of Rolla, Mo. A transmittance spectrum for “Blue 02” is schematically illustrated in FIG. 25. “Blue 02” is substantially transparent to light with wavelengths between approximately 390 nm and 520 nm, and is substantially opaque to light with wavelengths above approximately 530 nm.

Examples of techniques for fabricating the color filter layer 30 include, but are not limited to, dyeing, offset printing, pigment dispersion, spin-coating, electro-deposition, or electromist and may include photolithography techniques. Using an exemplary fabrication technique, the second material 34 of the embodiment schematically illustrated in FIG. 23 can be formed by applying an adhesion promoter to a substrate 20 with optical detectors 60 on its top surface, spin-coating the second material 34 onto the substrate 20, and curing the second material 34 by heating to an elevated temperature. The thickness of the second material 34 in the embodiment illustrated in FIG. 23 is preferably between approximately 1.0 to approximately 3.0 μm, more preferably between approximately 1.5 to approximately 3.0 μm, and most preferably between approximately 2.5 to 3.0 μm. Other embodiments may include other processing steps, such as photolithography techniques, to pattern the second material 34. Persons skilled in the art can select appropriate second materials 34 and techniques for fabricating the color filter layer 30 compatible with the present invention.

At least one light source 50 is coupled to the substrate 20. As used herein, the term “light source” encompasses single or multiple light sources or light source panels which may have a variety of configurations. In the embodiment illustrated in FIG. 23, the light source 50 is positioned below the substrate 20 and extends across the substrate 20 and illuminates the substrate 20 evenly. As described more fully below, other embodiments may utilize other configurations of light sources 50, such as multiple individual light sources 50 below the substrate 20, or utilize a light source 50 comprising a waveguide, such as an acrylic light pipe, which is coupled to the substrate 20 and to a light generator which is displaced from the substrate 20. Other embodiments include multiple individual light sources 50 located to evenly cover and illuminate the substrate 20, an array emitter including pixelized light sources, or a light source panel such as an electroluminescent panel.

In the embodiment illustrated in FIG. 23, when the light source 50 is activated, light propagates in an upward direction through the substrate 20, past the optical detectors 60, to be reflected by the contact surface 32 and fingertip 40. In this embodiment, the light source 50 functions as a backlight for the contact surface 32 of the fingerprint sensor 10. Persons skilled in the art can select an alternative configuration for the light source 50 which is compatible with the present invention.

The light source 50 generates light with at least one wavelength within the first range of wavelengths so that the generated light can propagate with minimal attenuation through the substrate 20 to the fingertip 40 positioned on the contact surface 32. In certain embodiments, the wavelengths of the generated light can be characterized as being visible light in the green or blue portion of the spectrum. In other embodiments, the light generated by the light source 50 is characterized as non-red light. Examples of light sources 50 compatible with the present invention include, but are not limited to, electroluminescent light sources, one or more inorganic or organic light-emitting diodes (LEDs), laser diodes, a backlight device, for example, as used for a liquid crystal display (LCD), or any other light source 50 suitable to illuminate the contact surface 32 of the fingerprint sensor 10.

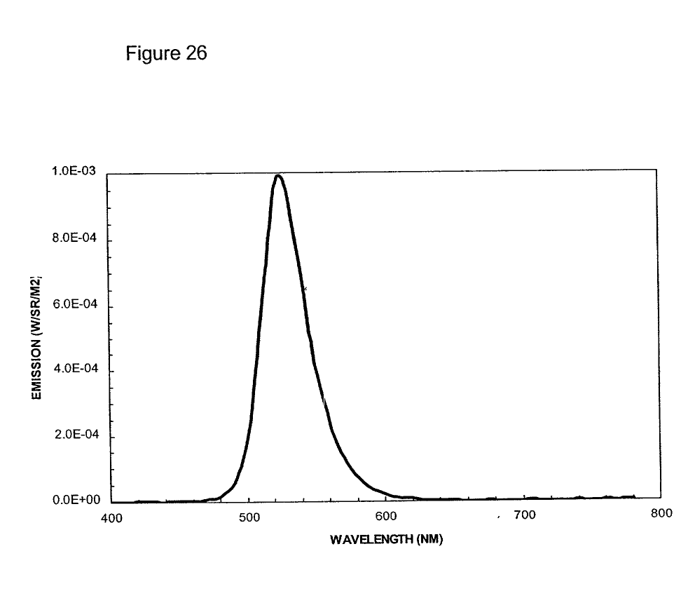

As explained below, one exemplary light source 50 comprises a backlight panel with a microlens array and a green LED positioned to one side of the backlight panel. The light from the green LED is reflected towards the contact surface 32 and onto the fingertip 40 by the microlens array positioned along the backlight panel. FIG. 26 schematically illustrates an emission spectrum for such an exemplary backlight panel, the emission being peaked at approximately 524 nm with a full-width-at-half-maximum of approximately 40 nm. Similar backlight panels are available from Lumitex, Inc. of Strongsville, Ohio.

Other embodiments can utilize light sources 50 with different emission spectra, e.g., blue LEDs, when used in conjunction with an appropriate color filter layer 30. However, light sources 50 which emit green light are more preferable since their emission spectra are a closer match to the sensitivity spectra of the optical detectors 60 described below. In addition, standard second materials 34 for the color filter layer 30 which substantially transmit blue light also transmit a significant fraction of red light, thereby reducing their effectiveness as filters of the ambient light transmitted through the fingertip 40. Also, LEDs which emit blue light are more expensive than LEDs which transmit green light, making green LEDs more preferable as the light source 50, e.g. Nichia Superbright LED, part number NSCG215, manufactured by Nichia America Corporation, Mountville, Pa. As described in U.S. Utility Patent and U.S. Provisional Patent Applications No. 60/188,273, entitled “System and Method for Lighting a Biometric Sensor” filed Mar. 10, 2000; 60/188,280 entitled “Biometric Sensor using Organic Light Emiting Diode Technology” filed Mar. 10, 2000, 60/201,905 entitled “System and Method for Lighting a Biometric Sensor” filed May 4, 2000; 60/214,155 entitled “System and Method for Lighting a Biometric Sensor” filed Jun. 26, 2000; 60/234,635 entitled “System and Method for Lighting a Biometric Sensor” filed Sep. 22, 2000; and Ser. No. 09/477,943, which are incorporated by reference herein, the fingerprint sensor 10 also includes various other components to operate the light sources 50 including any electrodes and power supplies.

For certain embodiments, the light source 50 comprises an electroluminescent light source based on inorganic or organic materials. An organic electroluminescent material includes, for example, thin sublimed molecular films such as tris(8-quinolinolato) aluminum (III) commonly known as Alq or light emitting polymers having specialized structures which provide positive and negative charge carriers having high mobilities. The light-emitting polymers include polyphenylene vinylene (PPV), soluble polythiophene derivatives, and polyanilene which may be applied by known coating techniques such as spin or doctor-blade coating. Further details about organic electroluminescent materials are described in J. C. Sturm et al., “Integrated Organic Light Emitting Diode Structures Using Doped Polymers,” Proceedings of SID, 1997, pages F11-F18.

An inorganic electroluminescent material includes a phosphor material in combination with material such as zinc sulfide:manganese (ZnS:Mn), zinc silicate (Zn₂SiO₄), or zinc gallate (ZnGaO₄). In one embodiment, the phosphor, ZnS:Mn material may be dispersed in an insulating dielectric material such as barium titanate (BaTiO₃). Other dielectric materials include yttrium oxide, silicon nitride, and silicon oxy-nitride. In another embodiment, the light source 50 includes an electroluminescent (EL) panel. Such an EL panel is, for example, manufactured by Durel Corporation of Chandler, Ariz., and designated as part number DB5-615B.

A plurality of optical detectors 60 are disposed from the contact surface 32, with at least a portion of the second material 34 disposed between the optical detectors 60 and the contact surface 32. In the embodiment schematically illustrated in FIG. 23, the optical detectors 60 are positioned on top of the substrate 20 and are below the color filter layer 30 which has the second material 34 generally uniformly distributed throughout. In this way, the optical detectors 60 are positioned to receive light which is generated by the light sources 50 and reflected by the fingertip 40 at the contact surface 32. In such an embodiment, the optical detectors 60 are not responsive to directly impinging light from below the optical detectors 60. The optical detectors 60 generate electrical signals in response to the received light, thereby providing an electronic representation of a fingerprint corresponding to the fingertip.

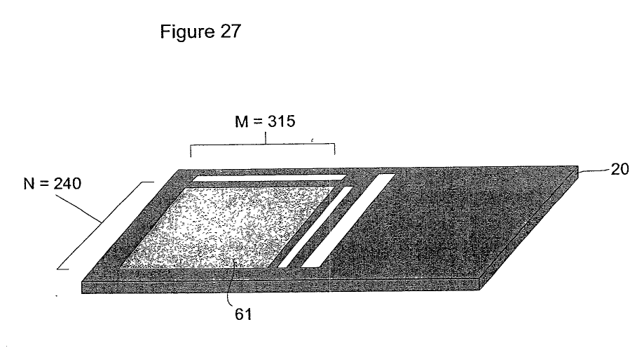

In certain embodiments, the optical detectors 60 include a plurality of individual, spaced-apart picture elements or pixels 61. As schematically illustrated in FIG. 27, the optical detectors 60 comprise an optical planar array 58 of pixels 61 arranged in M rows and N columns in generally orthogonal columns and rows. In one embodiment, the array 58 has M=315 rows and N=240 columns of pixels 61 with each pixel 61 occupying an area of approximately 63 square microns. Each pixel 61 includes a photodetector and a charge-storing mechanism, for example, an inherent (parasitic) capacitance or a capacitor electrically coupled to the photodetector. Each pixel 61, hence each photodetector, can be selected through an address line L_{M} (row) and a data line L_{N} (column) which are connected to a driver module. In such embodiments, the optical detector 60 comprises an active matrix sensor array.

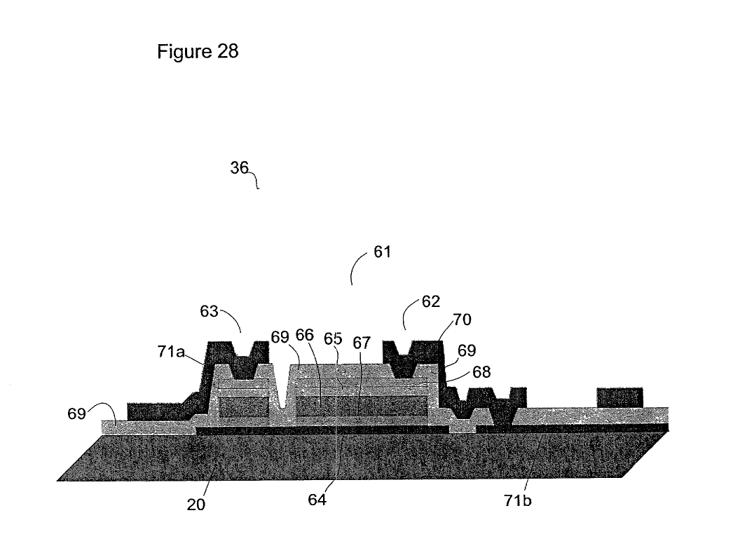

In the exemplary embodiment schematically illustrated in FIG. 28, each pixel 61 comprises a photodiode 62 and a switching diode 63, both deposited directly on the substrate 20 using photolithographic techniques. In one embodiment, a rigid material such as glass forms the substrate 20, with the glass having a thickness of approximately 1 mm. The photodiode 62 and switching diode 63 each comprise a p-i-n diode implemented above a chromium (Cr) electrode 64. The p-i-n photodiode 62 comprises a photoactive p-layer 65, an intrinsic (i)-layer 66, and an n-layer 67. The n-layer 67 is formed by a layer of amorphous silicon doped to be of n-type silicon (n⁺a-Si:H), and the p-layer 65 is formed by a layer of amorphous silicon doped to be of p-type silicon (p⁻a-Si:H). Between the p- and n-layers 65, 67, a layer of undoped amorphous silicon forms the i-layer 66 (i a-Si:H). The p-layer 65 of the photodiode 62 is covered by a transparent conducting layer 68. In this embodiment, the transparent conducting layer 68 comprises indium-tin oxide (ITO). The transparent conducting layer 68 is covered by a passivation layer 69, and is in contact with an electrode 70 which extends through the passivation layer 69.

In the illustrated embodiment, the switching diode 63 is also a p-i-n diode and has generally the same structure as the p-i-n photodiode 62. The p-layer 65 of the switching diode 63 is covered by the bus line 71a. The electrodes 64, 70 and bus lines 71a, 71b are, for example, thin layers of chromium or a combination of chromium and aluminum. It is contemplated that other conducting materials, such as Mo or W, may be used to form the electrodes 64, 70 and the bus lines 71a, 71b. In one embodiment, the bus lines 71a are part of the data lines L_{N}, L_{N-l}, and the bus lines 71b are part of the address lines L_{M}, L_{M-l}. The bus lines 71a and the bus lines 71b are separated through the passivation layer 69, which comprises an insulating material such as amorphous silicon nitride (a-SiNₓ:H). Various configurations of optical detectors 60 and methods of manufacture which are compatible with the present invention are described in U.S. patent application Ser. No. 09/477,943 which is incorporated by reference herein.

In one embodiment, the plurality of optical detectors 60 are positioned approximately 3-4 microns below the contact surface 32. In this embodiment, the optical detectors 60 are arranged in the array 58 comprising 240 by 317 pixels 61. In this embodiment, the plurality of optical detectors 60 occupies an area of approximately 19.2 mm by 14.2 mm wherein each pixel 61 occupies approximately 63 um². In one embodiment, a photodiode 62 and switching diode 63 have an area of approximately 40 um² and are spaced apart from other photodiodes 62 and switching diodes 63 by approximately 12 um.

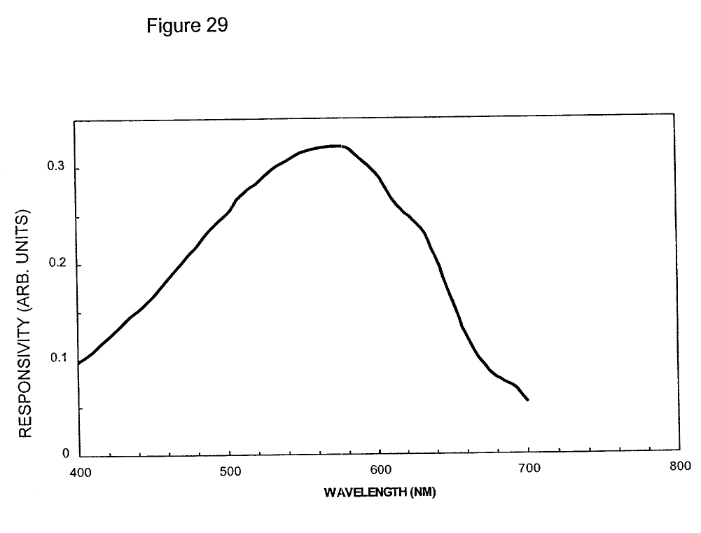

FIG. 29 schematically illustrates the optical responsivity of a p-i-n photodiode 62, such as the photodiode 62 illustrated in FIG. 28, as a function of the wavelength of the incident light. As can be seen from FIG. 29, the photodiode 62 is substantially responsive to wavelengths between approximately 450 nm and 650 nm. For the photodiode 62 to be responsive to light which is substantially transmitted through the substrate 20 and the color filter layer 30, the first range of wavelengths overlaps at least a portion of the range of optical responsivity of the photodiode 62.

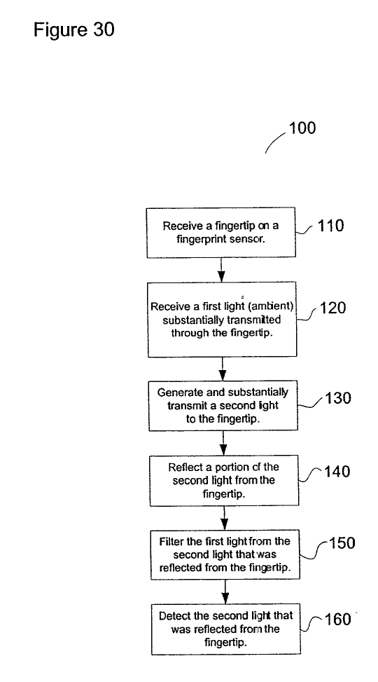

FIG. 30 is a flowchart of one embodiment of a method 100 of sensing a fingerprint comprising a pattern of ridges 42 and valleys 44 of a fingertip 40 of a user. In a procedural block 110, the fingertip 40 is received on a fingerprint sensor 10. The ridges 42 of the fingertip 40 make contact with a contact surface 32 of the fingerprint sensor 10. In embodiments of the fingerprint sensor 10 which comprise an opaque layer 37 which defines an active area 38, the fingertip 40 is placed so that the active area 38 is completely covered by the fingertip 40.

In a procedural block 120, a first light 80 is received and substantially transmitted through the fingertip 40 to the contact surface 32. The first light 80 is generated by ambient light sources, which can include, but are not limited to, fluorescent room lights or sunlight. In embodiments in which the fingertip 40 completely covers an active area 38, only the portion of the first light which propagates through the tissue of the fingertip 40 reaches the contact surface 32. As is evident from FIG. 25, the fingertip 40 substantially filters out wavelengths shorter than approximately 600 nm, thereby leaving only the red portion of the ambient light spectrum as the first light 80.

In a procedural block 130, a second light 82 is generated and substantially transmitted to the fingertip 40 from the contact surface 32. In embodiments using the fingerprint sensor 10 schematically illustrated in FIG. 23, the second light 82 is generated below the substrate 20 by the light source 50 and is substantially transmitted through the substrate 20, past the optical detectors 60, through the top coat layer 36 and color filter layer 30, and reaching the contact surface 32. In order for the second light 82 to be substantially transmitted in this manner, the optical transmittance spectra of the substrate 20, top coat layer 36, and color filter layer 30 substantially transmit at least one wavelength of the light generated by the light source 50.

In a procedural block 140, a portion of the second light 82 is reflected from the fingertip 40. The ridges 42 of the fingertip 40 exhibit a first reflectivity and the valleys 44 of the fingertip 40 exhibit a second reflectivity. Because the ridges 42 are generally in contact with the contact surface 32, the fractions of the second light 82 which undergo total internal reflection from the contact surface 32 are different at the ridges 42 from the valleys 44, thereby contributing to the difference in reflectivity between the ridges 42 and the valleys 44. In certain embodiments, the indices of refraction for the various layers of the fingerprint sensor 10 are selected to approximate the index of refraction of the fingertip 40 to utilize the total internal reflection phenomenon to provide contrast between the ridges 42 and valleys 44. In addition, the ridges 42 provide relatively flat surfaces from which the second light 82 can be reflected back down from the contact surface 32, while the valleys 44 provide relatively curved surfaces from which the second light 82 is reflected in various directions, thereby further contributing to the difference in reflectivity between the ridges 42 and the valleys 44.

In a procedural block 150, the first light 80, substantially transmitted through the contact surface 32, is filtered from the second light 82 reflected from the fingertip 40. In embodiments using the fingerprint sensor 10 schematically illustrated in FIG. 23, the filtering is performed by the color filter layer 30 which is substantially opaque to the first light 80 which was substantially transmitted through the fingertip 40 and substantially transparent to the second light 82 produced by the light source 50. The first light 80 is inhibited from propagating to the plurality of optical detectors 60 while a portion of the second light 82 is permitted to propagate to the plurality of optical detectors 60. In this way, any influence of the ambient light on the sensed fingerprint is effectively removed by the fingertip 40 (which is substantially opaque to light with wavelengths below 600 nm) combined with the color filter layer 30 (which is substantially opaque to light with wavelengths above 580 nm). The combined filtering of the fingertip 40 and the color filter layer 30 allow the fingerprint sensor 10 to operate even in environments with high levels of ambient light, and avoids potentially cumbersome enclosures for the fingerprint sensor 10 to shield it from the influences of ambient light.

In a procedural block 160, the second light 82 reflected from the fingertip 40 is detected, thereby imaging the fingerprint of the fingertip 40. In embodiments using the fingerprint sensor 10 schematically illustrated in FIG. 23, the second light 82 is detected by the plurality of optical detectors 60 after propagating through the color filter layer 30 and the top coat layer 36. The plurality of optical detectors 60 then generates an electronic representation of the fingerprint, which can be used for identification of the user.

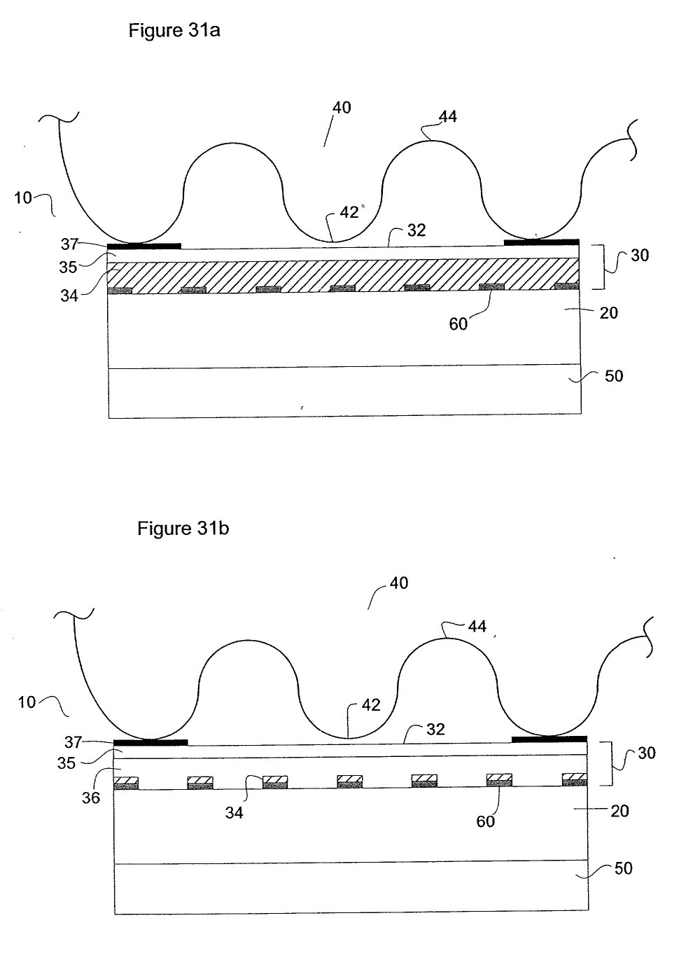

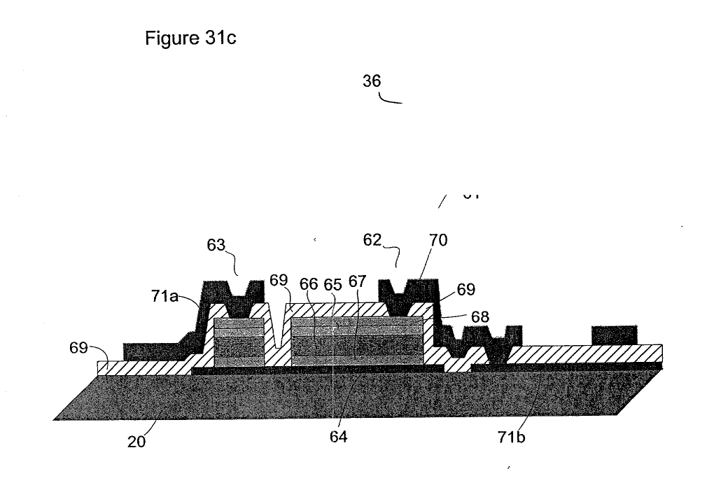

In an alternative embodiment, schematically illustrated in FIG. 31A, the color filter layer 30 with the second material 34 is applied directly onto the substrate 20 and the plurality of optical detectors 60. This embodiment either includes a top coat layer 36 which comprises the second material 34, or does not include a top coat layer 36 at all. Similarly, in the embodiment schematically illustrated in FIG. 31B, the second material 34 is applied directly onto the plurality of optical detectors 60, but the areas between the optical detectors 60 are free of the second material 34. The color filter 30 is patterned such that the color filter 30 does not substantially cover the region between the optical detectors 60. This embodiment avoids attenuation of the light from the light source 50 which may occur in the embodiments of FIGS. 23 and 31A as the light propagates through the color filter layer 30 toward the contact surface 32. In the embodiments of FIGS. 31A and 31C the color filter 30 substantially covers the plurality of optical detectors 60.

In still another alternative embodiment, schematically illustrated in FIG. 31C, the color filter layer 30 can be incorporated within the passivation layer 69 just above the photodiode 62 of the optical detectors 60. In such an embodiment, the passivation layer 69 is insulating, substantially transparent to light with wavelengths within the first range of wavelengths, and substantially opaque to light with wavelengths within the second range of wavelengths. An exemplary example of a passivation layer 69 compatible with this embodiment is a multilayer structure of a-SiNₓ/a-SiOₓ/a-SiNₓO_{y.} Persons, skilled in the art can select other materials and configurations which are compatible with this embodiment. In such embodiments, the optical detectors 60 are substantially responsive to light that is generated by the light source 50 and not substantially response to the portion of ambient light substantially transmitted through the fingertip 40.

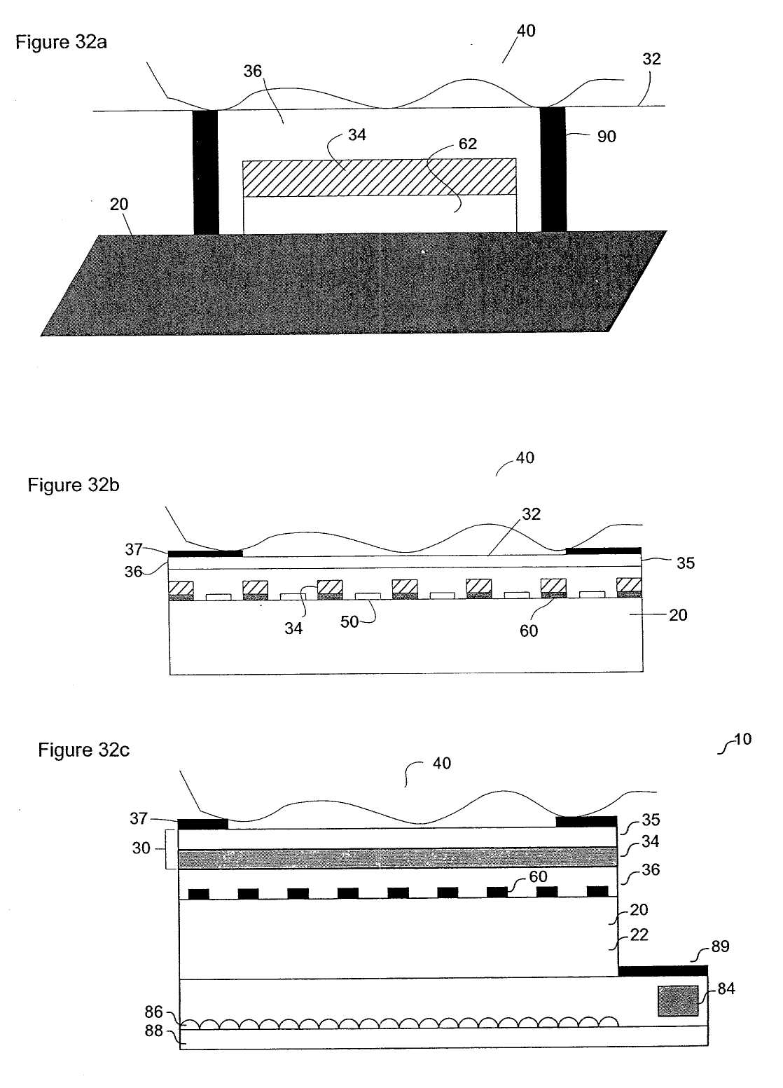

In alternative embodiments, the fingerprint sensor 10 does not have the opaque layer 37 of the embodiments of FIGS. 23, 31A, and 31B. Instead, the optical detectors 60 comprise an opaque matrix 90 which substantially bounds each optical detector 60 thereby separating the optical detectors 60 from one another, as schematically illustrated in FIG. 32A. Similarly, the opaque matrix 90 can substantially bound portions of the color filter 30, thereby separating the portions of the color filter 30 from one another. In still other embodiments, as shown in FIG. 32A, the opaque matrix 90 substantially bounds each optical detector 60 with an associated portion of the color filter 30. The walls of the opaque matrix 90 extend across a substantial portion of the thickness of the top coat layer 36. In this way, when the fingertip 40 is placed on the contact surface 32, ambient light not substantially transmitted through the fingertip 40 is blocked from reaching any pixels 61 directly below the fingertip 40. An exemplary material for the opaque matrix 90 is DARC 400, a resin material available from Brewer Science, Inc. of Rolla, Mo. The opaque matrix 90 can be fabricated by spin-coating and patterning using photolithographic techniques.

In yet another embodiment of the present invention, the light sources 50 and the optical detectors 60 can be fabricated in generally the same layer of the fingerprint sensor 10, such that the optical detectors 60 are substantially co-planar with the light sources 50. As schematically illustrated in FIG. 32B, the light generated by the light sources 50 is reflected from the fingertip 40 and detected by the optical detectors 60 which are incorporated with the color filter layer 30. The substrate 20 of this embodiment provides structural support for the other elements of the fingerprint sensor 10, and since the light does not propagate through the substrate 20, there are no constraints on the optical characteristics of the substrate 20.

In still other embodiments of the present invention, a color filter layer 30 may be omitted where the sensitivity spectrum of the optical detectors 60 are less sensitive to light which is substantially transmitted through the fingertip 40, i.e., in the red portion of the visible spectrum. By utilizing a light source 50 which emits light in the range of higher sensitivity of the optical detectors 60, e.g., green visible light, the filtering of the ambient light by the fingertip 40 reduces the sensitivity of the fingerprint sensor 10 to ambient light. Persons skilled in the art can select appropriate light sources 50 and optical detectors 60 to practice this embodiment of the present invention.

In another embodiment, as illustrated schematically in FIG. 32C, the fingerprint sensor 10 comprises an opaque material layer 37, a color filter layer 30 comprising a hardcoat layer 35 and a second material 34, a top coat layer 36, an active matrix sensor array 60, and a substrate 20 comprising a first material 22. The fingerprint sensor 10 also comprises a light source 50 comprising a green LED 84, a microlens array 86, and a reflector 88. In addition, the fingerprint sensor 10 further comprises a light shield 89.

The microlens array 86 and the reflector 88 are positioned below the active matrix sensor array 60, and the green LED 84 is positioned to one side of the microlens array 86. The green LED 84 illuminates the microlens array 86 and reflector 88, and the light from the green LED 84 is reflected towards the fingertip 40. The microlens array 86 comprises a plurality of reflective surfaces which direct the reflected light upward towards the fingertip 40. In certain embodiments, the reflective surfaces can be curved while in alternative embodiments the reflective surfaces can be angled, patterned, or generally rough in shape or form. Typically, the microlens array 86 comprises a molded acrylic material, and microlens arrays 86 compatible with this embodiment are available from Lumitex, Inc, of Strongsville, Ohio. To provide a more uniformly distributed illumination of the fingertip 40, the light shield 89 comprises an opaque material and is positioned to block light from the green LED 84 from directly illuminating the fingertip 40 without reflecting from the microlens array 86.

Note that not all of the components listed and described in FIGS. 23, 31A, 31B, 31C, 32A, 32B, and 32C are required to practice the present invention, since these figures merely illustrate particular embodiments of the fingerprint sensor 10. Other embodiments compatible with the present invention can eliminate some or all of these components, or can include additional components. It will be further appreciated that the color filter layer 30 as herein described with respect to the sensor 10 is compatible with the sensor 1003 and optical modules 1200, 1300, 1400, and 1500 previously described and the sensors 200, 300, 330, 370, 420, 450, 468, and 500 to be described in greater detail below and could be readily adapted by one of skill in the art without detracting from the spirit of the present invention.

In another aspect, the present invention comprises a fingerprint sensor 200 wherein the light source 50 is positioned substantially adjacent to the fingerprint sensor 200 wherein the light emitted from the light source 50 is directed towards a relief object through a substrate material to improve the image quality and resolution. Furthermore, the system and method presented herein have the ability to harvest ambient light in such a way that it may be used for improving image contrast while at the same time eliminating the need for employing a shield to prevent ambient light from entering the sensor device.

Still other aspects of the present invention will now be discussed which may utilize the aforementioned methods for rendering the fingerprint image. Additionally, these embodiments will disclose other features of the fingerprint sensor which demonstrate other methods and structures for detecting and imaging the fingerprint surface. In one aspect, the following methods and structures increase the accuracy or ease of reentering, as well as, desirably add other functionalities to the fingerprint sensor 200.

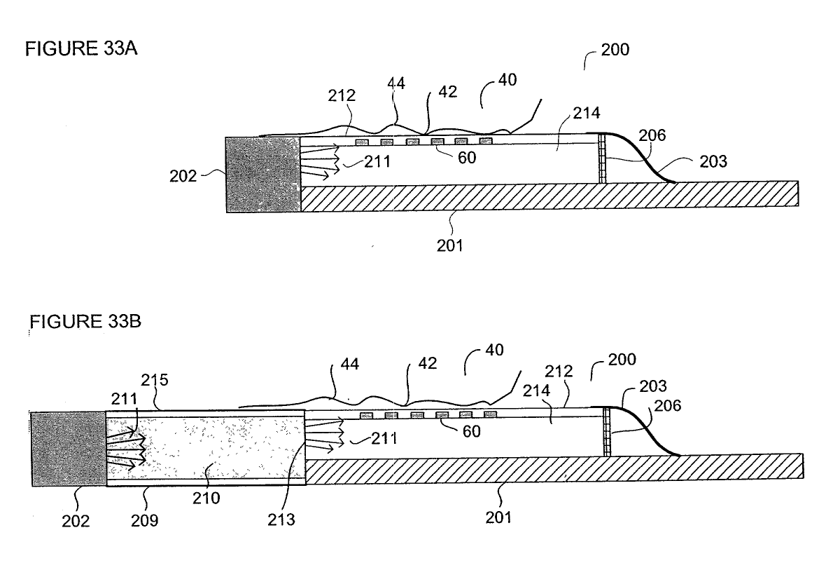

FIG. 33A illustrates a simplified cross sectional diagram of the fingerprint sensor 200 attached to a printed circuit board (PCB) 201 with a latch or harness 203. In one aspect, the light source 50 of the fingerprint sensor 200 comprises a side injected light source 202 for illuminating the fingertip 40. In one embodiment, the side injected light source 202 is positioned substantially adjacent to the fingerprint sensor :200 wherein light 211 is directed from the side injected light source 202 into the fingerprint sensor 200. A plurality of reflective surfaces 206 may further be positioned along the sides and bottom of the fingerprint sensor 200 to increase the amount of light 211 which is directed towards the fingertip 40 to be subsequently reflected and detected by a plurality of optical detectors 60.

In one aspect the reflective surfaces 206 will comprise a metal, glass, acrylic or plastic material having light reflective properties. Additionally, the reflective surfaces 206 may comprise one of the aforementioned materials used in conjunction with a light reflective layer or coating to produce the desired light reflective surfaces 206. The reflective surfaces 206 improve the illumination of the fingertip 40 by redirecting light, which might not otherwise reach the fingertip 40, in a direction which results in the light being transmitted towards the fingertip 40. Thus, the path of the light may be altered by the reflective surfaces 206 so as to increase the quantity of light which is directed towards the fingertip 40 as compared to that of the light which travels along paths that will not reach the fingertip 40. For example, a side reflective surface 206 may be positioned along the side opposite of the side injected light source 202 to reflect light 211 that would otherwise pass through the fingerprint sensor 200 without striking the fingertip 40.

Additionally, a reflective surface base may be positioned along the underside of the fingerprint sensor 200 to desirably reflect light 211 in the direction of the fingertip 40. The reflective surfaces 206 may desirably be used individually or in combination so as to reduce the amount of light 211 lost along undesirable paths and to increase the amount of light 211 directed towards the fingertip 40. In one embodiment, the reflective surfaces will comprise a metal or metal alloy coated or layered on the reflective surfaces 206 to yield a material which desirably possesses the aforementioned light-reflective properties.

In one aspect, light 211 emitted by the side-injected light source 202 propagates along a path which does not intersect with the fingertip 40. Unless reflected, this quantity of light 211 would be lost, for example, by transmission through the sides or base of the fingerprint sensor 200. By positioning the reflective surfaces 206 along areas of the sensor 200 where light would otherwise escape (such as the base or side walls of the sensor 200), the light can be desirably reflected back into the sensor 200 and furthermore redirected towards the fingerprint surface 40 to desirably increase the intensity of illumination produced by the light source 202.

FIG. 33B illustrates the side injected light source 202 coupled to a light conductive material 210 used to direct the emitted light 211 through a conduit 809 until the light 211 reaches a side surface 213 of the fingerprint sensor 200. Use of the light conductive material 210 desirably permits the side injected light source 202 to be displaced from the fingerprint sensor 200 while maintaining sufficient illumination of the fingertip 40. In one aspect, the light conductive material 210 comprises an acrylic, glass, or plastic light pipe or fiber optic material which efficiently internally conducts light 211 with minimal loss of light intensity. The light conductive material 210 may further be coupled to, or surrounded by, a conduit reflector 215 which desirably increases the amount of light 211 transmitted into the fingerprint sensor 200 by reducing the amount of stray light which might otherwise exit the light conductive material 210 in positions other than that of the desired position into the fingerprint sensor 200.

The aforementioned fingerprint sensors 200, shown in FIGS. 33A and 33B, may be advantageously used to detect a plurality of ridges 42 and valleys 44 formed along the fingertip 40 by using light 211 directed through an interior region 212 of the fingerprint sensor 200 to an upper surface 214 of the fingerprint sensor 200. In one aspect, the reflective surfaces 206 will desirably be positioned along the sides or edges of the sensor 200 to prevent light 211 from escaping from the sensor without intersecting with the fingerprint surface 40. At least a portion of the light 211 is reflected at the upper surface 214 where the valleys 44 of the finger 805 are positioned and is subsequently detected by an array 58 of optical detectors 60, such as those described above in reference to FIG. 28, to reconstruct an electronic image of the fingertip 40 in a manner that will be discussed in greater detail hereinbelow.

In one aspect, the reflective surfaces 206 advantageously reflect or redirect the light 211 at an angle which desirably increases the light's reflectivity when it interacts with the fingertip 40. As a result, the light-sensing photodetectors 60 of the fingerprint sensor 200 may receive and process the fingertip surface or relief information more readily with an increase in the efficiency of light utilization. Thus, the reflective surfaces 206 contribute to increased sensor sensitivity and require a light source with lower illumination intensity as compared to a sensor apparatus which does not employ reflective surface illumination.

The use of a light conductive material 211, such as the aforementioned light pipe, advantageously permits the light source 202 to be displace from the sensor 200 while still providing sufficient light transmission into the sensor 200 to permit the illumination of the fingertip 40. This conveys a manufacturing or fabrication advantage to the sensor 200 by permitting more flexible placement of the light source 202 and may be important in instances where the light source 202 generates heat which might interfere with the sensor 200 operation.

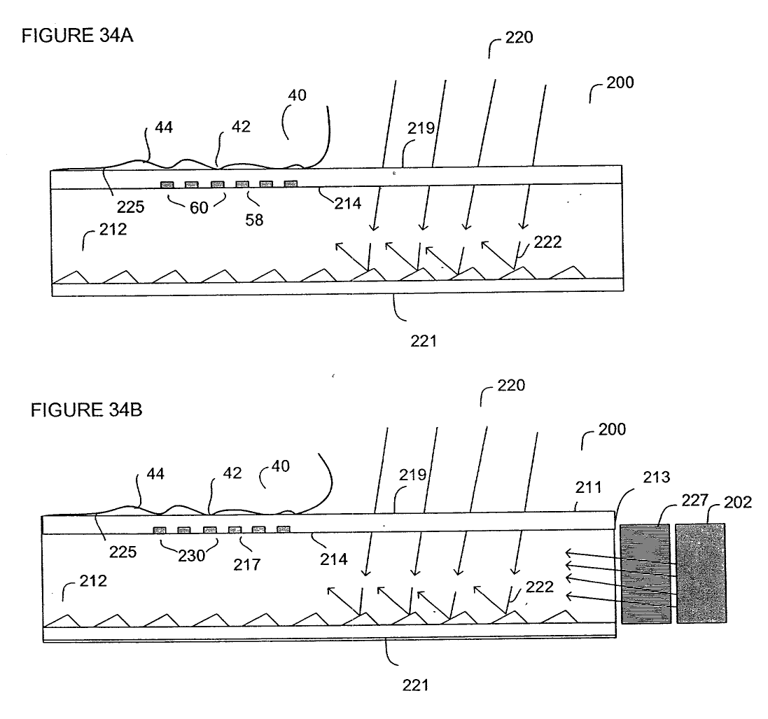

FIG. 34A illustrates a method for illuminating a relief object, such as a fingertip 40, to be subsequently resolved using a fingerprint sensor 200. The interior region 212 of the fingerprint sensor 200 may be formed from substantially light conductive material 210, such as glass or plastic. In one aspect, the fingerprint sensor 200, comprises a rectangular region with dimensions of approximately 14 mm by 19 mm and provides a sufficient surface to position at least a portion of the fingertip 40 upon to permit the electronic resolution of the ridges 42 and valleys 44 of the fingertip 40.

The light conductive material 210 of the fingerprint sensor 200 serves as a support base and light conductivity medium for the array 58 of optical detectors 60. The array 58 is additionally formed on or near the surface of the fingerprint sensor 200 and is covered or encased in a substantially transparent protective top-coat 36. The top-coat 36 desirably possess a refractive index close to that of the fingertip 40 to improve the selective light reflecting properties associated when passing light over the ridges 42 and valleys 44 of the fingertip 40. Furthermore, the optical detectors 60 are spaced between approximately 5 microns and 20 microns apart to permit sufficient light to pass between adjacent optical detectors 60. In other embodiments, the fingerprint sensor 200 may contain additional components and layers such as, for example, layers and components associated with an LCD or CRT display or screen. These additional layers and components desirably do not substantially interfere with the operation of the fingerprint sensor 200 and may be used to enhance the functionality of the fingerprint sensor 200 or permit integration into other devices.

In one embodiment, ambient light 220 is utilized in conjunction with another illumination method such as the aforementioned side injected light source 202, to improve the resolution and contrast of the fingerprint sensor 200 as is illustrated in FIG. 34A. During operation of the fingerprint sensor 200, ambient light 220 enters the fingerprint sensor 200 through an open region 219 which is not covered by the fingertip 40. Typically, the ambient light 220 enters the fingerprint sensor 200 from many different angles depending on the source of ambient light 220 present in the vicinity of the fingerprint sensor 200. A light reflective surface 221 is positioned substantially below or integrated into the base of the fingerprint sensor 200 and reflects 222 the incoming ambient light 220 towards the fingertip 40. The light reflective surface 221 is further configured in such a manner so as to reflect 222 the ambient light 221 at an angle which results in the ambient light 220 being transmitted from the open region 219 alongside the fingertip 40 to the underside 225 of the fingertip 40 wherein the ridges 42 and valleys 44 of the fingertip 40 can be identified.

The light reflective surface 221 used for reflecting ambient light 220 may be formed from numerous materials including an optical diffraction grating, a holography grating, a micro lens structure, a micro-prism device, or similar components possessing the necessary properties to reflect 222 the ambient light 220 which enters the fingerprint sensor 200. In one aspect, the light reflective surface 221 will further possess properties for selectively reflecting light at a particular angle or with a particular wavelength to improve the contrast or quality of the sensed fingertip 40. Selective light reflection may further comprise absorbing or reflecting undesirable ambient light 220 of a particular angle or wavelength away from the fingertip 40 to selectively illuminate the fingertip 40 with ambient light 220 of a particular wavelength and/or at a specific desired angle of incidence.

FIG. 34B further illustrates the fingerprint sensor 200 and light reflecting surface 221 used in conjunction with a side injected light source 202. In one aspect, the side injected light source 202 emits light 211 to illuminate the underside 225 of the fingertip 40 in a uniform manner. The emitted light 211 may additionally pass through a directivity enhancement element 227 interposed between the side injected light source 202 and the side surface 213 of the fingerprint sensor 200. The directivity enhancement element 227 serves to direct the light 211 along a desirable angular vector to increase the uniformity of the illumination of the fingertip 40. In one aspect, the directivity enhancement element 227 comprises a substantially transparent plastic, glass, or acrylic component with light bending properties.

Improved illumination and relief feature recognition is accomplished by passing the light from the light source 202 into the directivity enhancement element 227 in a first direction wherein at least a portion of the light is redirected of bent in a second direction to result in a projection of light along an angular vector which desirably enhances the amount of light which illuminates the fingertip region 40. Additionally, the directivity enhancement element 227 may further bend or redirect the light in such a manner so as to create an angle of incidence which improves the reflection of light off of the valleys 818 of the fingertip or increases the proportion of light which undergoes total internal reflection at the interface between the underside 225 of the fingertip and the top surface of the fingerprint sensor 200 in a manner that will be discussed in greater detail hereinbelow.

During operation of the fingerprint sensor 200, the side injected light 211 enters the side surface 213 of the fingerprint sensor 200 and cooperates with the reflected ambient light 220 to desirably illuminate the fingertip 40 with greater contrast than by using either light components 211 or 220 alone. One reason for the improved contrast results from the combination of light 211, 220 which have different angular components or angles of incidence and desirably enhance the quality of the electronic image obtained when reflected light is sensed by the array 58 of optical detectors 60 as described in greater detail hereinbelow.

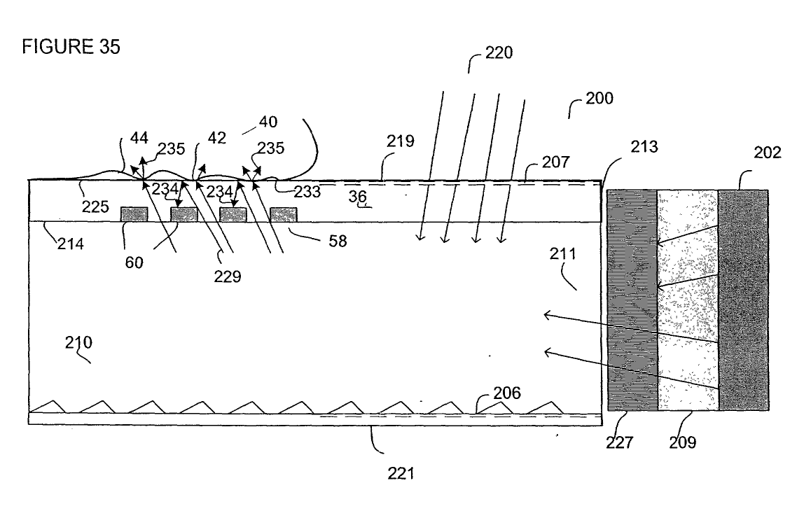

FIG. 35 further illustrates one embodiment of the present invention comprising a selective reflection method used to better discern between the ridges 42 and valleys 44 of the fingertip 40. The side injected light source 202 comprises a lighting apparatus such as an organic LED, a inorganic LED, a electro-luminescent component, or other light generating device which emits light 211 along the side of the fingerprint sensor 200 as previously described. The directivity enhancement element 227 and/or light conduit 209 may further be interposed between the side injected light source 202 and the side surface 213 of the fingerprint sensor 200 to improve the uniformity of the lighting of the fingertip 40 as previously described. In one aspect, the directivity enhancement element 227 may comprise a color filter, such as the color filter layer 30, used to selectively enhance a particular wavelength of side injected light 211 which is found to be most beneficial in obtaining a resolvable fingerprint image. Alternatively, the directivity enhancement element 227 may comprise a polarizing element or diffraction grating which directs the light 211 entering from the side surface 213 of the fingerprint sensor 200 along a particular plane or angle of incidence to improve the quality of the fingerprint image. Additionally, ambient light 220 may be reflected towards the fingertip 40 using the reflective grating 221 to increase the illumination of the fingertip 40 as previously discussed. The side injected light source 202 and ambient light 220 may be used in conjunction with one another to improve the overall contrast of the fingertip 40 to desirably obtain increased contrast and improved accuracy when electronically imaging the fingerprint.

A benefit obtained from using ambient light 220 in conjunction with the side light source 202 is that the need for a shield or sensor cover is eliminated and the flexibility of the fingerprint sensor 200 is improved. Additionally, the resulting electronic image may more accurately represent individual fingerprints when using combined light sources and results in increased accuracy in discriminating between similar but not identical fingerprints.

It will be appreciated by those of skill in the art that the combination of ambient light 220 and side injected light 211 is not necessarily required for electronically generating a representation of the fingerprint pattern of the fingertip 40. In certain embodiments, a single light source or method of illumination may be used to illuminate the fingertip 40. For example, the side injected light source 202 may be exclusively used for illuminating the fingertip 40 and ambient light 220 may be inhibited from either entering or reflecting off of the surfaces of the fingerprint sensor 200 by positioning light absorptive layers 207 along the fingerprint sensors 200 in positions where ambient light 220 interacts with the fingerprint sensor 200 to absorb or block ambient light 220. Furthermore, other lighting methods and types of light emitting devices exist that may sufficiently illuminate the fingertip 40 and may be used in conjunction with the aforementioned components of the fingerprint sensor 200 and thus represent additional embodiments of the fingerprint sensing device 200.

FIG. 35 further illustrates one aspect of fingerprint detection wherein the relief features of the fingerprint are detected by selective reflection of light using the property of total internal reflection. More specifically, the fingertip 40 is resolved by the passage of light through the substantially transparent light conductive material 210 of the fingerprint sensor 200 to the upper surface 214 of the light conductive material 210. A sufficient amount of incoming light 229 is further passed between the photodetector elements 220 and through the top-coat layer 36 to the interface 233 between the top-coat layer 36 and the fingertip 40 where the light 211 is either reflected, refracted, or absorbed by the surface of the fingertip 40 as discussed in previous sections.

When the portion of the fingertip 40 comprising the valleys 44 rests over the surface of the top-coat material 36, incoming light 211 in this area is substantially reflected towards the array 58 of optical detectors 60 in accordance with the principles of total internal reflection. In a more detailed sense, the selective reflection of light 211 along the valleys 44 of the fingertip 40 results from an optical density differential wherein the top-coat material 36 comprises a medium with a greater optical density than the space under the valleys 44 of the fingertip 40. Furthermore, light 211 is not substantially reflected in the areas where the ridges 42 of the fingertip 40 are positioned due to the optical density of the top-coat material 36 being fashioned to have a substantially identical optical density as compared to that of the fingertip 40.

As light 211 propagates through the top-coat material 36 the light 211 reaches the interface between the surface of the top-coat material 36 and the underside 225 of the fingertip 40. Light 211 with a sufficient angle of incidence undergoes total internal reflection under the areas where the valleys 44 of the fingertip 40 are positioned resulting from the light 211 traveling through a material with a greater optical density and interacting with a material with a lesser optical density. The array 58 embedded within the top coat layer 36 then registers the reflected light 235 wherein the plurality of optical detectors 60 are triggered by light 211 which has undergone total internal reflection.

Light 211 which propagates through the top-coat material 36 into areas where ridges 42 are positioned do not experience a substantial change in optical density when passing through the top-coat material into the underside 225 of the fingertip 40. As a result, the light 211 interacting with the areas where ridges 42 are present is transmitted into the fingertip 40 without undergoing appreciable total internal reflection.

Thus, a selective reflectivity of light 211 is observed between light 211 which interacts with the ridges 42 and valleys 44 of the fingertip 40 to provide a method for identifying the relief features of the fingertip 40. Furthermore, the selective reflection and transmittance of a sufficient amount of incoming light, selective triggers the array 58 of optical detectors 60 and results in the rendering of an electronic image which is representative of the reconstructed fingerprint pattern of the fingertip 40.

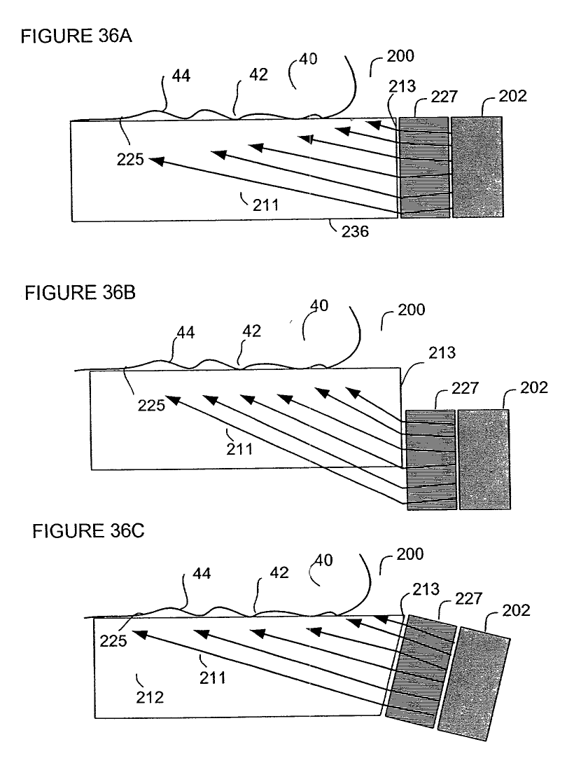

FIGS. 36A-C illustrate different modes by which the side injected lighting source 202 may be oriented to improve illumination of the ridges 42 and valleys 44 of the fingertip 40. As shown in FIG. 36A, the side injected light source 202 is positioned substantially adjacent to the directivity enhancement element 227 which in turn is positioned substantially adjacent to the side surface 213 of the fingerprint sensor 200. Light 211 generated by the side injected light source 202 is typically dispersed in many directions and is desirably filtered and oriented using the directivity enhancement element 227. In one aspect, the directivity enhancement element 227 bends or polarizes the light 211 along an angular path which provides increased illumination of the underside 225 of the fingertip 40. Reorientation or bending of the light 211 further improves the illumination of the fingertip 40 by uniformly spreading at least a portion of the light 211 across the fingertip 40 while at the same time reducing or eliminating undesirable angles or wavelengths of light which might otherwise reduce the contrast or quality or the resulting electronic image of the fingerprint.

FIG. 36B illustrates an alternative positioning of the side injected light source 202 and directivity enhancement element 227. In one aspect, the side injected light source 202 and directivity enhancement element 227 are vertically displaced or offset from the side surface 213 of the fingerprint sensor 200. Though offset from the fingerprint sensor 200, the directivity enhancement element 227 polarizes or bends light 211 emitted from the side injected light source 202 in a manner that permits the light 211 to be transmitted into the fingerprint sensor 200. The offset or displacement of the side injected light source 202 and directivity enhancement element 227 further permits at least a portion of the light 211 to enter the bottom surface 236 of the fingerprint sensor 200. As a result, improved uniformity of light 211 distribution across the fingertip 40 is thereby accomplished.

FIG. 36C illustrates the fingerprint sensor 200 wherein the side injected light source 202 and directivity enhancement element sent 227 re side substantially adjacent to the fingerprint sensor 200 but are angularly displaced from the major axis of the fingerprint sensor 200. Additionally, the side surface 213 of the fingerprint sensor 200 may be formed to coincide with the angular displacement of the side injected light source 202 and directivity enhancement element 227. This structure serves to direct the emitted light 211 with a desirable angle of incidence which may improve the illumination of the fingertip 40. Additionally, the side surface 213 may be formed in such a manner so as to enhance the bending or refracting of the light 211 wherein a prismatic effect is displayed by the light conductive material 210 of the interior region 212 of the fingerprint sensor 200. As with previous embodiments shown in FIGS. 36A-B, the configuration of the fingerprint sensor 200, side injected light source 202, and directivity enhancement element 227 may desirably enhance the illumination of the fingerprint region and improve the uniformity of light intensity distributed across the fingertip 40.

The embodiments of the fingerprint sensor 200 shown in FIGS. 36A-C may additionally comprise a light conduit 209, as previously discussed, to permit alternative placement of the side injected light source 202 in positions other than those indicated in the illustrated embodiments. Furthermore, the light conduit 209 may be interposed between the fingerprint sensor 200 and the directivity enhancement element 227, or alternatively, the light conduit 209 may be interposed between the side injected light source 202 and the directivity enhancement element 227. In both cases, the combination of the side injected light source 202, directivity enhancement element 227, and light conduit 209 may be configured to direct light 211 into the fingerprint sensor 200 in the indicated directions and orientations.

In addition to the aforementioned advantage of uniform light distribution, variations in the positioning of the side injected light source 202 and directivity enhancement element 227 may be beneficially used to accommodate different configurations of electronics which may be present in the area surrounding the fingerprint sensor 200. This feature becomes increasingly important in embodiments of the fingerprint sensor 200 where space is limited and results in an increase in the flexibility of design options which may incorporate the fingerprint sensor 200 and side injected light source 202.

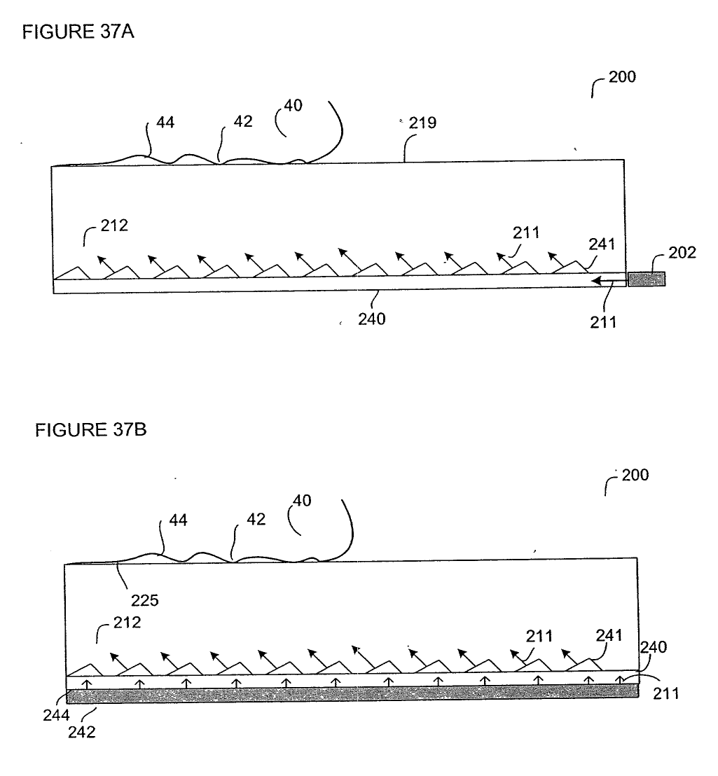

FIG. 37A illustrates another embodiment of the fingerprint sensor 200 wherein a bottom injected light method is utilized to illuminate the fingertip 40. In one aspect, bottom injected lighting is accomplished by coupling a side injected light source 202 with a diffuser component 240. The side injected light source 202 may be positioned adjacent to the diffuser component 240 wherein light 211 is conducted directly into the diffuser 240. Alternatively a light conduit 209 (not shown) may be interposed between the side injected light source 202 and the diffuser 240 to improve the light injection into the diffuser 240. Additionally, as previously mentioned, a directivity enhancement element 227 may also be interposed between the side injected light source 202 and the diffuser 240 to improve the lighting characteristics used to illuminate the fingertip 40.

The diffuser 240 further comprises a light conductive material, such as glass or plastic, which receives the light 211 from the side injected light source 202 and distributes and bends the light 211 in such a manner so as to direct the light 211 towards the fingertip 40. In one aspect, the diffuser 240 is further coupled to a micro-prism or micro-lens array apparatus 241 which receives at least a portion of the light 211 transmitted through the diffuser 240 and directs the light 211 towards the fingertip 40. One advantage realized by using the bottom injected light apparatus resides in the more uniform distribution of light 211 over a larger area compared to other conventional fingerprint illumination methods. Furthermore, the coupling of the micro prism apparatus 241 to the diffuser 240 further increases the quantity of light 211 which is directed along a desirable angle of incidence to improve the effect of total internal reflection by the valleys 44 of the fingertip 40 while maintaining an absorptive or refractive effect from the ridges 42 of the fingertip 40.

FIG. 37B illustrates another embodiment of the diffuser 240 and micro prism apparatus 241 wherein a backlight source 242 is used to provide light 211 for illuminating the fingertip 40. In this embodiment, light 211 is directed from a backlight source 242 into the diffuser 240 to uniformly illuminate the bottom surface 244 of the diffuser 240. In one aspect, the backlight source 242 comprises an LED array, electroluminescent panel or other lighting source with substantially the same area and/or surface dimensions as the bottom surface 244 of the diffuser 240. One advantage of this configuration is the backlight source 242 provides uniform luminosity across the region of the diffuser 240 and, as a result, improves the uniform distribution of light 211 over the underside 225 of the fingertip 40.

It will be appreciated by those of skill in the art that the aforementioned embodiments of the lighting apparatus, including the ambient lighting method, side lighting method, and backlighting method, may be used individually or in combination to improve the contrast and resolution of the fingerprint and improve the accuracy in discriminating between fingerprint patterns. Likewise, the components of the lighting apparatus may be modified or arranged in such a manner so as to improve the selective reflective effect resulting from the passage of light 211 over the fingertip 40. It will be further appreciated that the light sources 50, 202, 220, and 220 herein described can be used individually or in combination with the sensors 10 and 1003 and optical modules 1200, 1300, 1400, and 1500 previously described and the sensors 200, 300, 330, 370, 420, 450, 468, and 500 to be described in greater detail below without detracting from the spirit of the present invention.

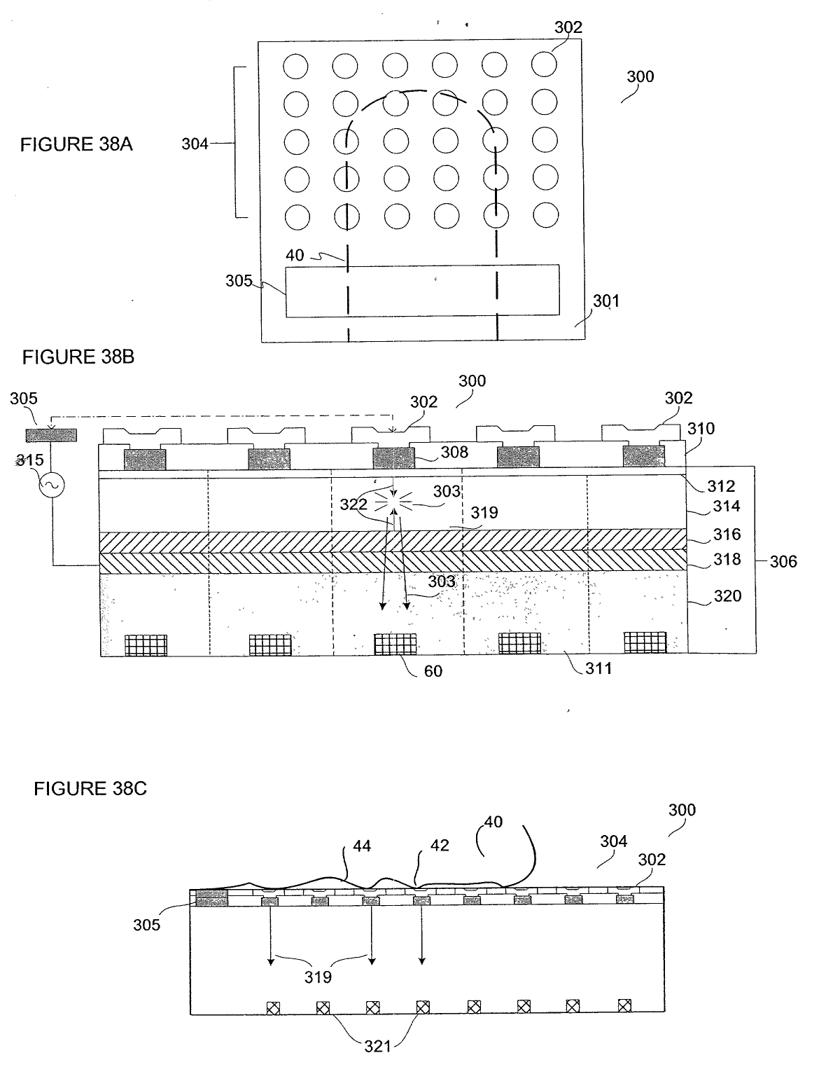

FIGS. 38A-C illustrate a contact triggered or tactile fingerprint sensor 300 used to electronically sense and image the fingertip 40. As schematically shown in FIG. 38A, a surface 301 of the fingerprint sensor 300 comprises a plurality of external contact electrodes 302 arranged about the surface 301 upon which the fingertip 40 is positioned. The arrangement of the external contact electrodes 302 forms a sensing array 304 with approximately 315×240 external electrodes 302 arranged in an area of between approximately 1.4 cm×1.8 cm and 1.6 cm×2.2 cm wherein the spacing between individual external electrodes 302 is between approximately 20 μm and 30 μm apart. A ground contact 305 is further formed on the surface 301 of the fingerprint sensor 300 and is positioned adjacent to the sensing array 304. The ground contact 305 forms a substantially rectangular region with approximate dimensions of 0.5 cm in width by 1.5 cm in length.

The sensing array 304 and ground contact or surface 305 are positioned on the substantially planar surface 301 of the fingerprint sensor 300 to allow the fingertip 40 to be positioned in such a manner so as to permit selective contact between the ridges 42 of the fingertip 40 and the external electrodes 302 of the sensing array 304. Furthermore, at least a portion of the fingertip 40 is desirably positioned to rest on the ground contact 305 in a manner that with be described in greater detail hereinbelow.

As shown in the cross-sectional view of FIG. 38B, the tactile fingerprint sensor 300 further comprises a plurality of substrate layers 306 that form a conductive medium through which electronic and light impulses may travel. In one aspect, a plurality of internal contact electrodes 308 are positioned adjacent to and in continuous contact with the external contact electrodes 302. A passivation layer 310 is further formed about the internal contact electrodes 308 to electrically isolate each external electrode 302/internal electrode 308 pair. The passivation layer 310 serves as a protective barrier or coating for the tactile fingerprint sensor 300 wherein the underlying components and layers 306 within the sensor 300 are shielded from damage by external or environmental factors. The passivation layer 310 is desirably formed from a non-conductive plastic or acrylic material and has a thickness of approximately 2.0 μm to form the surface 301 of the fingerprint sensor 300.

The substrate layers 306 below the internal electrode 308/passivation layer 310 form a region comprising an organic light emitting diode (OLED) cell 311 comprising an electron transportation layer (ETL) 312, an organic polymer layer (OPL) 314, a hole transportation layer (HTL) 316, a transparent conducting oxide (TCO) layer 318, and a substrate or contact imager layer 320. The OLED cell 311 is formed substantially below the plurality of internal contact electrodes 308 such that a least a portion of the bottom surface of each internal electrode 308 is in direct contact with a portion of the electron transport layer 312 of the OLED cell 311.

A power source 315 is further connected between the TCO layer 318 and the ground contact 305 such that, when the ground contact 305 is conductively joined to any external electrode 302, a conductive path is formed and a voltage is applied to the OLED cell 311. When the appropriate voltage is applied to the OLED cell 311, light emission is produced within the OLED cell 311 and is registered by a plurality of optical detectors 60 in a manner that will be described in greater detail hereinbelow.

In the OLED cell 311, each internal electrode 308 forms a cathode to the OLED cell 311 with the TCO layer 318 forming an anode layer. As described above, when a voltage is applied between to one or more of the plurality of internal electrodes 308 and the TCO layer 318, positive and negative charges 322 are injected into the OPL 314. The underlying ETL 312 and HTL 316 act as the sources for the positive and negative charges 322, as is known in the art of OLED design and manufacture, and these charges 322 recombine in the OPL 314 to produce OLED light 303 in the form of electroluminescence.

The fingerprint sensor 300 utilizes at least a portion of the emitted OLED light 303 which passes through the HTL 316 and TCO 318 layers to be subsequently captured by the optical detectors 60. In one aspect, the HTL 316 and TCO 318 are at least partially transparent so as to permit the transmission of the OLED light 303 into the substrate layer 320. As OLED light 303 enters the substrate layer 320, the plurality of optical detectors 60, arranged substantially below each internal electrode 308, detect and register the OLED light 303 produced as a result of the triggering of the OLED cell 311.

Based on the aforementioned principles of operation of the OLED cell 311, a fingertip 40 may be rendered by a plurality of triggering events which occur when a least a portion of the fingertip 40 is placed in contact with the tactile fingerprint sensor 300. The placement of the fingertip 40 conductively joins the ground contact 305 and one of more of the external electrodes 302 to thereby create a path of conductivity wherein a voltage may be made to pass through the layers 306 of a discrete section of the fingerprint sensor 300 comprising the OLED cell 311.

In one aspect, the tactile fingerprint sensor 300 produces discrete OLED light 303 in response to the individual triggering of external electrodes 302 by the ridges 42 of the fingertip 40. As shown in FIG. 38C, the fingertip 40 is desirably placed over the sensor array 304 wherein a portion of the fingertip 40 covers a number of individual external electrodes 302. When the fingertip 40 makes contact with the ground surface 305, a path of conductivity is created wherein a voltage is applied to the external electrodes 302 that are in contact with the ridges 42 of the fingertip 40. The applied voltage is conducted through the external electrode 302 to the internal electrode 308 and subsequently into the OLED cell 311 where the resulting applied voltage selectively triggers OLED light 303 in the OPL 314.

The aforementioned light triggering events are localized to the regions between the external electrode 302, to which the voltage was applied, and the area of the OPL 314 substantially below the external electrode 302. External electrodes 302 that are positioned under valleys 44 of the fingertip 40 do not receive an applied voltage as the fingertip 40 does not make contact with the external electrodes 302 in these positions. As a result, the relief structure of the fingertip 40 may be used to selectively illuminate OLED regions 319 of the OPL 314 that can be resolved to map the fingertip 40 and yield an electronic image of the fingerprint.

Crosstalk or light scatter resulting from light reflected by the valleys 44 or the surface of the sensor 200 underlying the valley 44 onto optical detectors 60 adjacent to the desired optical detector 60 is reduced by minimizing the path length of light travel between the reflecting surface and the optical detector 60. In one aspect, the path length is between approximately 3 microns and 5 microns with the optical detector 60 having dimensions of approximately 40 microns in width by 40 microns in length. Furthermore, the optical detectors 60 are spaced approximately 12 microns apart to permit light 211 to pass between the optical detectors 60 and illuminate the surface of the fingertip 40.

In one aspect, an image of the fingertip 40 is obtained by combining the results of the plurality of optical detectors 60 to reveal the areas in which the ridges 42 of the fingerprint are positioned relative to the valleys 44. As will be described in greater detail below, a controller 490 may be desirably integrated into the fingerprint sensor 300 to accumulate and process the signals generated by the optical detectors 60 to render the fingerprint image.

It will be appreciated that the tactile fingerprint sensor 300 need not depend on an externally positioned light source to illuminate the fingertip 40. The sensor 300 is compatible with the light sources 50, 202, 220, 242, and 311 previously described and 303 to be described in greater detail below as will be understood by one of skill in the art. As a result, the tactile fingerprint sensor 300 is not significantly affected by the presence of ambient light 220 and does not require side or back lighting devices. Another benefit of the tactile fingerprint sensor 300 resides in its ability to utilize a high-density sensor array 304. The high-density sensor array 304 possesses a greater number of contact points 302 compared to conventional fingerprint sensors and improves the quality and resolution of the fingerprint image resulting in increased sensitivity and accuracy in fingerprint rendering.

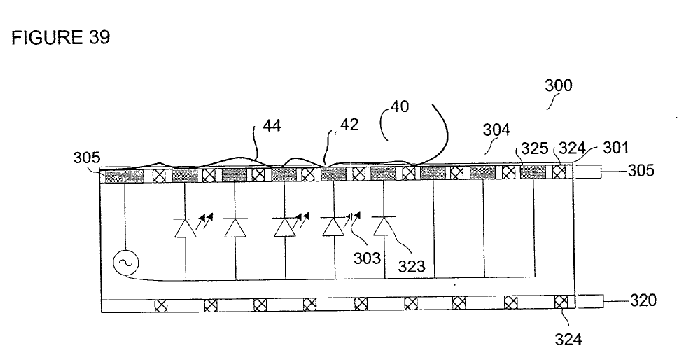

FIG. 39 illustrates another embodiment of the tactile fingerprint sensor 300 wherein the OLED cell 311 is represented as a plurality of photodiodes 323 coupled to discrete electrodes or contact points 325 to form the sensor array 304 upon which the fingertip 40 rests. The fingertip 40 is desirably positioned over the surface 301 of the sensor array 304 in contact with the ground electrode 305 and at least a portion of the discrete electrodes or contact points 325. The ridges 42 of the fingertip 40 selectively trigger the emission of discrete quantities of OLED light 303 which can then be identified to determine the relative position of the ridges 42 and valleys 44 of the fingerprint.

Identification of the emitted OLED light 303 is accomplished using a plurality of photodetectors 324 positioned in the substrate layer 320. Alternatively, the plurality of photodetectors 324 may be positioned in the upper surface 301 of the tactile fingerprint sensor 300 wherein incoming OLED light 303 is registered from the lower layers of the fingerprint sensor 300. When positioned in this manner, the photodetectors 322 may be further interposed between the electrodes 325 to capture emitted OLED light 303.

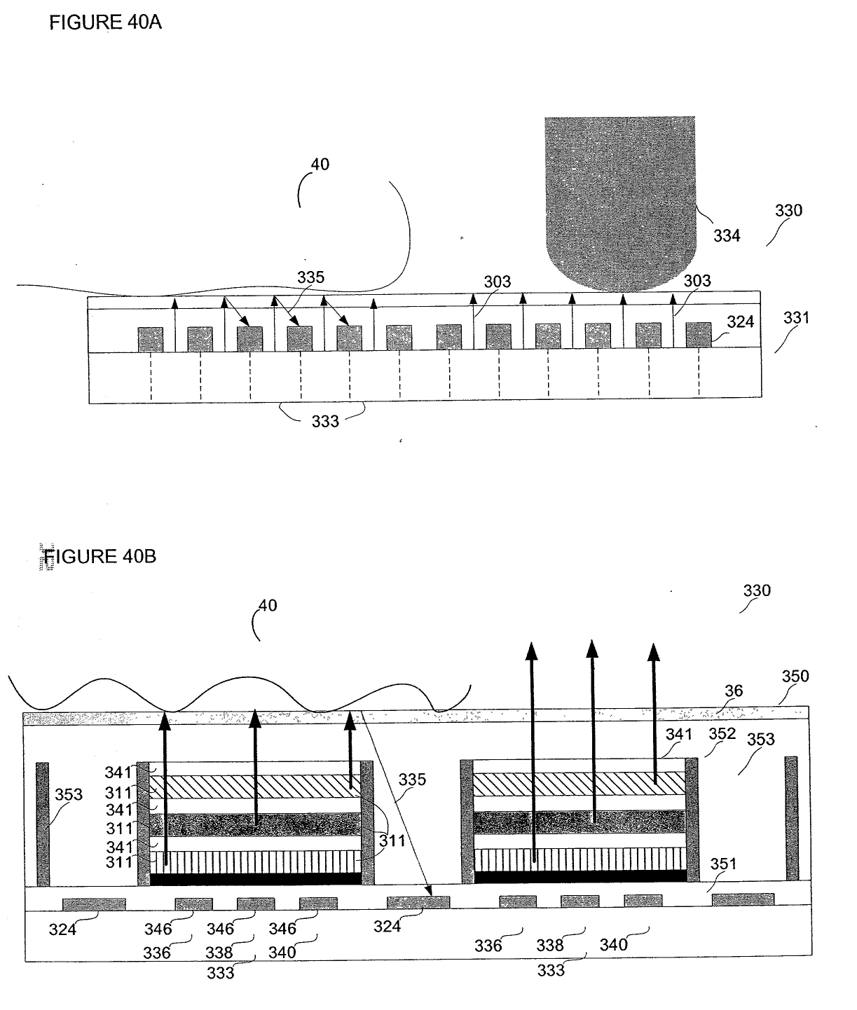

FIG. 40A illustrates one embodiment of a fingerprint sensor 330 used in conjunction with a multifunction OLED screen 331 that has a touch panel function. In one aspect, the OLED screen 331 comprises a plurality of discrete pixels 333 and is used to selectively emit OLED light 303 for display purposes. Additionally, a plurality of photodetectors 324 may be integrated into the multifunction screen 331 to sense the presence of a touch pen or stylus 334 when positioned over the multifunction screen 331.

As is known in the art of touch panel design, the presence of the stylus 334 may be detected when the stylus 334 is positioned over a region of pixels 333 wherein the photodetectors 324 detect a change in ambient light conditions. When the stylus 334 is brought into close proximity to the multifunction screen 331, the photodetectors 324 residing under the stylus 334 sense a reduction in the ambient lighting resulting from the stylus 334 blocking at least a portion of the light to prevent the light from interacting with the multifunction screen 331. The darkened area under the stylus 334 can then be identified relative to other areas of the multifunctional screen 331 that do not sense a change in ambient lighting to yield a method by which the position of the stylus 334 can be determined.

The multifunction OLED screen 331/fingerprint sensor 330 adds functionality for detecting and rendering the fingertip 40 using the pixels 333 as a source of OLED light 303 to illuminate the fingertip 40. When a fingertip 40 is positioned over the sensor 330, reflected light 335, which is reflected by the fingertip 40 and directed into the multifunction screen 331 where the photodetectors 324 are, is used to sense the reflected light 335. As with certain embodiments of the invention to be described in greater detail below, a controller 490 may be used to compile the triggering state of the photodetectors 324 and render an electronic image of the fingertip 40 in a manner that will be described in greater detail hereinbelow.

An enlarged cross-sectional view of the multifunctional display screen 331 as shown in FIG. 40A is shown in FIG. 40B to further illustrate the operation of the fingerprint sensor 330. A plurality of pixel elements 333 are positioned in close proximity to form the multifunctional OLED screen 331. In one aspect, each pixel element 333 comprises a red 336, green 338, and blue 340 color component that can be individually engaged to provide illumination of a specific wavelength or color. The color components 336, 338, 340 are formed in a layered stack comprising alternating layers of color OLED cells 311 corresponding to a red cell, a green cell, and a blue cell.

Each of the color OLED cells 311 further comprise a corresponding transparent conducting oxide (TCO) layer 341 and a corresponding electrode 346. When current is passed between a specific TCO layer 341 and the corresponding electrode 346, the OLED cell 311 associated with the TCO layer 341 and corresponding electrode 346 is selectively illuminated to produce OLED light 303 of a desired color or wavelength. At least a portion of the OLED light 303 generated by the OLED cells 311 is directed through the upper surface 350 of the display screen 331 to provide the illumination functionality of the multifunction screen 331. It will be appreciated by those of skill in the art, that the arrangement of OLED cells 311 may be accomplished using a transparent OLED (TOLED) configuration or a stacked OLED (SOLED) configuration, both of which are suitable for use in integration with the fingerprint sensor 330 into the touchscreen/display apparatus.

When the fingertip 40 covers the fingerprint sensor 330 and the multifunction screen illuminated 331, reflected light 335 may be reflected by the fingertip 40, as described previously, to be subsequently detected by the photodetector 324 positioned in close proximity to the pixel elements 333. In one aspect, the photodetector 324 comprises a thin film transistor (TFT) which is formed in a planarization layer 351 comprising a plastic, acrylic, or glass substrate located along the lower surface of the fingerprint sensor 330/multifunctional OLED screen 331.

A plurality of black matrix areas 352 are additionally formed on each side of the pixel element 333. The black matrix areas 352 block OLED light 303 from escaping from the sides of the pixel element 333 and thus illuminating the photodetector 324 directly. The black matrix areas 352 may further be formed from plastic or acrylic materials and are desirably opaque in nature to absorb or reflect OLED light 303 which is directed towards them. In the illustrated embodiment, each photodetector 324 is positioned between two adjacent pixel elements 333 with black matrix areas 352 extending about the sides of the photodetector 324. This arrangement blocks incoming paths of light aside from the path directly over the photodetector 324. When positioned in this manner, the photodetectors 324 may receive only reflected light 335 reflected by the fingertip 40 from an adjacent pixel element 333 thus reducing stray light detection and improving sensitivity of the fingerprint sensor 330.

The surface of the fingerprint sensor 330 is formed by a second planarization layer 353 extending about the pixel elements 333 and serves as an oxygen and moisture barrier to protect the embedded electronic components. The fingerprint sensor 330 may be further coated with a transparent topcoat layer 36 to provide added protection and resistance to damage from exterior elements such as the stylus 334 and fingertip 40.

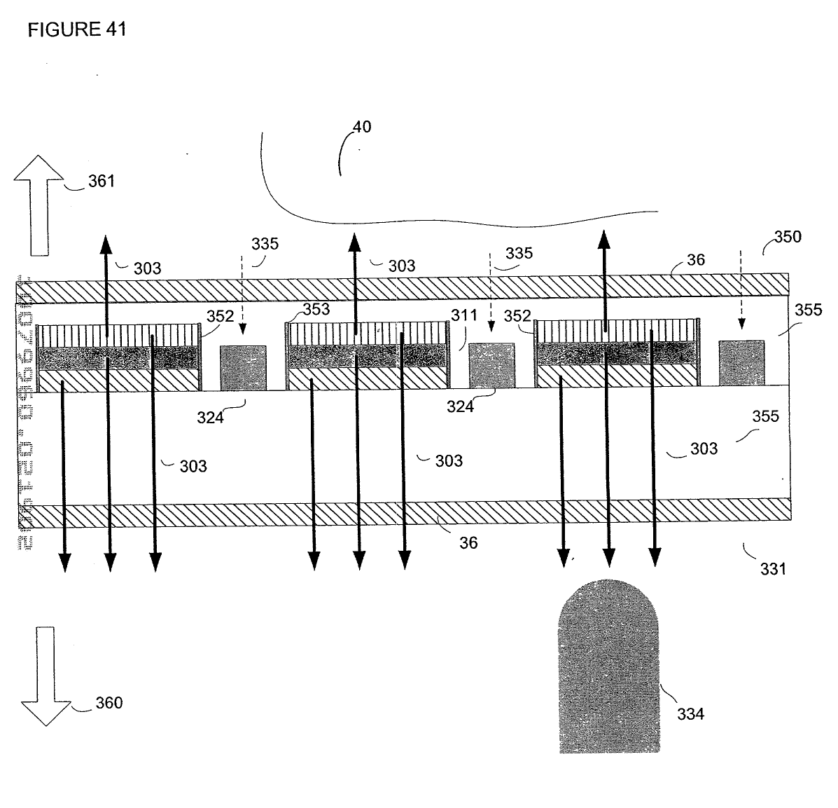

FIG. 41 illustrates another embodiment of fingerprint sensor 330 integrated into the multifunction OLED screen 331. In the illustrated embodiment, the OLED screen 331 has a directional functionality wherein in a first direction 360 the OLED screen 331 functions as a display apparatus and touchscreen. In the first direction 360, OLED light 303 is emitted from the plurality of color OLED cells 311 through a substrate/planarization layer 355 and topcoat layer 36 of the screen 331. Subsequent detection of the presence of the stylus 334 can be made, as previously described, by the plurality of photodetectors 324 interposed between the OLED cells 311.

The OLED screen 331 may additionally possess a second, substantially transparent substrate/planarization layer 355 and topcoat layer 36 positioned along the opposing side of the OLED screen 331 to permit a least a portion of the OLED light 303 emitted by the OLED cells 311 to be transmitted through the opposing side of the screen 331 in a second direction 361. This side of the screen 331 is configured to function as a fingerprint sensor 330 wherein a least a portion of the OLED light 303 is reflected 335 towards the photodetectors 324 when the fingertip 40 is appropriately positioned along the second surface 350 of the OLED screen 331.

The directional functionality of the OLED screen 331/fingerprint sensor 330 may be advantageously used to reduce the accumulation of dirt, oils, residues and other contaminants on the display side 360 of the screen 331. These accumulations may occur when the fingerprint sensor 330 is repeatedly used and results in reduced display quality. In a single direction integrated display and fingerprint sensing device, repeated cleaning of the screen may be necessary to remove the smudges and residues left behind by the fingertip 40. Confining finger sensing activities to a side other than the display side 360 of the screen 331 beneficially reduces the problems associated with the accumulation of these contaminants. Furthermore, by using the light 303 emitted from the OLED cells 311 in opposing directions, the fingerprint sensing apparatus 330 desirably saves space and reduces the number of electronic components which are needed to fabricate a display device with the plurality of functionalities described above.

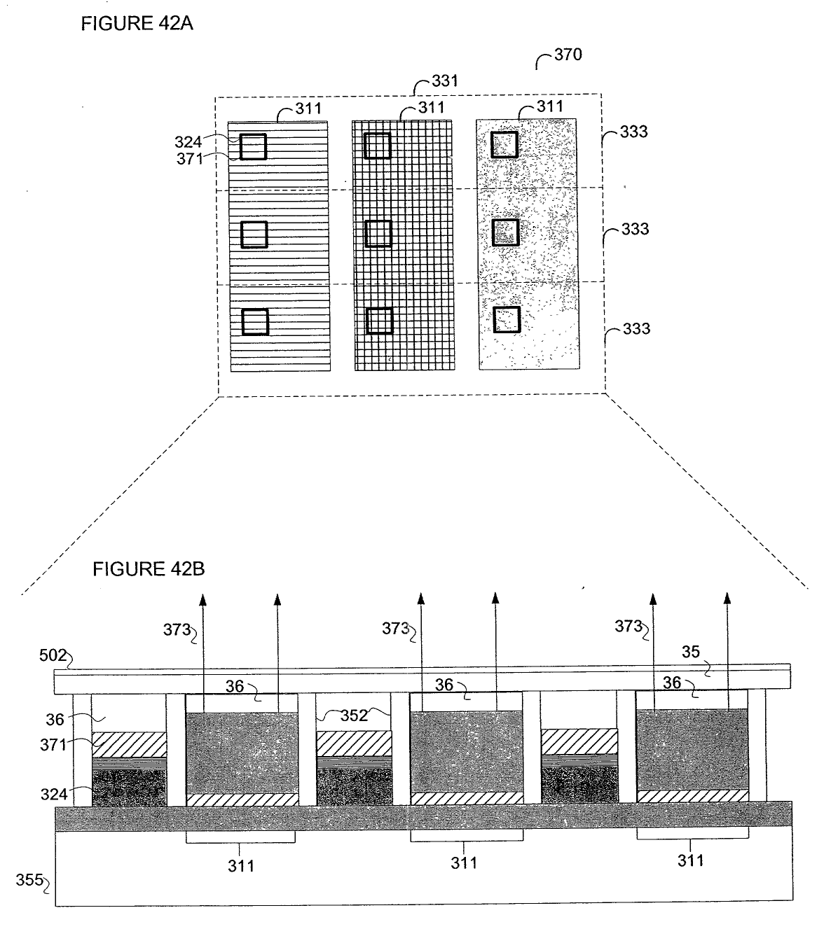

FIG. 42A-B illustrates an OLED fingerprint sensor 370 with an integrated color filter. As previously discussed, color filters may be advantageously used to select colors or wavelengths of light that yield improved contrast and resolution when imaging the fingertip 40. FIG. 42A illustrates a portion of the OLED display 331 comprising a plurality of pixel elements 333. Each pixel element 333 comprises three OLED color cells 311 corresponding to a red cell, a green cell, and a blue cell and may be selectively engaged to provide a large number of possible color combinations and wavelengths. The pixel elements 333 further comprise an integrated photodetector 324 and color filter 371 which are used to identify reflected light 335 when a fingertip 40 is positioned over the fingerprint sensor 370 in a manner that will be discussed in greater detail hereinbelow.

The cross-sectional detail of the pixel elements 333 shown in FIG. 42B, further illustrates the arrangement of the OLED fingerprint sensor 370 wherein the OLED color cells 311 are positioned on the substrate 355 with interposing color filter-protected photodetectors 324. Black matrix structures 352 are further positioned between each OLED cell 311 and its corresponding photodetector 324 to prevent emitted OLED light 303 from undesirably triggering the adjacent photodetectors 324 without first interacting with the fingertip 40. A substantially transparent hardcoat layer 35 may additionally be formed on the surface of the color filter 371 and OLED cells 311 and serves as a protective and planarization layer. The resulting surface of the fingerprint sensor 370 is then coated with a first protective layer 502. In this embodiment, the first protective layer 502 is a substantially transparent conductive material, such as indium-tin-oxide adapted to protect the fingerprint sensor 370 from damage due to electrostatic discharge in a manner that will be described in greater detail below.

Rendering of the fingertip 40 is accomplished by illuminating at least one of the OLED cells 311 so as to direct OLED light 303 towards the fingertip 40. Reflected light 335 is then redirected into the fingerprint sensor 370 where the color filter 371 permits the selective illumination of the underlying photodetector 324. In one aspect, each color filter 371 is matched to the color of the OLED cell 311 to which it is adjacently positioned to permit transmission of the reflected light 335 produced by the corresponding OLED cell 311. Reflected light 334 comprising light of an undesirable wavelength or color are excluded by the color filter 371 and prevented from triggering the underlying photodetector 324.

One advantage obtained by using this configuration of OLED fingerprint sensor 370 is that the fingertip 40 can be simultaneously illuminated with more than one color or wavelength of light 373. Each color or wavelength of light 373 can then be used to resolve an independent image of the fingertip 40 and the results combined by the controller 490 to yield an improved image or rending of the fingertip 40. The use of integrated color filters 371 additionally prevents undesirable ambient or reflected light from triggering the photodetector 324 without blocking the desirable color or wavelength of light 373 produced by the OLED cells 311.

Thus, the aforementioned OLED fingerprint sensor 370 may be integrated into a display apparatus or monitor without affecting the quality or tint of a displayed image while simultaneously providing a method for selecting optimized color or wavelength of light 373 to be used in resolving the fingerprint. Additionally, the OLED fingerprint sensor 370 may be manufactured with a thickness between approximately 2.0 μm and 3.0 μm thus making it highly suitable for integration into electronic devices where size and weight are a significant consideration.

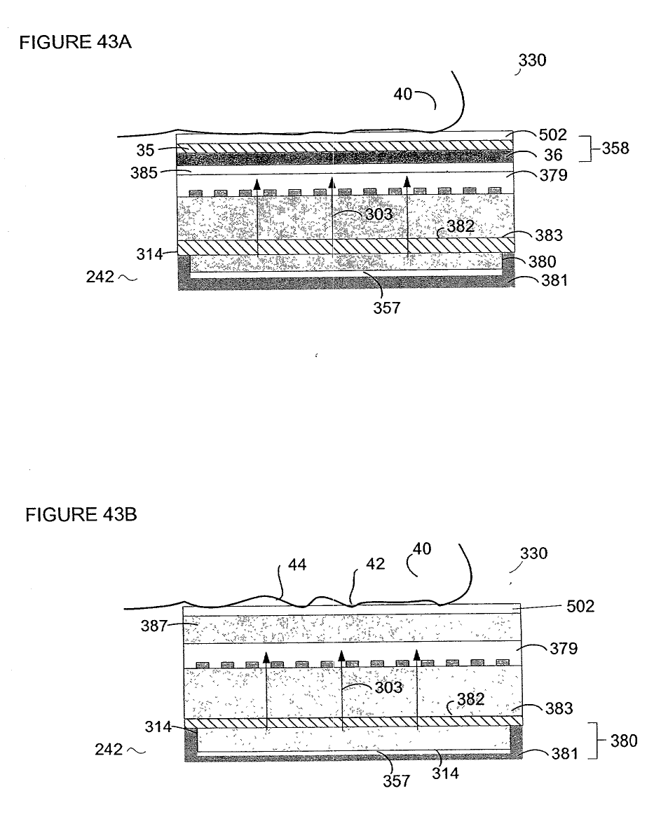

FIGS. 43A-B illustrate the OLED fingerprint sensor 330 comprising an OLED emitting layer 380. As shown in FIG. 43A, the OLED emitting layer 380 is formed on a sealant layer 381 which serves as a protective or insulating base for the fingerprint sensor 330. The OLED emitting layer 380 further comprises a plurality of functional layers which are arranged, as previously discussed, to inject electrical charges into the organic polymer layer 314 so as to induce light emissions in the form of electroluminescence.

In one aspect, the sealant layer 381 may be desirably formed from a rigid material such as glass, metal, or plastic with a thickness between approximately 0.3 mm and 1.1 mm. In applications where the overall thickness of the fingerprint sensor 380 is desirably minimized, a thin film of Vitex® may be used to form the sealant layer 381 wherein the Vitex® film forms a layer of approximately 1 micrometer.

A conductive layer 357 comprising aluminum, lithium fluoride or other suitable metal or metal alloy is interposed between the OLED emitting layer 380 and the sealant layer 381 and forms a first of the two electrode layers through which a voltage may be applied to induce the OLED emitting layer 380 to luminesce. In one embodiment, the second electrode comprises a transparent conductive oxide 382 which in this embodiment comprises a layer of indium tin oxide formed on the opposing side of the OLED emitting layer 380.

A substantially transparent substrate layer 383 is further formed on the surface of the transparent conductive oxide 382 to transmit emitted OLED light 303 towards the fingertip 40. The substrate layer 383 additionally serves a base for an upper sensor layer comprising one of the aforementioned fingerprint sensing layer 379, such as the active matrix sensor array or LCD sensor array. The sensor layer 379 is positioned in close proximity to the surface of the fingerprint sensor 330 to capture light reflected from the fingertip 40 and render the fingerprint image as discussed in previous sections.

As with other embodiments of the fingerprint sensor, upper protective layers 358 may be formed on the surface of the sensor layer 379 to provide necessary planarization and protection of the underlying sensor layer 379. These upper protective layers 358 comprise the first protective layer 502, the hardcoat layer 35, and a top-coat layer 36. Additionally, a color filter 385 may be interposed between these layers 502, 35, 36 to selectively permit light of a particular color or wavelength to enter the fingerprint sensor 330. The color filter 385 also permits the emitted OLED light 303 of the OLED emitting layer 380 to be transmitted through the fingerprint sensor 330 to improve the illumination of the fingertip 40.

FIG. 43B illustrates the OLED fingerprint sensor 330 with the integrated OLED backlight 242 wherein the upper protective layers 358 comprising the hardcoat layer 35, topcoat layer 36, first protective layer 502, and color filter 383 are desirably formed from a single multifunctional or composite layer 387 to serve substantially the same purpose as the aforementioned individual layers 502, 35, 36, and 383. The composite layer 387 in this embodiment simplifies the manufacturing steps required to produce the fingerprint sensor 330 and may advantageously require less material with a reduced overall thickness.

In one aspect, the overall thickness of the fingerprint sensor 330 is less than 2.1 millimeters with the composite layer 387 having a thickness of approximately 7 micrometers, the substrate surface having a thickness of approximately 1.1 millimeters and the backlight apparatus 242 having a thickness of approximately 0.5 micrometers. These relatively small dimensioned requirements contribute to the increased flexibility in integrating the fingerprint sensor 330 into electronic devices without unduly increasing the overall size of the device to accommodate the fingerprint sensor 330.

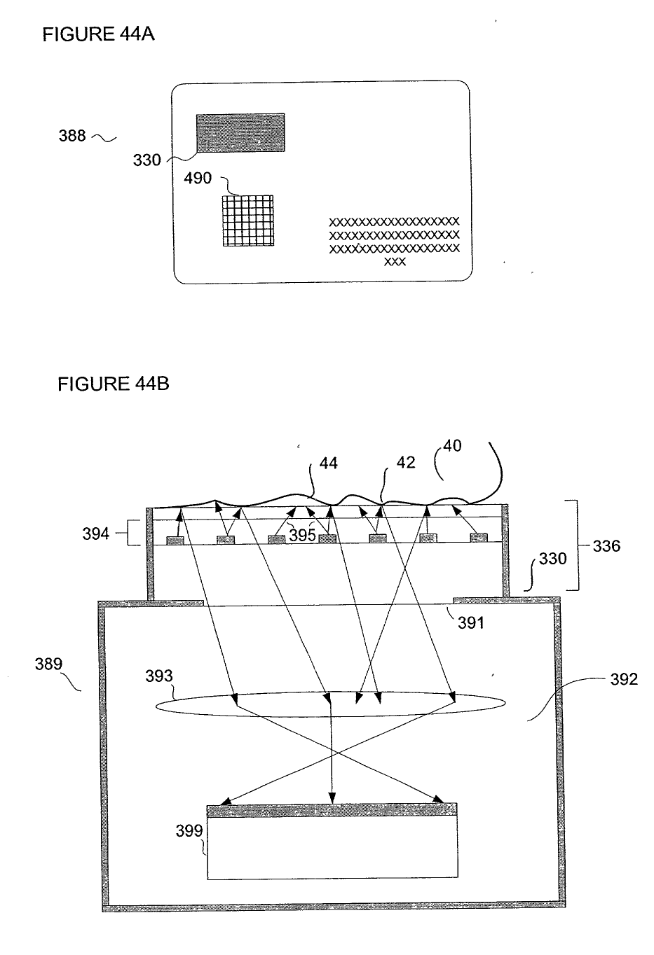

FIG. 44A-B illustrates another application of the OLED fingerprint sensor device 330 wherein an identification card 388 contains an embedded fingerprint sensor 330 and controller 490. The identification card 388 is desirably used in conjunction with an imaging device 389 (FIG. 44B) wherein the identification card 388 is placed on a receiving face 390 of the imaging device 389. The imaging device 389 contains an opening 391 which is positioned under the fingerprint sensor 330 when the identification card 388 is properly positioned over the imaging device 389 so as to permit light to enter an interior compartment 392 of the imaging device 389.

During operation of the imaging device 389 the fingertip 40 is placed in contact with the embedded fingerprint sensor 330 on the identification card 388 and a pixilated OLED layer 394 generates light 395 which is directed towards the fingertip 40. As described in previous sections, at least a portion of the light 395 is reflected by the ridges 42 and/or valleys 44 of the fingertip 40 back into the sensor 330. The reflected light 395 passes through substantially transparent layers 396 of the identification card 388 and enters the interior compartment 392 of the imaging device 389.

Within the imaging device 389, a lens assembly 393 is positioned so as to direct and/or focus at least a portion of the light 395 onto an imager 399 such as a charge-coupled device (CCD) imager or Complementary Metal-Oxide-Silicon (CMOS) imager. The imager 399 captures the light 395 to reconstruct an image of the fingertip 40 and subsequently uses this information for verification of the identity of the individual whose fingertip 40 has been placed on imaging device 389.

In one aspect, the lens assembly 393 may further comprise a color filter to block undesirable reflected light of an inappropriate wavelength, reduce ambient light entering the imager, or to improve the quality and contrast of the image of the fingertip 40 to be rendered by the imager 399. It will be further appreciated that other components may be used in conjunction with, or substituted for, the lens apparatus 393 such as a polarizing filter, a diffraction grating, other components which can be used to improve the quality and resolution of the resulting fingerprint.

FIG. 45 illustrates a laptop-computing device 400, wherein an optical image sensor system is employed for user identification and verification by fingerprint detection, capture, and analysis. The optical image 'sensor system, in one embodiment as a fingerprint sensor, may be integrated into a non-display area 401, such as a touchpad or a pointing device, a viewing display area 402, or a housing area 403 of the computing device 400. The non-display area 401 may be modified to comprise a dual functionality, wherein, in one embodiment, a first function comprises a fingerprint image sensor for user identification and verification and a second function comprises a touch sensitive pointing device. It will be appreciated by one of skill in the art that any of the sensors 10, 200, 300, 330, 370 previously described can be adapted to cooperate with the devices 331, 400, 410 as well as the sensors 420, 450, 468, and 500 to be described in greater detail below without detracting from the spirit of the present invention.

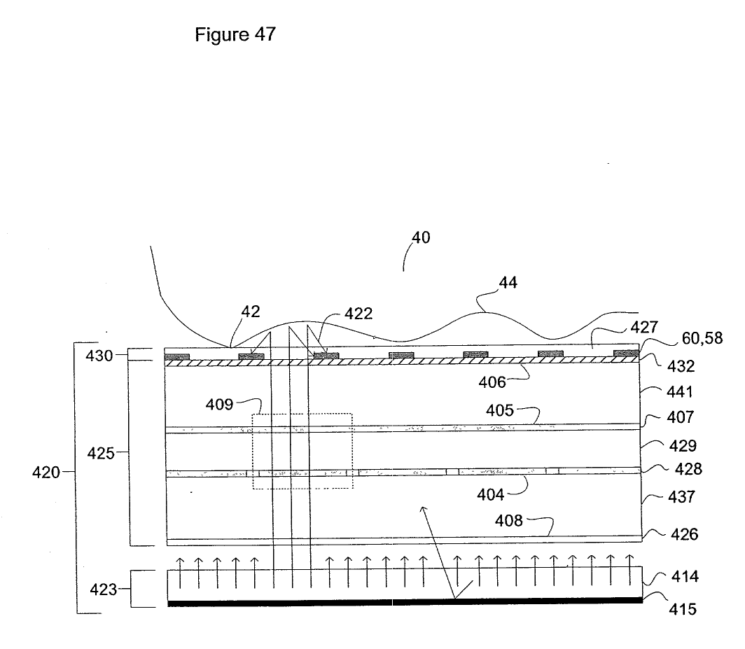

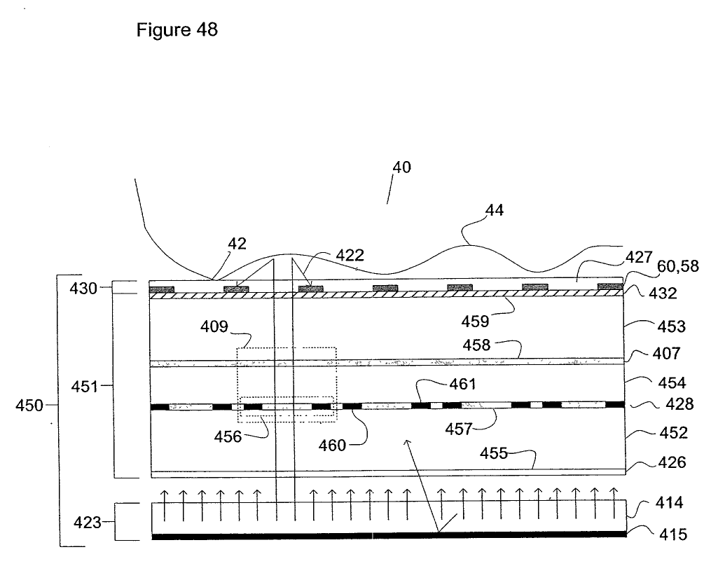

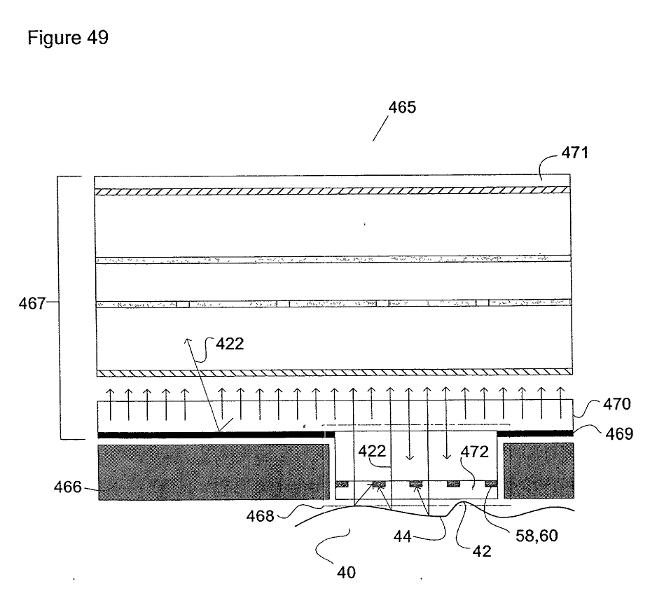

For example, in a normal operation embodiment, the non-display area 401 may function as a conventional pressure sensitive pointing device controller, but to login or gain access to the computing device 400, the non-display area 401 may function as an optical fingerprint sensor for user identification and verification. In which case, a transparent layer may replace the conventional upper opaque layer of the non-display area 401 for the optical image sensing of a fingerprint. The viewing display area 402 utilizes imaging techniques further discussed below with reference to FIGS. 47 and 48. Furthermore, the fingerprint sensor integration and application into the housing area 403 also utilizes imaging techniques further discussed below with reference to FIG. 49.

The benefit to integrating a fingerprint sensor into the computing device 400 is that the overall reduced bulk of the computing device 400 increases convenience and manageability of the computing device 400. In portable situations, the overall size and weight of the computing device 400 is a concern, which deters the employment of a discrete fingerprint sensor. With the application of an integrated fingerprint sensor, it may be appreciated that the need of an external connection port for the attachment of a fingerprint sensor is reduced and is no longer required by the sensor, which increases the user identification and verification procedural efficiency and convenience thereof.

In FIG. 46, an optical image sensor system, in one alternative embodiment, may be integrated into a Personal Digital Assistant (PDA) device 410. The placement of the optical image sensor system, in various embodiments, may be integrated into a non-display area 411, a display apparatus area 412, or the display casing area 413 of the PDA device 410. The non-display area 411 refers to a stylus sensitive region that can be modified to comprise a dual functionality, wherein, in one embodiment, a first function comprises an optical fingerprint image sensor for user identification and verification, and a second function comprises a stylus sensor. The display apparatus area 412 utilizes imaging techniques further discussed below in FIGS. 47 and 48. The fingerprint sensor integration and application into the display housing area 413 also utilizes imaging techniques further discussed below in FIG. 49.

Handheld computing devices and sub-compact electronic devices exemplify convenience and portability. The “ease of use” concept is inherent to the marketability of such small personal electronic computing devices. Many of these devices do not have peripheral connection ports for the attachment of external devices, such as a discrete fingerprint sensor. From this conceptualization, it may be appreciated that an integrated fingerprint sensor into the small personal electronic device would better serve the user, wherein portability, flexibility, convenience, and manageability are of high concern. The assimilation of an embedded fingerprint image sensor into the PDA 410 would seek to maintain the inherent value and nature of the small PDA 410 by preserving the size, weight, and portability of the PDA 410.

Many electronic computing devices, including personal devices or otherwise, integrate liquid crystal display imaging for viewing digital information. As is known in the art, many LCD devices comprise an array of microscopic partitions (pixels), preferably rectangular in form, wherein information is displayed through the internal manipulation of externally reflected or projected light. The liquid crystals themselves are typically classified as non-emissive display elements that generally do not generate their own light, but, alternatively, an LCD apparatus either passes or blocks reflected or projected light that is emitted from an external lighting source, wherein the reflected or projected light is supplied by a back or side active lighting source. LCD devices that are generally projective in nature tend to employ an active lighting source to illuminate and display electronic or digital information to a user via a display apparatus.

FIG. 47, illustrates one embodiment of fingerprint sensor system 420 integrated into a passive matrix liquid crystal display (LCD) 425, wherein the image sensed is a fingerprint. The fingerprint sensor system 420, in one embodiment, comprises a relief object sense layer 430, the passive matrix LCD 425, and an active back light source 423, wherein the sense layer 430 is formed on the upper surface of the LCD 425.

The relief object sense layer 430 of the fingerprint sensor system 420, in one embodiment, comprises an array 58 of light-sensing optical detectors 60 encapsulated in a transparent glass substrate 427 material, wherein the relief object sense layer 430 is formed on the upper surface of LCD 425. In one embodiment, the glass substrate 427 has an index of refraction close to that of a fingertip 40. In addition, the optical detectors 60 are spaced approximately between 50 and 60 μm apart to permit sufficient light to pass between adjacent optical detectors 60. The optical detectors 60, may be formed of a semiconductor based materials in the manners previously described.

When the fingertip 40 is placed onto the upper surface of the relief object sense layer 430, the ridges 42 are in contact with the upper surface of the relief object sense layer 430, while the valleys 44 form air-filled pockets or regions above the relief object sense layer 430. By illuminating the fingertip 40 and positioning an array of optical detectors 60 within the substrate layer 427, light 422 is able to pass between the fingertip 40 and the relief object sense layer 430 and is then reflected from the air filled valleys 44 and projected onto the array 58 of optical detectors 60. In this way, the ridges 42 can be visually distinguished from the valleys 44 to form an optical image of the fingertip 40. Thus, an optical image of the fingertip 40, in one embodiment, can be sensed, captured, and rendered electronically for future use, such as user identification and verification.

Integrating the fingerprint sensor system 420 into an LCD 425 offers many benefits to the user including convenience and ease of access to the fingerprint sensor system 420. An embedded fingerprint sensor system 420 integrated into the substrate layer 427 provides a surface for placement of the user's fingertip 40. In addition, the backlight apparatus 423 provides ample light for fingerprint detection, and the user does not have to worry about attaching a discrete fingerprint sensor device to a peripheral port. Thus, the integrated fingerprint sensor system 420 increases overall efficiency, convenience, and manageability of a personal electronic device equipped therewith.

In one aspect, the passive matrix LCD 425 comprises an incoming glass substrate layer 437 and an outgoing glass substrate layer 441 with a liquid crystal element layer 429 interposed between the two surface treated transparent glass substrate layers, 437 and 441. The two glass substrate layers, 437 and 441, are approximately 1100 microns thick, and the liquid crystal element layer is approximately 5 microns thick. The functionality of liquid crystals and the passive matrix LCD 425 will be further discussed below.

The incoming glass substrate layer 437 further comprises a polarized filter layer 426 formed on a first surface 408 of the substrate 437 and a first series of contiguous electrode traces 428 patterned and etched, in a manner well known in the art, into a series of rows formed on a second surface 404 of the substrate 437. The polarized filter layers 426 are approximately 60 um thick, and are usually formed of iodine material in a manner known in the art.

A voltage applied to the electrode traces 428 induces an electrical field across the liquid crystal element 429, which enables or disables the ability of reflected or projected light to internally traverse the liquid crystal element 429. The electrode traces 428, in one embodiment, are formed of Indium Tin Oxide (ITO), which is a transparent conductive material, wherein the electrode layer is approximately 0.15 microns thick, and are formed by a sputter deposition technique known in the art. Furthermore, the electrode traces 428 are patterned to form the rows and columns of a passive matrix display or the individual pixels of an active matrix display. The active matrix display embodiment will be further discussed herein below.

The polarized filter layers 426 is preferably polarized in a first fixed direction, whereby light can only pass through if it is oriented in the same first fixed direction of the polarized filter layers 426. Conversely, the orientation of the second direction is preferably a 90-degree rotational offset of the orientation of the first direction. The orthogonal polarized filters, 426 and 432, act as a medium that only passes light if the plane of the light is oriented in a specific pre-determined direction, wherein incoming light is oriented in a first direction and outgoing light is oriented in a second direction.

As is known in the art, liquid crystals exhibit properties of a liquid, defined by the ability of molecules to freely move about within a material, and the properties of a solid, defined by the ability of molecules within a material to orient in one common direction. In one embodiment, nematic liquid crystals exhibit this phenomenon with a definite molecular order or pattern, whereby liquid crystal molecules are oriented in distinct parallel lines. As a result, exemplary ordered liquid crystal molecules, known as Twisted Nematic (TN) liquid crystals, are capable of performing a highly uniform twist in the absence of an electric field. Conversely, in the presence of an electric field, TN liquid crystal molecules untwist causing polarized light passing through the untwisted liquid crystal molecules to substantially diffuse most of the incoming light, which produces a darkened pixel image. Therefore, an exemplary type of LCD device is the Twisted Nematic display, wherein the TN display comprises a nematic liquid crystal element interposed between two transparent glass substrate layers.

For example, the absence of an applied electric field across a liquid crystal element causes the liquid crystal molecules to twist which rotates the incoming plane of light 90-degrees, wherein the outgoing rotated plane of light can pass through the plane of the second polarized filter. Conversely, in the presence of an electric field, the liquid crystal molecules untwist, which results in an un-rotated incoming plane of light, wherein an un-rotated outgoing plane of light diffuses and cannot fully penetrate the plane of the second polarized filter.

The outgoing glass substrate layer 441 comprises a second series of contiguous electrode traces 407 patterned and etched, in a manner well known in the art, into a series of columns, orthogonal to the electrode rows , formed on a first surface 405 of the substrate 441 and a second polarized filter layer 432 formed on a second surface 406 of the substrate 441. The electrode trace layers, 407 and 428, are approximately 0.15 microns thick, and are formed by a deposition technique in a manner known in the art. The second polarized filter layer 432 is preferably polarized in a second fixed direction, which is orthogonal to the first fixed direction of the polarized filter layer 426, wherein light can only pass through if it is oriented in the same second fixed direction of the polarized filter layer 432.

When, in one embodiment, the two glass substrates, 437 and 441, are assembled into the LCD 425, the orthogonal intersection of electrode traces 428 and 407 forms a pixel 409, whereby the pixel 409 is addressed by the electrode traces 428 and 407. For example, in one embodiment, when a pulse is sent down one electrode trace 407 and the corresponding addressed electrode trace 428 is grounded, the induced electric field across the pixel 409 can alter the visual appearance of the liquid crystal element 429, which is referenced by the specifically addressed pixel 409. The resultant electric field across a liquid crystal element 429 rotates the polarized plane of light from an active light source 414, which alters the visual appearance of the addressed pixel 409. In addition, if the pixel 409 is not addressed, then the visual appearance of the pixel 409 remains unaltered. By addressing and non-addressing multiple pixels 409 at one time, a preferred image can be visualized on the LCD 425.

The back light apparatus 423 is formed, in various embodiments, with an array of tightly packed LEDs, multiple fluorescent tubes, or an array of miniature light bulbs in a manner known in the art. The back light apparatus 423 provides the LCD 425 and the sense layer 430 with a constant projection of light 422, wherein the intensity of the light 422 is sufficient for proper LCD 425 and fingerprint sensor system 420 functionality. The back light apparatus 423 comprises the active light source 414 and a back light reflector 415, wherein the light 422 is substantially projected towards the LCD device 425. The back light reflector 415, in one embodiment, comprises a material with a known reflective coating, whereby the back light reflector 415 substantially redirects any diverging light 422 from the back light apparatus 423 towards the LCD device 425.

For proper functionality, it is desired to reduce external ambient light from impinging upon the optical detectors 60 by completely covering the active optical image sense region with fingertip 40. Ambient light can have the effect of reducing the contrast resolution between the ridges 42 and the valleys 44 of the fingerprint image by providing unwanted conduits for light encroaching onto the optical detectors 60. Moreover, during the fingerprint image capture mode, the LCD device 425 must allow the light 422 to pass through for image reflection of the ridges 42 and the valleys 44 of the fingertip 40. As a result, an electric field should not be present across the LCD device 425 during the fingerprint image capture mode due to the diffusion of light 422 when an electric field is applied across the LCD device 425.

FIG. 48 illustrates another embodiment of a fingerprint sensor system 450 integrated into an active matrix LCD 451, wherein the image sensed is a fingerprint. The fingerprint sensor system 450, in one embodiment, comprises the relief object sense layer 430, the active matrix LCD 451, and the active back light 423, wherein the relief object sense layer 430 is formed on the upper surface of the active matrix LCD 451. The relief object sense layer 430 of the fingerprint sensor system 450, in this embodiment, is utilized in the same manner as in the fingerprint sensor system 420 as previously described. The active back light 423 provides the active matrix LCD 451 and the sense layer 430 with a constant projection of light 422, wherein the operation and formation are incorporated in the same manner as in the fingerprint sensor system 420.

In one aspect, the active matrix LCD 451 comprises an incoming glass substrate layer 452 and an outgoing glass substrate layer 453 with the liquid crystal element layer 454 interposed between the two glass substrate layers, 452 and 453. The two glass substrate layers, 452 and 453, are approximately 1100 microns thick, and the liquid crystal element layer 454 is approximately 5 microns thick. The functionality of the active matrix LCD 451 will be further discussed below.

The incoming glass substrate layer 452 comprises the polarized filter layer 426 formed on a first surface 455 of the substrate 452 and the electrode trace 428 patterned and etched, in a manner well known in the art, into an array of individual partitions 456 formed on a second surface 457 of the substrate 452. The polarized filter layer 426 is preferably polarized in a first fixed direction, whereby light 422 can only pass through if the light 422 is oriented in the same first fixed direction of the polarized filter layer 426.

The outgoing glass substrate layer 453 comprises the electrode trace 407 formed on a first surface 458 of the substrate 453 and a second polarized filter layer 432 formed on a second surface 459 of the substrate 453. The electrode trace layers, 428 and 407, are approximately 0.15 microns thick. The second polarized filter layer 432 is preferably polarized in a second fixed direction, which is orthogonal to the first fixed direction of the first polarized layer 426, wherein light 422 can only pass through if it is oriented in the same second fixed direction of the polarized filter layer 432.

When, in this embodiment, the two glass substrates, 452 and 453, are assembled into the active LCD 451, the intersection of the electrode trace 426 and the patterned electrode partition 456 forms a pixel 409. Individual electrode partitions 456 comprise a hydrogenated amorphous silicon (a-Si:H) type Thin Film Transistor (TFT) 460 that indirectly addresses individual pixels 409, wherein the a-Si:H TFT 460 characterizes a pixel switch. The a-Si:H TFT 460 devices are formed by a sputtering deposition technique in a manner known in the art. The pixel 409 is addressed by applying a current to the a-Si:H TFT 460 gate terminal, which switches the a-Si:H TFT 460 “on” and permits a charge to transfer from the a-Si:H TFT 460 source terminal onto the electrode partition 456. The resultant electric field across the liquid crystal element layer 454 rotates the plane of light from the light source 414, which alters the visual appearance of the addressed pixel 409. Once the pixel 409 has been addressed, the a-Si:H TFT 460 gate terminal is reversed biased to insure that no charge can pass into an adjacent pixel 409.

By addressing multiple pixels 409 at one time, a preferred image can be visualized on the active LCD 451. To insure proper charge storage for a single display cycle and to carefully control the charge state of the pixel 409, electrode partition 456 incorporates a capacitor 461 in conjunction with the TFT 460, wherein the capacitor 461 provides a continuous refresh of charge to the TFT 460. Thus, the pixel 409 warrants the ability to provide a continuous visual appearance. Conversely, if TFT 460 is switched “off” by not applying a current to the TFT 460 gate terminal, then the visual appearance of the addressed pixel 409 remains unaltered. By addressing and non-addressing multiple pixel 409 at one time, a preferred image can be visualized on the active LCD 451.

Liquid crystal displays employ a light source, such as the lighting apparatus 423 represented in FIGS. 47, 48, and 49. Liquid crystal displays can utilize an ambient lighting source and further employ a reflective surface mounted behind the LCD device. Reflective displays have limited brightness capabilities due to the fact that light passes through multiple polarized filter layers, which significantly diminishes the overall intensity of the reflected light. An exemplary method for providing light to both passive and active LCD devices is through an active projected lighting source.

A back or side projected lighting system reliably increases overall light intensity to the LCD device, wherein the light source, mounted behind or at the edges of the LCD device, reduces the need for reflected ambient light. Active matrix displays commonly utilize back or side lighting systems to increase light intensity, and, in most cases, passive matrix displays also incorporate back and side lighting systems to improve overall light intensity. Moreover, the array of photo-detectors 60 in the relief object sense layer 430 reduces the intensity of light seen by the user, wherein the appearance comprises a reduced brightness over the optical image sensor system region. To combat this potential problem, the light source should project a higher intensity of light 422 through the optical image sensor system region, which results in a balanced visual appearance for the user over the entire viewing display area of the display apparatus.

FIG. 49 illustrates a cross-sectional view of an LCD system 465, wherein the LCD system 465 comprises an electronic device housing substrate 466, an LCD 467, and a fingerprint sensor 468.

The LCD 467 comprises a back light reflector 469, an active back lighting source 470, and a transparent protective screen 471, wherein the LCD 467 is attached to the housing substrate 466. The active back lighting source 470 emits and provides light 422 to the LCD 467, and, in addition, the back light reflector 469 reflects light 422 from the active back lighting source 470 and any external ambient light towards the LCD 467. The fingerprint sensor 468 is embedded and integrated into the housing substrate 466, wherein the back light reflector 469 does not prevent the active back lighting source 470 from emitting and providing light 422 to the fingerprint sensor 468. Furthermore, the active back lighting source 470 simultaneously emits and provides light 422 to the LCD 467 and to the fingerprint sensor 468.

The fingerprint sensor 468, in one embodiment, comprises the array 58 of optical detectors 60 encapsulated in a transparent glass substrate 472, wherein the fingerprint sensor 468 is formed on the active back lighting source 470 and embedded and integrated into the housing substrate 466. In one embodiment, the glass substrate 472 material has an index of refraction close to that of a fingertip 40.

When the fingertip 40 is placed onto the glass substrate 472, the fingertip ridges 42 are in contact with the glass substrate 472, while the fingerprint valleys 44 form air-filled pockets or regions above the substrate 472. By illuminating the fingertip 40 and positioning an array of optical detectors 60 within the glass substrate 472, the light 422 is able to pass between the fingertip 40 and the glass substrate 472 and is then reflected from the air filled valleys 44 and projected onto the array 58 of optical detectors. In this way, the ridges 42 can be visually distinguished from the valleys 44 to form an optical image of the fingertip 40. Thus, an optical image of the fingertip 40 can be detected, captured, and saved for future use, such as user identification and verification.

The advantage to integrating an embedded fingerprint image sensor into the housing substrate of an electronic device is that the overall reduced bulk of a portable electronic device increases overall flexibility, convenience, and manageability of the portable electronic device. In portable situations, the overall size and weight of the personal electronic device is a concern, which deters the employment of a discrete, standalone fingerprint sensor device. In addition, with the application of an integrated fingerprint sensor into a personal computing electronic device, it may be appreciated that the need of an external connection port for the attachment of a fingerprint sensor is significantly diminished. Therefore, the fingerprint image sensor no longer requires an external peripheral connection port, and, as a result, the user identification and verification procedural efficiency and convenience are considerably increased.

For proper functionality, it is desired to reduce external ambient light from impinging the optical detectors 60 by completely covering the active optical image sense region with the fingertip 40. Ambient light can have the effect of reducing the contrast resolution between the ridges 42 and the valleys 44 of the fingerprint image by providing unwanted conduits for light encroaching onto the optical detectors 60.

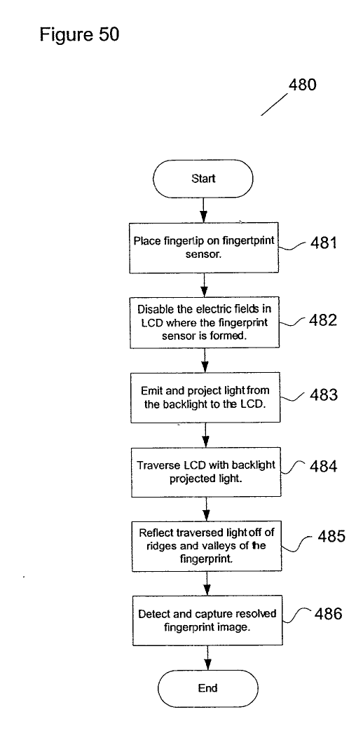

FIG. 50 schematically illustrates, in one embodiment, a functional procedure 480 for the fingerprint sensor system 420 and 450, whereby the fingerprint comprises a pattern of the ridges 42 and the valleys 44 of the fingertip 40 of a user. The functional procedure 480 begins with the procedural block 481, wherein the fingertip 40 is placed on the relief object sense layer 430 of the fingerprint sensor 420 and 450. The ridges 42 of the fingertip 40 make contact with the upper surface of the sense layer 430, and the valleys 44 of the fingertip 40 do not make contact with the upper surface of the sense layer 430. In various embodiments, finger print sensor 420 and 450 define an active area 402, whereby the fingertip 40 is positioned over the active area 402 defined by the placement of the finger print sensor 420 and 450.

In procedural block 482, the next step is to disable the electric fields in the LCD 425 and 451 where the fingerprint sensor is formed. Disabling the electric field across the LCD 524, 451 allows light 422 to traverse through the LCD 425, 451.

In procedural block 483, an active back light source 470 projects the light 422, which is emitted and projected towards the LCD device 425 and 615. Any diverging light 721 is reflected from the reflector 613 towards the LCD 425, 451.

In procedural block 484, the projected light 422 from the back light source 470 and the reflector 469 traverses the LCD 425, 451, whereby traversed light 422 illuminates the fingertip 40 placed on the upper surface of the sense layer 430. At this time, an electric field applied across the liquid crystal element layers, 429., would inhibit traversing light 422 from penetrating the LCD 425, 451 and reaching the fingertip 40.

In procedural block 485, traversed light 422 is reflected off of the ridges 42 and the valleys 44 of the fingertip 40. In one embodiment, the glass substrate material 430 has an index of refraction close to that of a fingertip 40. By illuminating the fingertip 40 and positioning an array of optical detectors 60 within the substrate layer 427, the light 422 is able to pass between the fingertip 40 and the substrate 430 and is then reflected from the air filled valleys and projected onto the array 58 of optical detectors 60.

In procedural block 485, the reflected light is detected by the array 58 of optical detectors 60, and the resolved fingerprint image is captured for user identification and verification. Once the fingerprint image is captured, the functional procedure ends.

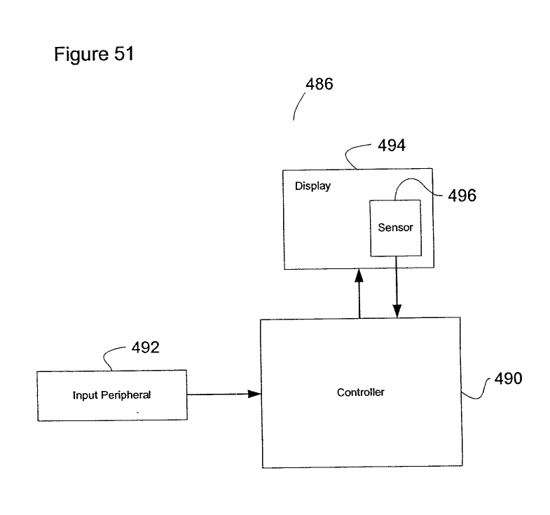

FIG. 51 schematically illustrates a personal electronic device 486, which, in one embodiment, comprises a controller 490, an input peripheral device 492, a display apparatus 494, and a fingerprint sensor 496 integrated into the display apparatus 494. The input device 486 permits a user to input information. The display apparatus 494 projects light from a back or side lighting apparatus and provides a method for displaying electronic images on the viewing area of the display apparatus. The controller 490 receives electronic signals from the input device 492 and provides signals to the display 494. The controller 490 also receives electronic signals from the fingerprint sensor 496. The fingerprint sensor 496 is integrated into the display device 494 such that light projected from the display is reflected off of a fingertip, which is positioned on the fingerprint sensor 496 surface, and captured by the fingerprint sensor 496. The fingerprint sensor 496 sends signals to the controller indicative of the optical image captured by the fingerprint sensor 496, wherein the fingerprint image sensed is an electronic representation of the fingerprint.

When utilizing an integrated fingerprint sensor, in various personal electronic devices, it may be appreciated that increased flexibility and manageability of the personal electronic device is achieved, whereby an increased sense of workspace organization results from the assimilation of an integrated fingerprint sensor into an electronic device. Discrete standalone fingerprint sensors can be cumbersome, but an integrated fingerprint sensor increases convenience by reducing the need for exchanging external connection ports for the use of a fingerprint image sensor device. Furthermore, integrated fingerprint sensors preserve portability, size, and weight of the personal electronic device, whereby the footprint of the device as a whole is maintained. As a result, it may be appreciated that an integrated fingerprint sensor satisfies the needs of a user by increasing the flexibility, manageability, convenience, and portability of the personal electronic device.

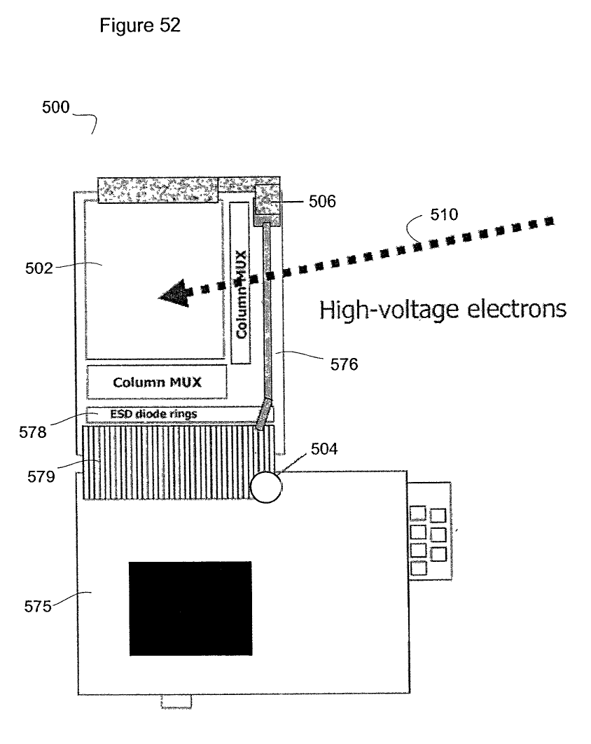

FIG. 52 is a top view of a fingerprint sensor 500 comprising a first protective layer 502 adapted for protecting the fingerprint sensor 500 against electrostatic discharge (ESD) and for improving the resolution of the fingerprint sensor 500 in a manner that will be described in greater detail below. The fingerprint sensor 500 senses, renders, and validates fingerprint patterns placed adjacent the fingerprint sensor 500 in the manner previously described with respect to the fingerprint sensors 10, 200, 300, 330, 370, 420, 450, 468.

In this embodiment, the fingerprint sensor 500 is embodied as a separate assembly, such as a PCMCIA card as previously described and attached to a system 575, such as a PDA, laptop computer, and the like. However, it will be appreciated by one of skill in the art that the inventive features of the finger print sensor 500 as described in this embodiment can also be adapted for use with the fingerprint sensors 10, 200, 300, 330, 370, 420, 450, 468 as previously described without departing from the spirit of the invention.

The first protective layer 502 of this embodiment is an electrically conductive, optically transparent material. In one embodiment, the first protective layer 502 comprises a layer of indium-tin oxide (ITO) with a composition of approximately 90% In₂O₃ and 10% SnO₂. The first protective layer 502 is applied with a known sputtering technique to a thickness of approximately 1500 Å. In this embodiment, the SnO₂ component of the first protective layer 502 acts as an n-type dopant providing donor carriers to improve the electrical conductivity of the first protective layer 502.

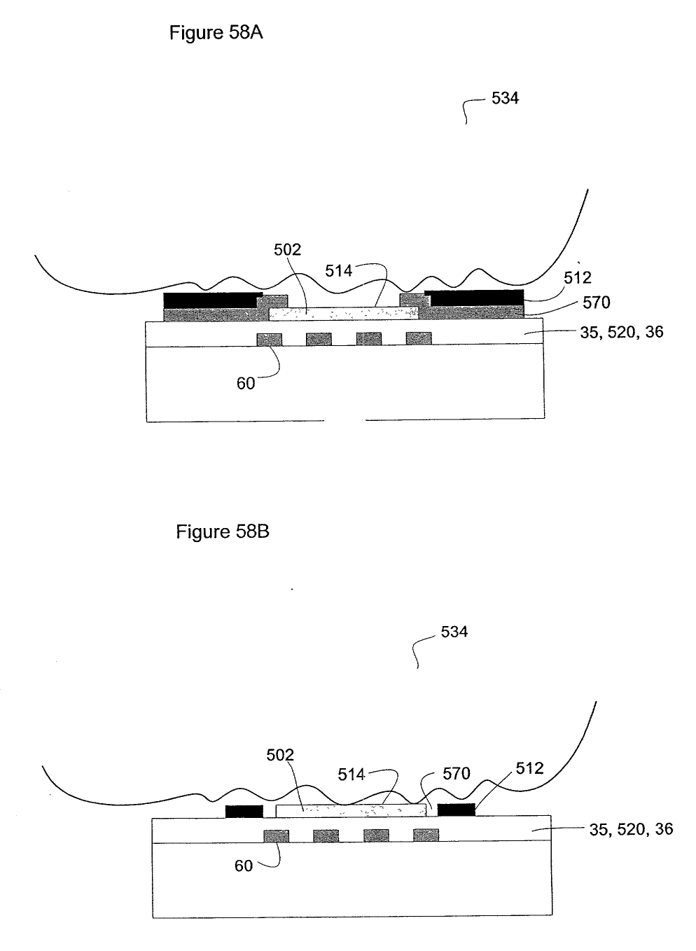

In one embodiment, the hardcoat layer 35 is interposed between the first protective layer 502 and underlying optical detectors 60 so as to form a second protective layer 520 (FIGS. 58A and 58B). The second protective layer 520, comprising the hardcoat layer 35, protects underlying structures, including the optical detectors 60, from damage due to physical contact such as scratching, erosion, etc. In alternative embodiments, the second protective layer 520 comprises the top-coat layer 36. In another embodiment, the second protective hardcoat layer 520 is placed over the first protective layer 502 to improve the resistance of the finger print sensor 500 to physical contact damage.

The first protective layer 502 is electrically connected to an analog circuit ground 504 via a planar conductor 506. The analog circuit ground 504 provides a circuit reference node in a known manner. The planar conductor 506 of this embodiment is a paint or tracing of Silver (Ag) approximately 50 μm thick and 1 mm wide deposited on a substrate 576 with a conductive trace deposition, sputtering, soldering, wire-bonding, or other known method of forming conductive structures. The planar conductor 506 has the advantage of being low profile and minimally affecting the overall planarity of the fingerprint sensor 500, thereby maintaining optimal convenience for the user. The planar nature of the fingerprint sensor 500 also facilitates integration of the fingerprint sensor 500 into other devices as previously described with respect to the fingerprint sensors 10, 200, 300, 330, 370, 420, 450, 468.

A user of the fingerprint sensor 500 typically carries at least some electrostatic charge 510 in their body and clothing. The electrostatic charge 510 can be of either positive or negative polarity and can have a kilovolt potential. As the user touches the fingerprint sensor 500, the potential of the electrostatic charge 510 contained in the user's finger can be different than the potential of the fingerprint sensor 500. The potential difference will tend to equalize by a discharge of the electrostatic charge 510 with the direction of current flow depending on the particular potential difference according to known electrical principles.

Current induced by the electrostatic charge 510 will be distributed throughout the first protective layer 502 and will further flow from or to the analog circuit ground 504 depending on the direction of potential difference. Thus, the electrostatic charge 510 carried by the user will be shunted to the analog circuit ground 504 through the first protective layer 502 and the planar conductor 506 so as to equalize potential difference therebetween. As the first protective layer 502 overlies and is electrically isolated from the optical detectors 60 (FIGS. 58A and 58B), the electrostatic charge 510 is inhibited from discharging through the optical detectors 60, thereby minimizing the potential for damage to the optical detectors 60 due to ESD.

The fingerprint sensor 500 also comprises a plurality of diode rings 578. The diode rings 578 are in electrical communication with a connector 579. The connector 579 interconnects the fingerprint sensor 500 and the system 575 in a known manner. The diode rings are adapted to shunt ESD that may be picked up on the conductors of the connector 579 to the analog ground 504.

An additional advantage of the fingerprint sensor 500 of this embodiment is that shunting the electrostatic charge 510 in the manner previously described also helps to maintain image resolution. In particular, if the electrostatic charge 510 were not shunted away from the optical detectors 60, the discharge of the electrostatic charge 510 could create false signals to be read from individual optical detectors 60. The individual optical detectors 60 could unintentionally interpret localized ESD as impinging light reflected from the fingertip 40. Thus, the fingerprint sensor 500 could mistakenly interpret ESD as light reflected off of ridges 42 and valleys 44 of a user's fingertip 40 thereby corrupting the data and reducing the accuracy of the fingerprint sensor 500. The invention of this embodiment offers the particular advantage of offering protection both from damage from discharge of the electrostatic charge 510 as well as maintaining the resolution of the images sensed by the fingerprint sensor 500 from being corrupted by ESD in a single structure. This reduces the overall size and cost of the fingerprint sensor 500.

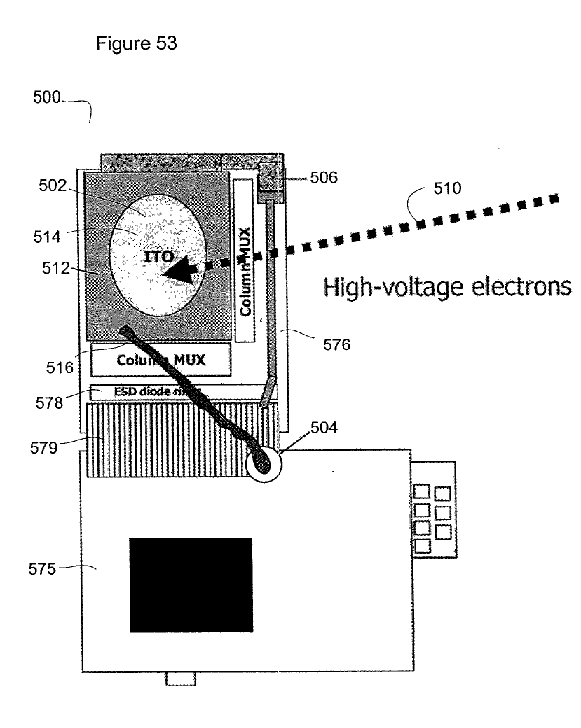

FIG. 53 is a top view of an alternative embodiment of a fingerprint sensor 500. In this embodiment, the fingerprint sensor 500 also comprises a metal layer 512. In this embodiment, the metal layer 512 comprises a layer of copper foil approximately 0.1 mm thick. The metal layer 512 also defines an opening. The metal layer 512 overlies the first protective layer 502 such that the opening in the metal layer 512 defines an active area 514. The active area 514 is generally oval and conforms generally to the contact profile of a finger. The active area 514 is that region of the first protective area 502 not occluded by the opaque metal layer 512. The contour of the active area 514 provides a pictograph suggesting to a user the appropriate place to position their finger to effect sensing and rendering by the fingerprint sensor 500. The pictorial suggestion of the contour of the active area 514 is advantageous in that it is non-verbal and thus non-language specific. This offers increased utility to the fingerprint sensor 500 in multi-national markets.

The metal layer 514 is connected to the analog circuit ground 504 via a planar conductor 516. The planar conductor 516 of this embodiment is substantially similar to the planar conductor 506, however, in alternative embodiments, the planar conductor 506, 516 can comprise other conductive material such as copper, aluminum, and conductive oxides or silicides. The planar conductor 516 is formed by soldering, deposition, wire-bonding, sputtering, or other known methods of forming conductive structures. As will be understood by one of skill in the art, the planar conductor 516 is electrically isolated from other conductive structures such as the connector 579 by placement of insulative material, such as plastic or silicon dioxide, between the planar conductor 516 and other structures in manner well understood in the art. The metal layer 514, as connected to the analog circuit ground 504 via the planar conductor 516, is adapted to shunt the electrostatic charge 510 so as to equalize electrical potential in the manner previously described. An advantage of the metal layer 514 is that it offers a secondary path for current travel thus increasing the capacity for discharging electrostatic charge 510 of the fingerprint sensor 500 of this embodiment.

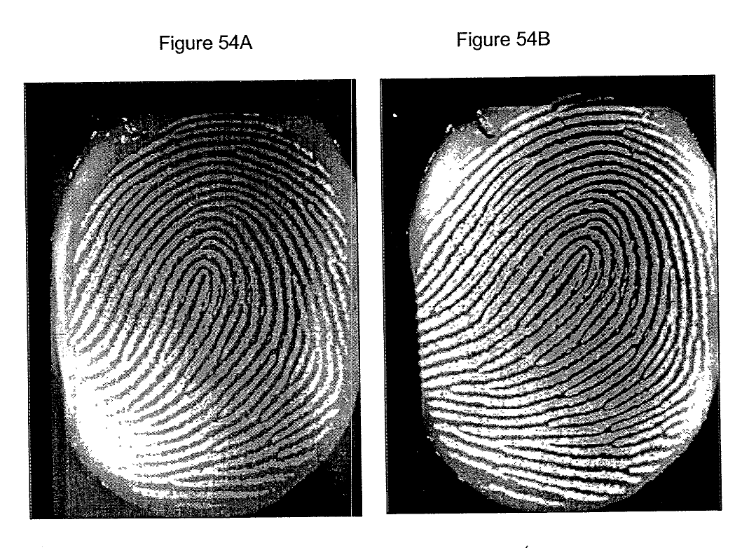

The improvement in image resolution provided by the first protective layer 502 is illustrated in FIGS. 54A and 54B. In particular, it should be noted that the image sensed with a fingerprint sensor 500 with the first protective layer 502 as illustrated in FIG. 54B is less grainy or pixilated than a contrasting image sensed by a fingerprint sensor without the presence of the first protective layer 502 as illustrated in FIG. 54A. It will be appreciated by one of skill in the art, that a less grainy or pixilated image provides a more accurate image of the actual fingerprint pattern of the user and facilitates an improved rendering of the fingerprint sensor 500, thereby increasing the sensitivity, accuracy and convenience and utility of the fingerprint sensor 500.

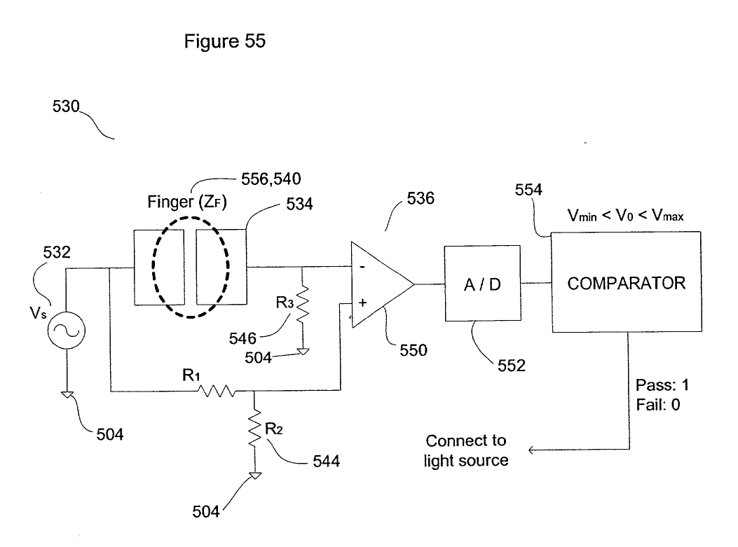

FIG. 55 is a circuit diagram of an additional aspect of the present invention. FIG. 55 illustrates a live finger detection system 530. The live finger detection system 530 detects and discriminates the presence or absence of a live finger surface in contact with the fingerprint sensor 500. The live finger detection system 530 performs the function of powering the fingerprint sensor 500 only when a living finger is in contact with the fingerprint sensor 500. This function of the live finger detection system 530 enables power-saving for the fingerprint sensor 500 as power is only supplied and consumed when the fingerprint sensor 500 is actually in the process of imaging a fingerprint. Thus, the fingerprint sensor 500 of this embodiment draws less energy from a limited power source, such as a battery, in battery powered applications such as PDAs or laptop computers.

The live finger detection system 530 also provides fraud protection for the fingerprint sensor 500. In particular, the live finger detection system 530 is adapted to only engage the fingerprint sensor 500 when a living finger is in contact with the fingerprint sensor 500 in a manner that will be described in greater detail below. In this manner, the live finger detection system 530 inhibits a fraudulent user from employing an artifice imitating a finger print, such as a rubber or dead finger to activate the fingerprint sensor 500 and render or validate a fingerprint image from the artifice.

The live finger detection system 530 comprises a time varying voltage source 532, a finger contact 534, and a sensing circuit 536. The time varying voltage source 532 provides a voltage of approximately 10 Vₚₚ at a frequency from 10 Hz to 10 MHz. In one embodiment, the time varying voltage source 532 provides, a voltage of 10 Vₚₚ at 1 KHz. In alternative embodiments, the time varying voltage source 532 provides voltages at different frequencies. The time varying voltage source 532 is constructed in a known manner.

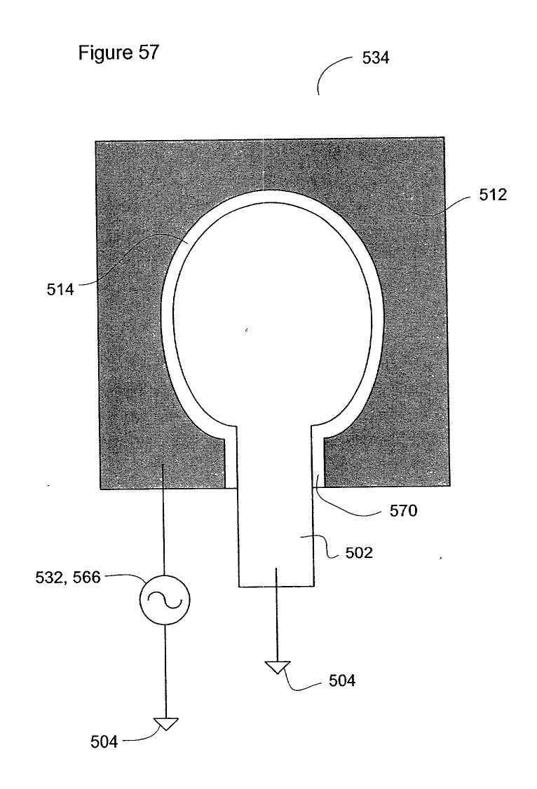

The finger contact 534 provides a contact that is normally open and is selectively bridged by a finger surface as a user places their finger in contact with the fingerprint sensor 500. Several embodiments of the finger contact 534 are illustrated in FIGS. 57, 58A, and 58B and will be described in greater detail below with reference to these Figures. When a user's finger is in contact with the finger contact 534, this condition will be referred to as finger present 540 in the description to follow.

The sensing circuit 536 of this embodiment, comprises three resistors, R1 542, R2 544, R3 546, an Op Amp 550, an analog-to-digital converter (A/D) 552, and a comparator 554. R1 542 and R2 544 are connected in series between the time varying voltage source 532 and analog ground 504. R1 542 and R2 544 are also connected as a voltage divider with the node between R1 542 and R2 544 being connected to the non-inverting input of the Op Amp 550. The finger contact 534 and R3 546 are also connected as a voltage divider with the node between the finger contact 534 and R3 546 being connected to the inverting input of the Op Amp 550.

The output of the Op amp 550 is connected to the A/D 552 and the output of the A/D 552 is fed to the comparator 554 such that input signals to the inverting and non-inverting inputs of the Op Amp 550 generate signals to the comparator 554 in a known manner. The output of the comparator 554 is connected to the light source 50, 202, 242, 380, 414, 423, 470. The parameters of the sensing circuit 536 are selected such that presence of a living finger with an impedance in the range of 5 KOhms to 70 KOhms at 1 KHz will generate a logic “1” output from the comparator 554 so as to enable the light source 50, 202, 242, 380, 414, 423, 470. In a complementary manner, absence of a living finger or an artifice without the correct finger impedance 556 will generate a logic “0” output from the comparator 554 and inhibit the activation of the fingerprint sensor 500. Thus, the voltage dividers of R1 542 and R2 544 and the finger contact 534 and R3 546 as connected to the time varying voltage source 532, generate inputs to the Op Amp 550. If a living finger is not present or an artifice without the appropriate finger impedance 556 is present, the fingerprint sensor 500 will not be enabled.

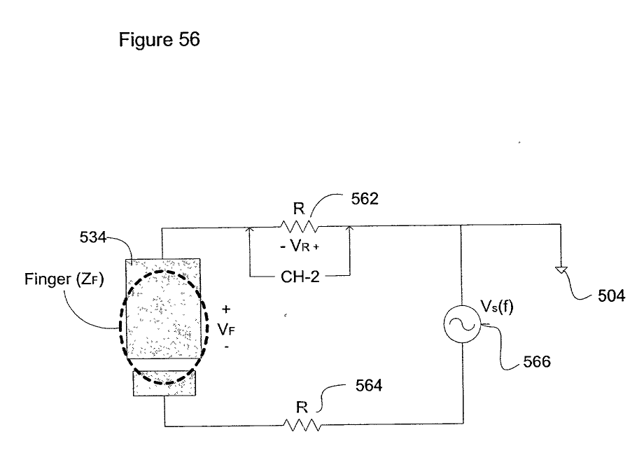

FIG. 56 is a circuit diagram of an alternative embodiment of a live finger detection system 530. In this embodiment, the live finger detection system 530 comprises a sensing circuit comprising resistors R4 562 and R5 564, a time varying voltage source 566, and the finger contact 534. In this embodiment, R4 562 has a resistance of approximately 75 Ω and R5 564 has a resistance of approximately 1 kΩ. The time varying voltage source generates a voltage of 20 V peak-to-peak at a frequency between 100 Hz and 1 MHz.

R4 562 and R5 564 are connected in series with the finger contact 534 so as to form a voltage divider. In this embodiment, the fingerprint sensor 500 monitors the voltage developed across the finger contact 534 due to the finger impedance 556 in a known manner. In a similar manner to that previously described, if the finger impedance 556 is not within the range of 5K Ω to 70K Ω at 1 KHz, thereby indicating the absence of a finger or the presence of something other than a live finger, the voltage read across the finger contact 534 will not be within the indicated range and the fingerprint sensor 500 will not be enabled.

In certain embodiments of the live finger detection system 530, a first measurement of the finger impedance 556 is taken or sampled at a time varying voltage source 532, 566 of 10 Vₚₚ V (rms or P-P) and a frequency of 1 KHz. Then, at least a second measurement is taken at 10 Vₚₚ V and 5 KHz. In this manner, taking at least two measurements better discriminates the capacitance of the finger thereby improving the live finger detection system's 530 ability to discriminate the presence of a live finger.

These embodiments of the present invention offer the advantage of additional convenience to the user. In particular, the user would need to place their finger on the fingerprint sensor 500 anyway and doing so enables the fingerprint sensor 500 and simultaneously authenticates that a living finger is in place. In addition, once the finger is removed, power is also disengaged from the optical detectors 60 and the light source 50, 202, 242, 380, 414, 423, 470 of the fingerprint sensor 500, thereby only powering the fingerprint sensor 500 when a finger is in contact with the fingerprint sensor 500. In one embodiment, the fingerprint sensor 500 can be adapted to power down when the authentication procedure is completed regardless of whether a finger is still in contact with the fingerprint sensor 500.

FIG. 57 is a detailed, top view of one embodiment of the finger contact 534. In this embodiment, the finger contact 534 comprises the first protective layer 502 and the metal layer 512. In this embodiment, the first protective layer 502 and the metal layer 512 are electrically insulated from each other by a insulator layer 570 such that a closed electrical circuit between the first protective layer 502 and the metal layer 512 is not formed unless an object, such as a finger, bridges the gap between the first protective layer 502 and the metal layer 512. It will be appreciated that in the embodiment of the finger contact 534 illustrated in FIG. 57, the region of the insulative layer 570 wherein the metal layer 512 does not overlie the first protective layer 502 can comprise a solid insulator such as SiO₂ or an air gap.

FIG. 58A is a side, section view of an alternative embodiment of the finger contact 534. In this embodiment, the finger contact 534 comprises the first protective layer 502, the metal layer 512, and the insulator layer 570. In this embodiment, the metal layer 512 partially overlies the first protective layer 502 about the periphery of the active area 514. FIG. 58B illustrates an embodiment of the finger contact 534 comprising the first protective layer 502, the metal layer 512, and the insulator layer 570 wherein the metal layer 512 does not overlie the first protective layer 502. It can be seen in FIG. 58A and 58B that the active area 514 overlies the plurality of optical detectors 60.

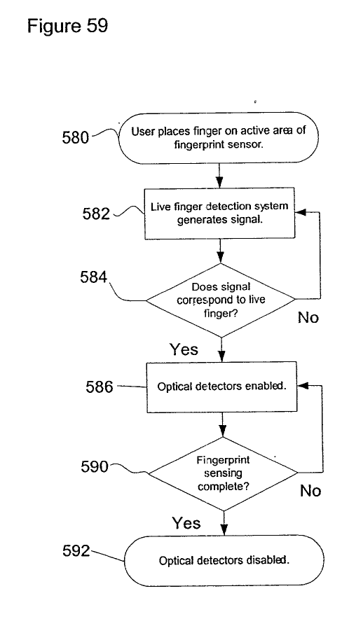

FIG. 59 is a flow chart illustrating certain aspects of one embodiment of the method of operation of the present invention. In particular, a user places their finger on the active area 514 of the fingerprint sensor 500 in state 580. The user's finger has a finger impedance 556 and the live finger detection system 530 will generate a signal corresponding to the voltage developed across the finger in the manners previously described in state 582. The fingerprint sensor 500 then determines in decision state 584 whether the signal generated in state 582 corresponds to a live finger, i.e. to finger present 540. As previously described, in certain embodiments of the present invention, multiple measurements of the finger impedance 556 may be made to better discriminate finger present 540. Designing and implementing an appropriate decision logic for determining the presence of a live finger with multiple measurements is well within the skill of one of ordinary skill in this art and will not be described in detail here.

If the fingerprint sensor 500 determines in state 584 that a live finger is present, the fingerprint sensor 500 enables the optical detectors 60 and the light source 50, 202, 242, 380, 414, 423, 470 in state 586. The fingerprint sensor 500 then senses and authenticates the fingerprint in the manner previously described. When the fingerprint sensor 500 determines that the sensing is complete in state 590, the fingerprint sensor proceeds to disable the optical sensors 60 and the light source 50, 202, 242, 380, 414, 423, 470 in state 592. It should be appreciated that, in decision state 590, wherein a determination is made if the fingerprint sensing is complete, can comprise actually completing the sensing as previously described or removing the finger from the fingerprint sensor 500.

Although the foregoing description of the invention has shown, described and pointed out novel features of the invention, it will be understood that various omissions, substitutions, and changes in the form of the detail of the apparatus as illustrated, as well as the uses thereof, may be made by those skilled in the art without departing from the spirit of the present invention. Consequently the scope of the invention should not be limited to the foregoing discussion but should be defined by the appended claims.

What is claimed is:

1. A fingerprint sensor wherein a finger placed on the sensor is illuminated by both a light source and by ambient light, the fingerprint sensor having a color filter that filters out a portion of the ambient light, the fingerprint sensor comprising:
a contact surface which receives a fingertip of a user;
at least one light source which generates at least green light that is reflected by the fingertip;
a color filter which is substantially transparent to the green light and substantially opaque to a portion of ambient light that is substantially transmitted through the fingertip; and
a plurality of optical detectors disposed from the contact surface with at least a portion of the color filter disposed between the optical detectors and the contact surface, the optical detectors positioned to receive the green light reflected by the fingertip, the optical detectors generating electrical signals in response to the received light, thereby providing an electronic representation of a fingerprint corresponding to the fingertip.

2. The fingerprint sensor of claim 1, wherein the portion of ambient light that is substantially transmitted through the fingertip is primarily red light.

3. The fingerprint sensor of claim 1, wherein the light source comprises a green light-emitting diode.

4. The fingerprint sensor of claim 1, wherein the color filter comprises a polyimide material with dissolved colorants.

5. The fingerprint sensor of claim 1, wherein the color filter comprises an organic material.

6. The fingerprint sensor of claim 1, wherein the color filter comprises an inorganic material.

7. The fingerprint sensor of claim 6, wherein the color filter comprises a multilayer structure of a-SiNₓ/a-SiOₓ/a-SiNₓO_{y}.

8. The fingerprint sensor of claim 1, wherein the color filter has a thickness between approximately 1.0 um to approximately 3.0 um.

9. The fingerprint sensor of claim 1, wherein the color filter substantially covers the plurality of optical detectors.

10. The fingerprint sensor of claim 1, wherein the plurality of optical detectors are separated from one another, thereby defining a region between the optical detectors, and the color filter is patterned such that the color filter does not substantially cover the region between the optical detectors.

11. The fingerprint sensor of claim 1, wherein the plurality of optical detectors comprise a planar array of pixels.

12. The fingerprint sensor of claim 11, wherein the planar array of pixels is arranged in generally orthogonal columns and rows.

13. The fingerprint sensor of claim 1, wherein each optical detector comprises a switching diode and a photodiode.

14. The fingerprint sensor of claim 1, wherein the plurality of optical detectors comprises an opaque matrix which substantially bounds each optical detector, thereby separating the optical detectors from one another.

15. The fingerprint sensor of claim 1, further comprising an opaque matrix which substantially bounds portions of the color filter, thereby separating the portions of the color filter from one another.

16. The fingerprint sensor of claim 1, further comprising an opaque matrix which substantially bounds each optical detector with an associated portion of the color filter.

17. The fingerprint sensor of claim 1, wherein the plurality of optical detectors and the light source are substantially co-planar.

18. A fingerprint sensor comprising:
at least one light source which generates light that is reflected by a fingertip;
a color filter which is substantially transparent to green light and substantially opaque to non-green light; and
at least one optical detector disposed from the fingertip with at least a portion of the color filter disposed between the optical detector and the fingertip, the optical detector positioned to receive the green light reflected by the fingertip.

19. A fingerprint sensor comprising:
a contact surface which receives a fingertip of a user, the fingertip comprising a pattern of ridges and valleys, the contact surface in contact with the ridges of the fingertip;
at least one light source which generates light that is reflected from the contact surface;
a color filter which is substantially transparent to green light and substantially opaque to non-green light; and
at least one optical detector disposed from the contact surface with at least a portion of the color filter disposed between the optical detector and the contact surface, the optical detector positioned to receive the green light reflected from the contact surface.

20. A fingerprint sensor comprising:
a substrate which is substantially transparent to green light;
at least one light source coupled to the substrate, the light source generating light that propagates through the substrate and is reflected by a fingertip;
a color filter which is substantially transparent to green light and substantially opaque to non-green light; and
at least one optical detector disposed from the fingertip with at least a portion of the color filter disposed between the optical detector and the fingertip, the optical detector positioned to receive the green light reflected by the fingertip.

21. A fingerprint sensor comprising:
at least one light source which generates light that is reflected by a fingertip;
a color filter which is substantially transparent to green light and substantially opaque to non-green light; and
an optical detector layer disposed from the fingertip with at least a portion of the color filter disposed between the optical detector layer and the fingertip, the optical detector layer positioned to receive the green light reflected by the fingertip.

22. A fingerprint sensor comprising:
at least one light source which generates light that is reflected by a fingertip;
a color filter which is substantially transparent to non-red light and substantially opaque to red light; and
at least one optical detector disposed from the fingertip with at least a portion of the color filter disposed between the optical detector and the fingertip, the optical detector positioned to receive the non-red light reflected by the fingertip.

23. A fingerprint sensor comprising:
a contact surface which receives a fingertip of a user, the fingertip comprising a pattern of ridges and valleys, the contact surface in contact with the ridges of the fingertip;
at least one light source which generates light that is reflected from the contact surface;
a color filter which is substantially transparent to non-red light and substantially opaque to red light; and
at least one optical detector disposed from the contact surface with at least a portion of the color filter disposed between the optical detector and the contact surface, the optical detector positioned to receive the non-red light reflected from the contact surface.

24. A fingerprint sensor comprising:
a substrate which is substantially transparent to non-red light;
at least one light source coupled to the substrate, the light source generating light that propagates through the substrate and is reflected by a fingertip;
a color filter which is substantially transparent to non-red light and substantially opaque to red light; and
at least one optical detector disposed from the fingertip with at least a portion of the color filter disposed between the optical detector and the fingertip, the optical detector positioned to receive the non-red light reflected by the fingertip.

25. A fingerprint sensor comprising:
at least one light source which generates light that is reflected by a fingertip;
a color filter which is substantially transparent to non-red light and substantially opaque to red light; and
an optical detector layer disposed from the fingertip with at least a portion of the color filter disposed between the optical detector layer and the fingertip, the optical detector layer positioned to receive the non-red light reflected by the fingertip.

26. A fingerprint sensor comprising:
at least one light source which generates light that is reflected by a fingertip;
a color filter which is substantially opaque to a portion of ambient light that passes through the fingertip; and
at least one optical detector disposed from the fingertip with at least a portion of the color filter disposed between the optical detector and the fingertip, the optical detector positioned to receive a portion of the light that reflects from the fingertip and passes through the color filter.

27. A fingerprint sensor comprising:
a contact surface which receives a fingertip of a user, the fingertip comprising a pattern of ridges and valleys, the contact surface in contact with the ridges of the fingertip;
at least one light source which generates light that is reflected from the contact surface;
a color filter which is substantially opaque to a portion of ambient light that passes through the fingertip; and
at least one optical detector disposed from the contact surface with at least a portion of the color filter disposed between the optical detector and the contact surface, the optical detector positioned to receive a portion of the light that reflects from the contact surface and passes through the color filter.

28. A fingerprint sensor comprising:
at least one light source coupled to a substrate, the light source generating light that propagates through the substrate and is reflected by a fingertip, the substrate being substantially transparent to the light generated by the light source;
a color filter which is substantially opaque to a portion of ambient light that passes through the fingertip; and
at least one optical detector disposed from the fingertip with at least a portion of the color filter disposed between the optical detector and the fingertip, the optical detector positioned to receive a portion of the light that reflects from the fingertip.

29. A fingerprint sensor comprising:
at least one light source which generates light that is reflected by a fingertip;
a color filter which is substantially opaque to a portion of ambient light that passes through the fingertip; and
an optical detector layer disposed from the fingertip with at least a portion of the color filter disposed between the optical detector layer and the fingertip, the optical detector layer positioned to receive a portion of the light that reflects from the fingertip.

30. A fingerprint sensor comprising:
at least one light source which generates light that is reflected by a fingertip; and
at least one optical detector disposed from the fingertip, the optical detector positioned to receive the light generated by the light source and reflected by the fingertip, the optical detector comprising a color filter which is substantially transparent to the light that is generated by the light source and reflected by the fingertip and substantially opaque to a portion of ambient light substantially transmitted through the fingertip, whereby the optical detector is substantially responsive to the light that is generated by the light source and reflected by the fingertip and is not substantially responsive to the portion of ambient light substantially transmitted through the fingertip.

31. A fingerprint sensor comprising:
at least one light source which generates light that is reflected by a fingertip; and
a plurality of optical detectors disposed from the fingertip, the optical detectors positioned to receive the light generated by the light source and reflected by the fingertip, the optical detectors each comprising:
a switching diode;
a photodiode comprising a photoactive p-layer, an intrinsic layer, and an n-layer; and
a color filter layer covering the photoactive p-layer, the color filter layer substantially transparent to the light generated by the light source and reflected by the fingertip and substantially opaque to a portion of ambient light substantially transmitted through the fingertip,
whereby the optical detectors are substantially responsive to light that is generated by the light source and not substantially responsive to the portion of ambient light substantially transmitted through the fingertip.

32. A fingerprint sensor wherein a finger placed on the sensor is illuminated by both a light source and by ambient light, the fingerprint sensor having a color filter that filters a portion of the ambient light, the fingerprint sensor comprising:
a substrate comprising a first material which is substantially transparent to light with wavelengths within a first range of wavelengths;
a contact surface which receives a fingertip of a user;
a color filter layer comprising a second material which is substantially transparent to light with wavelengths within the first range of wavelengths and substantially opaque to a portion of ambient light with wavelengths within a second range of wavelengths, the portion of ambient light propagating through the fingertip;
at least one light source coupled to the substrate, the light source generating light with at least one wavelength within the first range of wavelengths, the light propagating through the substrate to the fingertip; and
a plurality of optical detectors disposed from the contact surface with at least a portion of the second material disposed between the optical detectors and the contact surface, the optical detectors positioned to receive light generated by the light source and reflected by the fingertip, the optical detectors generating electrical signals in response to the received light, thereby providing an electronic representation of a fingerprint corresponding to the fingertip.

33. A method of sensing a fingerprint comprising a pattern of ridges and valleys of a fingertip of a user, the method comprising:
receiving the fingertip on a fingerprint sensor;
receiving a first light substantially transmitted through the fingertip to a contact surface, whereby the first light is generated by ambient light sources;
generating a second light and substantially transmitting the second light to the fingertip from the contact surface;
reflecting a portion of the second light from the fingertip;
filtering the first light substantially transmitted through the contact surface from the second light reflected from the fingertip; and
detecting the second light reflected from the fingertip, thereby imaging the fingerprint of the fingertip.

34. The method of claim 33, wherein receiving the fingertip on the fingerprint sensor comprises contacting a contact surface of the fingerprint sensor with the ridges of the fingertip.

35. The method of claim 33, wherein reflecting a portion of the second light from the fingertip comprises reflecting from the ridges of the fingertip with a first reflectivity and reflecting from the valleys of the fingertip with a second reflectivity.

36. The method of claim 33, wherein receiving the first light substantially transmitted through the fingertip comprises receiving primarily red light.

37. The method of claim 33, wherein generating the second light is performed using a light source comprising a green light-emitting diode.

38. The method of claim 33, wherein filtering the first light comprises using a color filter comprising a polyimide material with dissolved colorants.

39. The method of claim 33, wherein filtering the first light is filtered comprises using a color filter having a thickness between approximately 1.0 um to approximately 3.0 um.

40. The method of claim 33, wherein detecting the second light comprises using a plurality of optical detectors comprising a planar array of pixels.

41. The method of claim 40, further comprising arranging the planar array of pixels in generally orthogonal columns and rows.

42. The method of claim 33, wherein detecting the second light comprises using a plurality of optical detectors comprising an opaque matrix which substantially bounds each optical detector, thereby separating the optical detectors from one another.

43. The method of claim 33, wherein filtering the first light comprises using an opaque matrix which substantially bounds portions of the color filter, thereby separating the portions of the color filter from one another.

44. The method of claim 33, wherein filtering the first light comprises using an opaque matrix which substantially bounds each optical detector with an associated portion of the color filter.

45. The method of claim 33, wherein detecting the second light comprises using a plurality of optical detectors which is substantially co-planar with a light source which generates the second light.

46. A fingerprint sensor comprising:
at least one light source which generates green light that is reflected by a fingertip;
a color filter which is substantially transparent to the green light generated by the light source and reflected by the fingertip, and which is substantially opaque to non-green light; and
at least one optical detector disposed from the fingertip with at least a portion of the color filter disposed between the optical detector and the fingertip, the optical detector positioned to receive the green light generated by the light source and reflected by the fingertip.

47. The fingerprint sensor of claim 46, wherein the light source comprises a green light-emitting diode.

48. The fingerprint sensor of claim 46, wherein the light source comprises a microlens array.

49. The fingerprint sensor of claim 46, wherein the optical detector comprises an active matrix sensor array.

50. A fingerprint sensor comprising:
at least one light source comprising a green light-emitting diode which generates green light that is reflected by a fingertip;
a color filter which is substantially transparent to the green light generated by the green light-emitting diode and reflected by the fingertip, and which is substantially opaque to non-green light; and
at least one optical detector comprising an active matrix sensor array disposed from the fingertip with at least a portion of the color filter disposed between the active matrix sensor array and the fingertip, the active matrix sensor array positioned to receive the green light generated by the green light-emitting diode and reflected by the fingertip.

51. The fingerprint sensor of claim 50, further comprising a microlens array that reflects the green light onto the fingertip.

52. The fingerprint sensor of claim 51, wherein the microlens array is positioned below the active matrix sensor array.

53. The fingerprint sensor of claim 51, wherein the microlens array comprises a plurality of reflective, curved surfaces.

54. The fingerprint sensor of claim 51, wherein the fingerprint sensor further comprises a light shield positioned to block light from the green light-emitting diode from directly illuminating the fingertip without reflecting from the microlens array.

55. A fingerprint sensor comprising:
at least one light source comprising a microlens array and a green light-emitting diode which generates green light that is reflected by a fingertip;
a color filter which is substantially transparent to the green light generated by the light source and reflected by the fingertip, and which is substantially opaque to non-green light; and
at least one optical detector disposed from the fingertip with at least a portion of the color filter disposed between the optical detector and the fingertip, the optical detector positioned to receive the green light generated by the light source and reflected by the fingertip.

56. A fingerprint sensor comprising:
at least one light source comprising a microlens array and a green light-emitting diode which generates green light that is reflected by a fingertip;
a color filter which is substantially transparent to the green light generated by the light source and reflected by the fingertip, and which is substantially opaque to non-green light; and
at least one optical detector comprising an active matrix sensor array disposed from the fingertip with at least a portion of the color filter disposed between the active matrix sensor array and the fingertip, the active matrix sensor array positioned to receive the green light generated by the green light-emitting diode and reflected by the fingertip.

57. A fingerprint sensor comprising:
at least one light source which generates non-red light that is reflected by a fingertip;
a color filter which is substantially transparent to the non-red light generated by the light source and reflected by the fingertip, and which is substantially opaque to red light; and
at least one optical detector disposed from the fingertip with at least a portion of the color filter disposed between the optical detector and the fingertip, the optical detector positioned to receive the non-red light generated by the light source and reflected by the fingertip.

58. The fingerprint sensor of claim 57, wherein the light source comprises a green light-emitting diode.

59. The fingerprint sensor of claim 57, wherein the light source comprises a microlens array.

60. The fingerprint sensor of claim 57, wherein the optical detector comprises an active matrix sensor array.

61. A fingerprint sensor comprising:
at least one light source which generates light that is reflected by a fingertip, the light having a wavelength which is not substantially transmitted through the fingertip;
a color filter which is substantially opaque to a portion of ambient light that passes through the fingertip, and which is substantially transparent to the light generated by the light source and reflected by the fingertip; and
is at least one optical detector disposed from the fingertip with at least a portion of the color filter disposed between the optical detector and the fingertip, the optical detector positioned to receive the light generated by the light source and reflected by the fingertip.
